(19) United States
(12) Patent Application Publication
(10) Pub. No.: US 2015/0019252 A1
(43) Pub. Date: Jan. 15, 2015

(54) DENTAL IMPLANT MANAGEMENT SYSTEM AND METHOD

(71) Applicant: Centergistix, LLC, Arlington, TX (US)

(72) Inventors: Thomas W. Dawson, Arlington, TX (US); Susan R. Shepherd, Arlington, TX (US)

(21) Appl. No.: 13/937,694

(22) Filed: Jul. 9, 2013

(51) Int. Cl. G06F 19/00; A61C 8/00

(52) U.S. Cl. CPC G06F 19/3418; A61C 8/00
USPC 705/3

(57) ABSTRACT

A dental implant management system/method that improves communication and coordination between parties associated with dental implant procedures is disclosed. The system/method operates to permit each dental implant professional (DIP) (typically a surgeon, restorative doctor, and dental laboratory) to iteratively generate a patient treatment execution plan (TEP) for the dental implant procedure that is generally structured within execution treatment phases (ETP) and automatically coordinated among each DIP. The ETP typically defines FOUNDATION, IMPLANT PLACEMENT, RESTORATIVE, and MAINTENANCE phases that may each incorporate custom execution phase checklists (EPC) that permit each DIP to ensure that critical elements of their TEP are properly executed. Coordination of the various DIP-generated TEPs is integrated with treatment planning/sequencing, patient scheduling, DIP fee estimation, and dental parts procurement to ensure maximum revenue to each DIP while simultaneously improving the probability of a successful dental implant procedure for the patient.

### CROSS REFERENCE TO RELATED APPLICATIONS

Not Applicable

### PARTIAL WAIVER OF COPYRIGHT

All of the material in this patent application is subject to copyright protection under the copyright laws of the United States and of other countries. As of the first effective filing date of the present application, this material is protected as unpublished material.

However, permission to copy this material is hereby granted to the extent that the copyright owner has no objection to the facsimile reproduction by anyone of the patent documentation or patent disclosure, as it appears in the United States Patent and Trademark Office patent file or records, but otherwise reserves all copyright rights whatsoever.

### STATEMENT REGARDING FEDERALLY SPONSORED RESEARCH OR DEVELOPMENT

Not Applicable

### REFERENCE TO A MICROFICHE APPENDIX

Not Applicable

### FIELD OF THE INVENTION

The present invention relates to dental implant management systems/methods and specifically addresses application contexts in which a patient must interact with a surgeon, restorative doctor, and dental laboratory during one or more restorative dental procedures. The system/method context involves planning, coordination, and synchronization between the patient, surgeon, restorative doctor, dental laboratory, and other participants involved in the overall restorative dental procedure.

### PRIOR ART AND BACKGROUND OF THE INVENTION

### Overview

Dental implant procedures are currently the fastest growing dental procedure in the United States. Research indicates that every dentist will need to perform 20 dental implant procedures per month for the next 20 years to keep up with the expected demand for this service in the future. Despite this opportunity for patient service, most dental professionals are overwhelmed, overworked, and under-prepared to meet this demand. As a result, only 50% of the approximately 177,000 dentist in the United States perform dental implants in their daily practice. The complexity of coordinating and managing dental implant procedures is a significant factor in this low participation rate.

As a direct result of these pressures on dental professionals, the current standard of care for dental implant procedures is often fraught with undesirable outcomes. Recent statistics indicate that approximately 65% of the dental implant procedures performed result in undesirable outcomes and patient dissatisfaction due to a failure to properly plan and execute the dental implant procedure. This poor performance may be the result of a variety of factors, including any or all of the following:
Participant Coordination. The implant process involves coordinating at a minimum the activities of the patient, a surgeon, a restorative doctor, and a dental laboratory. These participants are often not completely aware of the actions they need to perform to move the dental implant process forward to a successful conclusion.
Extended Time Scope. The dental implant process has a relatively long time scope that may require a year or more to successfully execute. Maintaining forward momentum for all participating parties during this lengthy time scope is very difficult in most circumstances.
Communication. Generally speaking, the more parties that are involved in a dental procedure, the more difficult it is to ensure that adequate communication between the parties can be maintained during the entire process to ensure that no one participant “drops the ball” with respect to their scope of responsibility.
Plan Generation. Often participants in a dental implant procedure work without a structured plan of execution, opting to concentrate only on their scope of responsibility. Without a centralized plan of execution, the dental implant process often becomes confused. This is especially true for the patient, who often has no idea his/her status or position within the overall plan calendar. This confusion often results in patient dissatisfaction with respect to procedure cost and execution timeframes.
Document Integration and Execution Status. The management of documentation associated with the dental implant process can be daunting, given that this information spans patient medical data, treatment planning (from at least the surgeon, restorative doctor, and dental laboratory), procedure documentation relating to the actual implant execution, and milestone completion data. All of this information is currently uncoordinated within the dental implant industry, resulting in significant inefficiencies as well as general customer dissatisfaction regarding multiple billing entities and lack of unified cost generation procedures.
Patient Expectation Management. Current dental implant procedures often have no regard for managing patient expectations regarding the procedure. This is often the result of the patient not being provided a plan timeline for completion of the procedure and an ability to determine where in the overall timeline they are positioned. Often this dissatisfaction is the result of the patient not being provided a comprehensive cost estimate for the individual costs associated with the procedure and where these costs will be allocated. This patient expectation management also involves situations in which the patient is not apprised of the timing involved in the overall dental implant procedure.
Provider Throughput Optimization. Since current dental implant procedures involve the operation of several different professionals (surgeon, restorative doctor, dental laboratory, dental implant parts supplier, etc.), the lack of coordination of these participants often results in inefficiencies in work flow within the domain of each professional. This can result in time or billing gaps that reduce overall profit for each professional. Currently there is no methodology in place to improve this loss of income or improve throughput efficiency.
   The current prior art standard of care in the dental implant industry incorporates all of these factors and as stated previously, on average results in an unacceptable outcome for the dental implant procedure.

### Current Methodologies

Since dental implant patients must interact with at least three distinct dental implant professionals (DIPs) in affecting a dental implant procedure (surgeon, restorative doctor, dental lab), the coordination of a treatment plan among these professionals is often a fragmented and disorganized process. Typical approaches to the generation of a treatment plan for a given DIP often include the use of spreadsheets (MICROSOFT® EXCEL®, etc.) that are customized to a given DIP practice and incorporate cost information associated with the procedure for a given patient. However, this information is local only to the particular DIP practice office and cannot be shared among the various DIPs or the patient. As a result, critical information necessary to properly treat the patient is often not communicated to the other DIPs responsible for patient treatment.

### Deficiencies in the Prior Art

The prior art as detailed above suffers from the following deficiencies:
Dental implant professionals are often unable to effectively communicate with each other and the patient.
Dental implant professionals are often unable to generate an execution plan that effectively coordinates all professionals associated with the dental implant procedure.
Dental implant professionals are often unable to efficiently schedule their time with patients and each other to maximize profit margins for their dental practice.
Patients are often unaware of their progress within the overall dental implant procedure execution plan.
Patients often have no idea as to the total cost of the implant procedure or when these costs will be incurred.
Dental implant professionals often are forced to keep significant inventory of dental implant parts on hand in anticipation of future dental patient needs. This can result in USD$100,000.00 or more of unnecessary parts inventory. There is currently no methodology of reducing this cost overhead in dental implant practices.

While some of the prior art may teach some solutions to several of these problems, the core issues of allowing dental implant professionals to effectively manage dental implant procedures in a cooperative manner with patients has not been addressed by the prior art. As a result, more than half of the dental implant procedures performed result in an undesirable outcome, resulting in patient dissatisfaction and loss of revenue for dental implant professionals.

### Objectives of the Invention

Accordingly, the objectives of the present invention are (among others) to circumvent the deficiencies in the prior art and affect the following objectives:
(1) Provide for a dental implant management system and method that allows automated generation of a dental implant treatment execution plan (TEP) for a patient.
(2) Provide for a dental implant management system and method that allows improved communication between the patient, surgeon, restorative doctor, and dental laboratory.
(3) Provide for a dental implant management system and method that allows coordination between the patient, surgeon, restorative doctor, and dental laboratory.
(4) Provide for a dental implant management system and method that allows real-time progress status for a dental implant procedure to be viewed by the patient, surgeon, restorative doctor, and dental laboratory.
(5) Provide for a dental implant management system and method that allows real-time progress status for a dental implant procedure to be updated by the surgeon, restorative doctor, and dental laboratory.
(6) Provide for a dental implant management system and method that allows comprehensive integrated patient treatment planning for the dental implant surgeon, restorative doctor, and dental laboratory.
(7) Provide for a dental implant management system and method that allows the surgeon, restorative doctor, and dental laboratory to independently construct execution phase checklists (EPC) that operate within fixed execution treatment phases (ETP) to ensure that all activities associated with a dental implant procedure are properly executed in proper sequence.
(8) Provide for a dental implant management system and method that improves patient outcomes and improves the standard of patient care for dental implant procedures.
(9) Provide for a dental implant management system and method that permits dental implant professionals the ability to manage their dental parts inventory in a “just in time” fashion to reduce overall parts inventory and overhead costs.
(10) Provide for a dental implant management system and method that allows archiving of dental implant history information so that any patient maintenance that must be performed in the future can have access to this information
(11) Provide for a dental implant management system and method that improves the likelihood that a dental implant can easily be identified in a patient in the future.
(12) Provide for a dental implant management system and method that provides for shared patient history among dental professionals.

While these objectives should not be understood to limit the teachings of the present invention, in general these objectives are achieved in part or in whole by the disclosed invention that is discussed in the following sections. One skilled in the art will no doubt be able to select aspects of the present invention as disclosed to affect any combination of the objectives described above.

### BRIEF SUMMARY OF THE INVENTION

A system and method that allows integrated deployment of dental implant services to a patient is disclosed. The invention provides for a web-based user interface that supports the patient, surgeon, restorative doctor, and dental laboratory that structures procedures, communication, and dental parts procurement between these entities.

### System Overview

The invention system generally incorporates an Implant Management Web Server (IWS) and Implant Management Database (IMD) that operate in conjunction to execute a website having a patient, surgeon, restorative doctor, and dental laboratory web portals that allow information from dental implant professionals (DIP) (surgeon, restorative doctor, and dental laboratory, etc.) to be collected. This information is then used to generate a treatment execution plan (TEP) for the patient and then organized into execution treatment phases (ETP) (typically comprising FOUNDATION, IMPLANT PLACEMENT, RESTORATIVE, and MAINTENANCE phases) to schedule the patient treatment. Within each ETP each DIP can create a series of execution phase checklists (EPC) that include milestones within each ETP that must be satisfied to ensure a proper patient outcome.

The system incorporates a multi-access multi-threaded database that permits all interested parties (patient, surgeon, restorative doctor, and dental laboratory, etc.) to be continuously updated as to the current patient status within the dental implant procedure and also permit automated scheduling of upcoming procedures with each DIP by the patient and improved communication between each DIP to ensure that the overall dental implant procedure is performed in an efficient and effective manner.

The invention method generally incorporates the following steps:
(1) Configuring setup information for the patient and dental implant professionals (DIPs).
(2) Defining a patient-specific treatment execution plan (TEP) by coordinating input from the DIPs.
(3) Integrating the TEP into specific execution treatment phases (ETP).
(4) Associating execution phase checklists (EPC) for each DIP with each ETP.
(5) Coordinating and triggering patient/DIP activity within each ETP.
(6) Verifying that all EPC entries within an ETP are successfully completed.

Within this general method, communication between the DIPs and the patient is maintained and information (such as appointments, dental parts ordering, treatment sequencing, etc.) is constantly updated so that all parties involved in the dental implant procedure are properly scheduled and coordinated to execute the patient TEP.

### Data Flow Overview

The present invention permits integration of patient medical/dental data with creation of dynamic teams of dental implant professionals to integrate implementation of the patient dental implant procedure. This data integration includes structuring the dental implant procedure into execution treatment phases (ETP) that are substantially fixed, but allowing the dental implant professionals to customize the requirements within each ETP to their specific practice methodologies and/or a given patient. This ensures that while overall coordination of the dental implant procedure is under automated control, individual customization by the dental implant professional and/or patient is still possible. As the dental implant process progresses to completion, a documentation trail is generated that may be used by the patient and/or dental implant professionals in the future as needed to maintain or augment the dental health of the patient.

### BRIEF DESCRIPTION OF THE DRAWINGS

For a fuller understanding of the advantages provided by the invention, reference should be made to the following detailed description together with the accompanying drawings wherein:

FIG. 1 illustrates a preferred exemplary system embodiment of the present invention;

FIG. 2 illustrates a preferred exemplary overview method embodiment of the present invention;

FIG. 3 illustrates a preferred exemplary detail method embodiment of the present invention;

FIG. 4 illustrates a preferred exemplary execution treatment phase (ETP) structure that may be useful in some preferred invention embodiments;

FIG. 5 illustrates a preferred exemplary passive patient scheduling method embodiment useful in some preferred invention embodiments;

FIG. 6 illustrates a preferred exemplary passive patient scheduling update method embodiment useful in some preferred invention embodiments;

FIG. 7 illustrates a preferred exemplary active patient scheduling method embodiment useful in some preferred invention embodiments;

FIG. 8 illustrates a preferred exemplary active patient scheduling update method embodiment useful in some preferred invention embodiments;

FIG. 9 illustrates an exemplary communication/interaction flow associated with a typical application of an exemplary invention embodiment;

FIG. 10 illustrates an exemplary communication/interaction flow associated with a typical application of an exemplary invention embodiment;

FIG. 11 illustrates an exemplary cost updating method associated with a typical application of an exemplary invention embodiment;

FIG. 12 illustrates an exemplary calendar time updating method associated with a typical application of an exemplary invention embodiment;

FIG. 13 illustrates a data flow diagram depicting the separation of treatment plans among various DIPs and the use of sequencing/grouping to fracture these plans into subgroups that may be integrated into a cohesive EPC structure to implement an optimized patient treatment plan;

FIG. 14 illustrates an exemplary schedule integration method flowchart useful in some preferred invention embodiments;

FIG. 15 illustrates an exemplary schedule integration inter-DIP dependency method flowchart useful in some preferred invention embodiments;

FIG. 16 illustrates an exemplary EPC procedure flow depicting sequencing and grouping within DIP EPC procedures and across DIP procedure boundaries;

FIG. 17 illustrates an overview of an exemplary patient web portal useful in some preferred invention embodiments;

FIG. 18 illustrates an exemplary patient portal dashboard interface (partial screen display 1/2);

FIG. 19 illustrates an exemplary patient portal dashboard interface (partial screen display 2/2);

FIG. 20 illustrates an exemplary patient portal appointments interface;

FIG. 21 illustrates an exemplary patient portal dental team interface;

FIG. 22 illustrates an exemplary patient portal messaging interface;

FIG. 23 illustrates an exemplary patient portal help screen interface;

FIG. 24 illustrates an exemplary patient portal setup configuration interface;

FIG. 25 illustrates an overview of an exemplary surgeon web portal useful in some preferred invention embodiments;

FIG. 26 illustrates an exemplary surgeon web portal dashboard interface (partial screen display 1/2);

FIG. 27 illustrates an exemplary surgeon web portal dashboard interface (partial screen display 2/2);

FIG. 28 illustrates an exemplary surgeon web portal case creation interface (partial screen display 1/3);

FIG. 29 illustrates an exemplary surgeon web portal case creation interface (partial screen display 2/3);

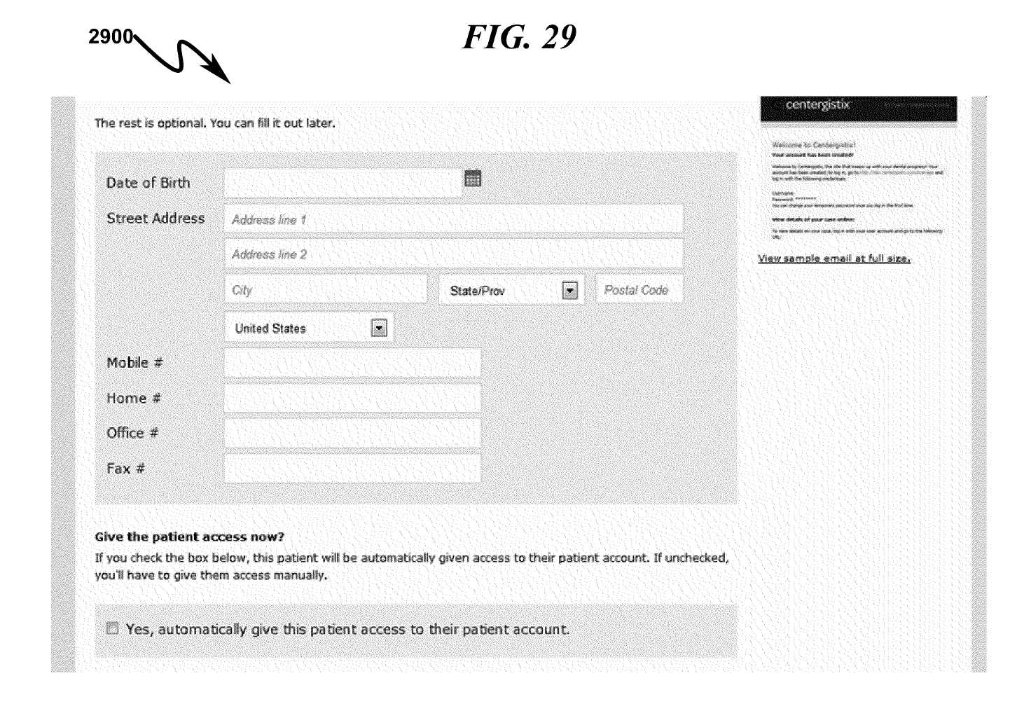

FIG. 30 illustrates an exemplary surgeon web portal case creation interface (partial screen display 3/3);

FIG. 31 illustrates an exemplary surgeon web portal case viewing interface;

FIG. 32 illustrates an exemplary surgeon web portal case appointments interface;

FIG. 33 illustrates an exemplary surgeon web portal help interface (partial screen display 1/2);

FIG. 34 illustrates an exemplary surgeon web portal help interface (partial screen display 2/2);

FIG. 35 illustrates an overview of an exemplary surgeon web portal setup configuration useful in some preferred invention embodiments;

FIG. 36 illustrates an exemplary surgeon web portal profile configuration setup interface (partial screen display 1/2);

FIG. 37 illustrates an exemplary surgeon web portal profile configuration setup interface (partial screen display 2/2);

FIG. 38 illustrates an exemplary surgeon web portal subscription configuration setup interface (partial screen display 1/2);

FIG. 39 illustrates an exemplary surgeon web portal subscription configuration setup interface (partial screen display 2/2);

FIG. 40 illustrates an exemplary surgeon web portal staff configuration setup interface (partial screen display 1/2);

FIG. 41 illustrates an exemplary surgeon web portal staff configuration setup interface (partial screen display 2/2);

FIG. 42 illustrates an exemplary surgeon web portal procedure configuration setup interface (partial screen display 1/4);

FIG. 43 illustrates an exemplary surgeon web portal procedure configuration setup interface (partial screen display 2/4);

FIG. 44 illustrates an exemplary surgeon web portal procedure configuration setup interface (partial screen display 3/4);

FIG. 45 illustrates an exemplary surgeon web portal procedure configuration setup interface (partial screen display 4/4);

FIG. 46 illustrates an exemplary surgeon web portal manufacturer representative configuration setup interface;

FIG. 47 illustrates an exemplary surgeon web portal implant component configuration setup interface (partial screen display 1/2);

FIG. 48 illustrates an exemplary surgeon web portal implant component configuration setup interface (partial screen display 2/2);

FIG. 49 illustrates an overview of exemplary surgeon phase checklist configuration setup dialogs useful in some preferred invention embodiments;

FIG. 50 illustrates an exemplary surgeon web portal phase checklist configuration setup dialog depicting a foundation phase surgeon-specific phase checklist interface;

FIG. 51 illustrates an exemplary surgeon web portal phase checklist configuration setup dialog depicting a foundation phase restorative-dentist-specific phase checklist interface;

FIG. 52 illustrates an exemplary surgeon web portal phase checklist configuration setup dialog depicting a foundation phase dental-lab-specific phase checklist interface;

FIG. 53 illustrates an exemplary surgeon web portal phase checklist configuration setup dialog depicting a implant phase surgeon-specific phase checklist interface;

FIG. 54 illustrates an exemplary surgeon web portal phase checklist configuration setup dialog depicting a implant phase restorative-dentist-specific phase checklist interface;

FIG. 55 illustrates an exemplary surgeon web portal phase checklist configuration setup dialog depicting a implant phase dental-lab-specific phase checklist interface;

FIG. 56 illustrates an exemplary surgeon web portal phase checklist configuration setup dialog depicting a restorative phase surgeon-specific phase checklist interface;

FIG. 57 illustrates an exemplary surgeon web portal phase checklist configuration setup dialog depicting a restorative phase restorative-dentist-specific phase checklist interface;

FIG. 58 illustrates an exemplary surgeon web portal phase checklist configuration setup dialog depicting a restorative phase dental-lab-specific phase checklist interface;

FIG. 59 illustrates an exemplary surgeon web portal phase checklist configuration setup dialog depicting an exemplary methodology to add a new phase checklist item;

FIG. 60 illustrates an exemplary patient treatment plan interactive dialog allowing a DIP to view the patient dental X-rays and select treatment options for a specific tooth;

FIG. 61 illustrates an exemplary treatment plan summary for the patient treatment plan of FIG. 60;

FIG. 62 illustrates an exemplary phase outline (dialog screen part 12) for the patient treatment plan of FIG. 61;

FIG. 63 illustrates an exemplary phase outline (dialog screen part 2/2) for the patient treatment plan of FIG. 61 and illustrates exemplary DIP/patient documentation generation options dialog incorporating CASE PRESENTATION, PHASE OUTLINE, PROVIDER SUMMARY, and IMPLANT COMPONENT SUMMARY reports;

FIG. 64 illustrates an exemplary implant summary for the patient treatment plan of FIG. 61.

### DESCRIPTION OF THE PRESENTLY PREFERRED EXEMPLARY EMBODIMENTS

While this invention is susceptible of embodiment in many different forms, there is shown in the drawings and will herein be described in detailed preferred embodiment of the invention with the understanding that the present disclosure is to be considered as an exemplification of the principles of the invention and is not intended to limit the broad aspect of the invention to the embodiment illustrated.

The numerous innovative teachings of the present application will be described with particular reference to the presently preferred embodiment, wherein these innovative teachings are advantageously applied to the particular problems of a DENTAL IMPLANT MANAGEMENT SYSTEM AND METHOD. However, it should be understood that this embodiment is only one example of the many advantageous uses of the innovative teachings herein. In general, statements made in the specification of the present application do not necessarily limit any of the various claimed inventions. Moreover, some statements may apply to some inventive features but not to others.

### Centergistix™ Mark

The use of the trademark CENTERGISTIX™ within the present invention disclosure is only exemplary of a mark that may be used to identify a particular exemplary embodiment of the present invention and does not indicate that this mark is an element of the present invention for the purposes of claims scope. This mark as being exemplary of product identification is not an element of the present invention and remains the property of the mark owner.

### Internet Communication Not Limitive

The present invention anticipates that a wide range of communication methodologies may be utilized to affect a specific implementation of the present invention. While the present invention specifically anticipates the use of the Internet for most applications, the present invention makes no limitation on the type of communication technology or computer networking that may be used. Thus, the term “computer network” and/or “Internet” are to be given the broadest possible definitions within the scope of the present invention.

### Professional Titles Not Limitive

The present invention utilizes the terms “surgeon”, “restorative doctor/dentist”, and “dental lab” and their variants to describe the major professionals associated with a given dental implant procedure. These terms may vary somewhat in the industry and as such should be given a broad definition when used in describing the present invention. The functions of these professionals may in some cases overlap or be associated with a single organization in some circumstances. Regardless of these variations, the major functions of these dental implant professionals (DIPs) can be separated as described in the present invention in order to implement phased execution of the dental implant procedure and within each phase, execution of a phase checklist to ensure proper procedures have been followed within each phase by each dental professional.

### Execution Phases Not Limitive

The present invention in the embodiments described herein utilize a four-phase execution protocol for dental implant procedures comprising a FOUNDATION, IMPLANT PLACEMENT, RESTORATIVE, and MAINTENANCE phases. While these execution phases (and their associated phase checklists) are applicable to most anticipated dental implant procedures, the present invention anticipates that both the execution phases and their associated phase checklists may be augmented by the dental implant professionals to incorporate more or less phases and phase checklists depending on a particular application or implementation.

The present invention may in some preferred embodiments make use of electronic calendaring software such as APPLE® ICAL®, GOGGLE® CALENDAR, LOTUS® NOTES®, MICROSOFT® EXCHANGE®, MICROSOFT® OUTLOOK®, and YAHOO!® CALENDAR in order to schedule appointments between dental patients and dental implant professionals. These electronic calendaring packages are only exemplary of those that may be used in this application context.

The present invention anticipates that some preferred embodiments may utilize calendar “sniffing” to determine the calendar conflicts associated with a given individual (patient or DIP) and use this information to automatically suggest a “provisional” appointment schedule that is consistent with both the individual's calendar and the timing required to complete a milestone within an execution phase checklist (EPC). In this manner the present invention may combine the calendars of various individuals within the dental implant procedure and optimally reduce the patient wait time for next procedure while simultaneously improving the patient throughput performance for the dental implant professional executing the dental implant procedure.

### Scheduling/Triggering of Patient/DIP Interaction Not Limitive

The present invention in the embodiments described herein may utilize a bifurcated methodology to schedule interaction between the patient and dental implant professional. This may involve the “scheduling” of appointments followed by “triggering” of appointment confirmation once the schedule is determined. This two-phase approach permits iterative schedule determination to occur which optimizes patient/DIP time utilization.

As mentioned above regarding “sniffing” of electronic calendar data maintained by the patient and/or DIPs, this conflict information can be retrieved and then used to optimize the execution of the overall patient dental implant procedure as well as optimally fill available appointment time slots for the DIPs involved in the overall patient treatment process.

### Dental Implant Process Overview

The present invention incorporates Case Progress reports for all parties (patient, surgeon, restorative doctor, dental lab, etc.) to enable each party to track and view phases of treatment or status during the dental implant process. Each dental case can be carefully and thoughtfully developed by each dental professional team provider using the present invention to define a specific pathway to success for each patient. The different dental execution treatment phases (ETP) represent the systems, structure, and steps that will ensure the best possible outcome for the patient. Using these methods shortens treatment time, improves the quality of care, and keeps all parties informed at all times.

### Foundation Phase

During the Foundation Phase the fundamental steps are taken to prepare the patient's mouth before the actual implants are placed. Many things can fall into this category, but the main goal is to have the patient's mouth free of dental disease and any infection. It is known by taking these precautions implant treatment is successful in over 99% of dental implant cases.

### Implant Placement Phase

During the Implant Placement Phase the patient receives their implant surgery. The specific placement of each implant can be carefully calculated by the patient's dental team. The use of photographic images, CBCT scans, panoramic x-rays, diagnostic wax-ups (models of the patient's teeth), and surgical guides are just a few of the tools at the dental professional's disposal to perform minimally invasive surgery. These steps speed healing and maximize the accuracy of placement. Once implants have been placed, the usual healing time is 3-4 months before the restorative process can begin.

### Restorative Phase

During the Restorative Phase, the patient's implant is connected to the specific implant crown or prosthesis that will complete the treatment plan. This process can be as simple as a single crown or the entire mouth restored by connecting the implants. In this phase the dental laboratory and the restorative doctor work together to complete your final plan. The dental implant team prepares for this day from the time the patient agrees to treatment to the completion of the final patient treatment. By using all helpful resources possible, such as photographic images, models of patient teeth, X-rays, and phase checklists, the dental implant team eliminates guesswork and optimizes final results for the patient.

### Maintenance Phase

During the Maintenance Phase, the patient receives a timely dental exam and/or dental cleaning necessary to protect their investment. At the end of the restorative phase, the dentist will outline a custom plan for the patient to keep their mouth healthy. Regular exams and X-rays are always an important part of monitoring the patient's long term dental health.

### Treatment Planning/Treatment Sequencing

Within the context of the present invention discussion the term “treatment planning” will generally refer to the generation of one or more “lists” of procedures that must be performed in order to progress the dental implant process forward for the dental patient. The term “treatment sequencing” will refer to the “order” in which the procedures must be performed.

A treatment plan in this context may combine “treatment planning” and “treatment sequencing” in order to ensure that all proper procedures are applied to the patient in the right order with proper cooperation between the patient and all dental implant professionals.

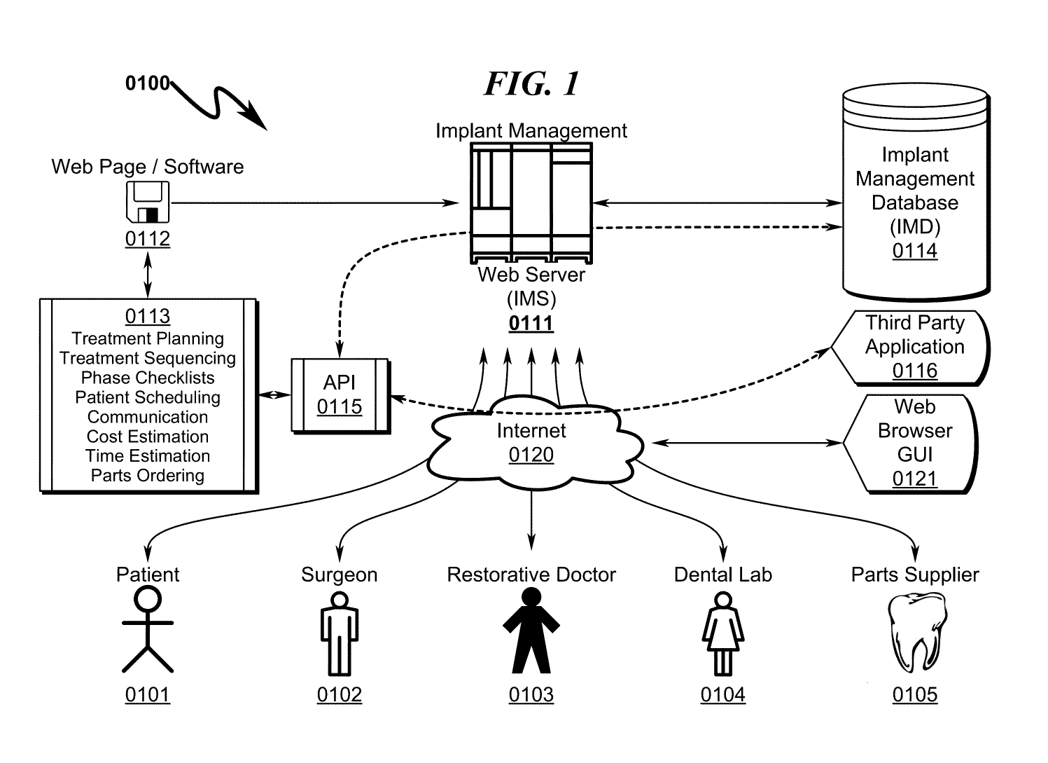

An overview of a presently preferred invention dental implant management system embodiment is generally illustrated in FIG. 1 (0100). Within this exemplary embodiment a patient (0101), surgeon (0102), restorative doctor (0103), dental lab (0104), and dental part supplier (0105) may communicate via the Internet (0120) using a web browser GUI (0121) or other graphical interface with the implant management system embodied as an implant management web server (IMS) (0111) running software read from a computer readable medium (0112). This operational software (0113) may comprise Treatment Planning, Treatment Sequencing, Phase Checklist generation/maintenance, Patient Scheduling, Patient/Dental Professional Communication, Cost Estimation, Time Estimation, Dental Parts Ordering and other functions associated with the coordination and management of a dental implant procedure for the patient (0101) using the professional team (0102, 0103, 0104, 0105). Coordination of the entire process is managed through the use of a common implant management database (IMD) (0114).

Each of the individuals (0101, 0102, 0103, 0104, 0105) participating in the overall dental implant process may interact with the IMS (0111) using a web GUI (0121) via the Internet (0120) to determine the exact status of the dental implant procedure, timeline for completion, cost, next step necessary for successful completion of the procedure, and other information necessary for each individual to optimize their activity with respect to the overall dental implant procedure.

In addition to direct access using a web GUI (0121), the system may also incorporate an application programming interface (API) (0115) that may access and manipulate the (IMD) (0114) under control of a third-party application program (0116) via the Internet (0120).

In contrast to the current standard of care in the prior art, the system as depicted ensures that communication between the interested parties (0101, 0102, 0103, 0104, 0105) is constantly maintained, but also that activities between the parties (0101, 0102, 0103, 0104, 0105) are properly coordinated (based on phased execution of the dental implant procedure coordinated with individualized phase checklists for all relevant participating parties). This combination of communication and coordinated management of activity ensures that no aspect of the dental implant procedure is overlooked or ignored by some oversight by any individual participant (0101, 0102, 0103, 0104, 0105). This coordination of structured execution results in a significant improvement in overall patient satisfaction as compared to the prior art standard of care and reduces the incidence of expensive dental implant rework associated with typical unsatisfactory prior art manual coordination methods.

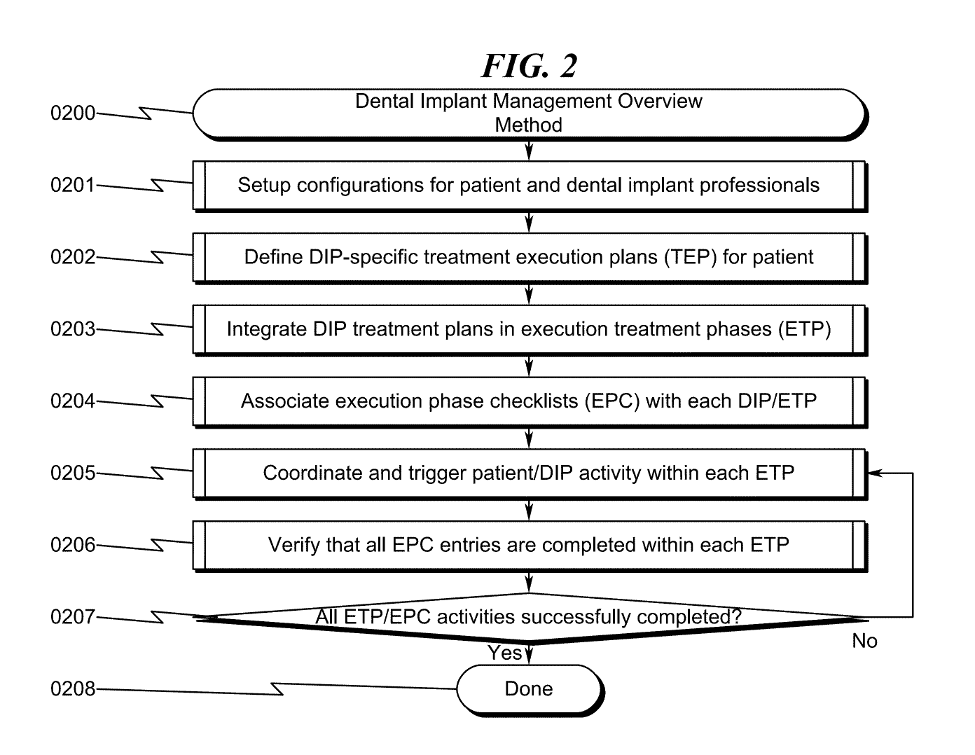

The above-described system may have an associated method as generally depicted in the overview flowchart of FIG. 2 (0200) and can be generalized as a dental implant management method comprising the following steps:
(1) Setting up configuration for a patient and dental implant professionals (DIP) generally consisting of a surgeon, restorative doctor, and dental lab. This configuration information may incorporate a wide variety of information regarding the patient, DIP personnel, treatment teams, sources for dental implant parts, dental parts vendors, etc. that are specific to each party participating in the process (0201);
(2) Generating a treatment execution plan (TEP) customized for the patient by each DIP (0202);
(3) Integrating the separate DIP TEP information into fixed execution treatment phases (ETP) that represent major functional milestones in the overall dental implant process (0203);
(4) Associating execution phase checklists (EPC) provided by each DIP with each of the ETP functional milestones (0204);
(5) Coordinating and triggering patient and DIP activity within each ETP and the associated integrated EPC within each ETP (0205);
(6) Verifying that all EPC entries are completed within each ETP before the next ETP phase is initiated (0206);
(7) Determining if all ETP/EPC activities have been successfully completed, and if not, proceeding to step (5) (0207); and
(8) Indicating completion of the dental implant procedure for the patient (0208).

This general method may be modified heavily depending on a number of factors, with rearrangement and/or addition/deletion of steps anticipated by the scope of the present invention. Integration of this and other preferred exemplary embodiment methods in conjunction with a variety of preferred exemplary embodiment systems described herein is anticipated by the overall scope of the present invention.

This general method overview indicates how the disparate entities associated with the dental implant procedure are integrated into teams (as part of step (1) (0201)). After the treatment plans are generated by the various dental implant professionals (DIPs) this information is integrated into fixed “phases” of treatment plan execution wherein each phase may incorporate a set of checklists provided by each DIP to ensure that no portion of the process is omitted or skipped. It is this imposition of structure among various separate parties that provides the invention a significant improvement over the prior art standard of care in that without some oversight in the coordination of the patient and DIPs, there is no methodology to ensure both the proper sequencing and completion of all tasks necessary to ensure a successful patient outcome.

### Method Detail Flowchart (0300)

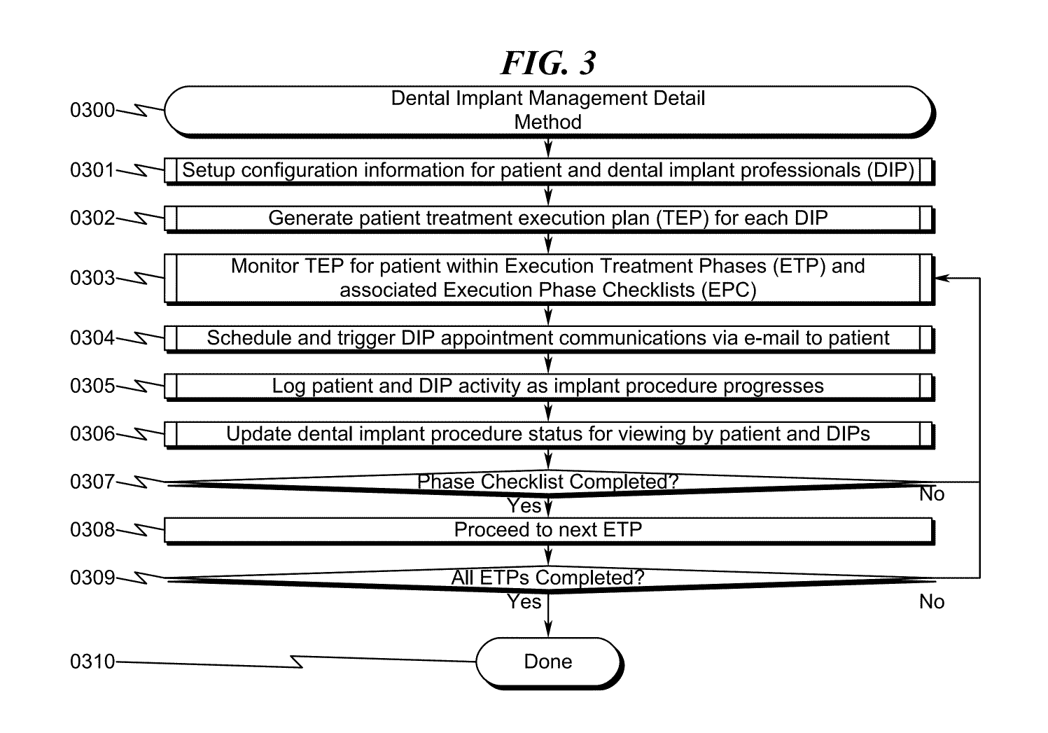

The above-described system may also have an associated method as shown in more detail and depicted in the flowchart of FIG. 3 (0300). This detail that includes additional communication functions can be generalized as a dental implant management method comprising the following steps:
(1) Setting up configuration information for a patient and dental implant professionals (DIPs) generally consisting of a surgeon, restorative doctor, and dental lab (0301);
(2) Generating a treatment execution plan (TEP) customized for the patient by each DIP (0302);
(3) Monitoring the TEPs for the patient within the context of execution treatment phases (ETP) and associated execution phase checklists (EPC) within each ETP (0303);
(4) Scheduling and triggering appointment communications for the patient with each DIP via e-mail to coordinate the execution of the patient
TEP according to the current phase within the ETP (0304);
(5) Logging patient and DIP activity as activities are performed within each ETP (0305);
(6) Updating the dental implant procedure status for viewing by the patient and DIPs (0306);
(7) Determining if the EPC associated with the current ETP is completed, and if not, proceeding to step (3) (0307);
(8) Proceeding to the next ETP and its associated EPC (0308);
(9) Determining if all ETPs have been completed, and if not, proceeding to step (3) (0309); and
(10) Indicating completion of the dental implant procedure for the patient (0310).

This general method may be modified heavily depending on a number of factors, with rearrangement and/or addition/deletion of steps anticipated by the scope of the present invention. Integration of this and other preferred exemplary embodiment methods in conjunction with a variety of preferred exemplary embodiment systems described herein is anticipated by the overall scope of the present invention.

As can be seen from this exemplary method, the present invention is designed to define a structured pathway from initial patient contact to final completion of the dental implant procedure that progresses in predefined phases with each phase incorporating a set of checklists that must be executed by each dental implant professional (DIP) within their respective realm of expertise. Since the patient and each DIP must interact with other parties in the process, the system automatically coordinates these interactions with e-mails and other forms of communication and real-time status information to ensure that the dental implant process progresses from start to completion in the most efficient manner.

### ETP/EPC Structural View (0400)

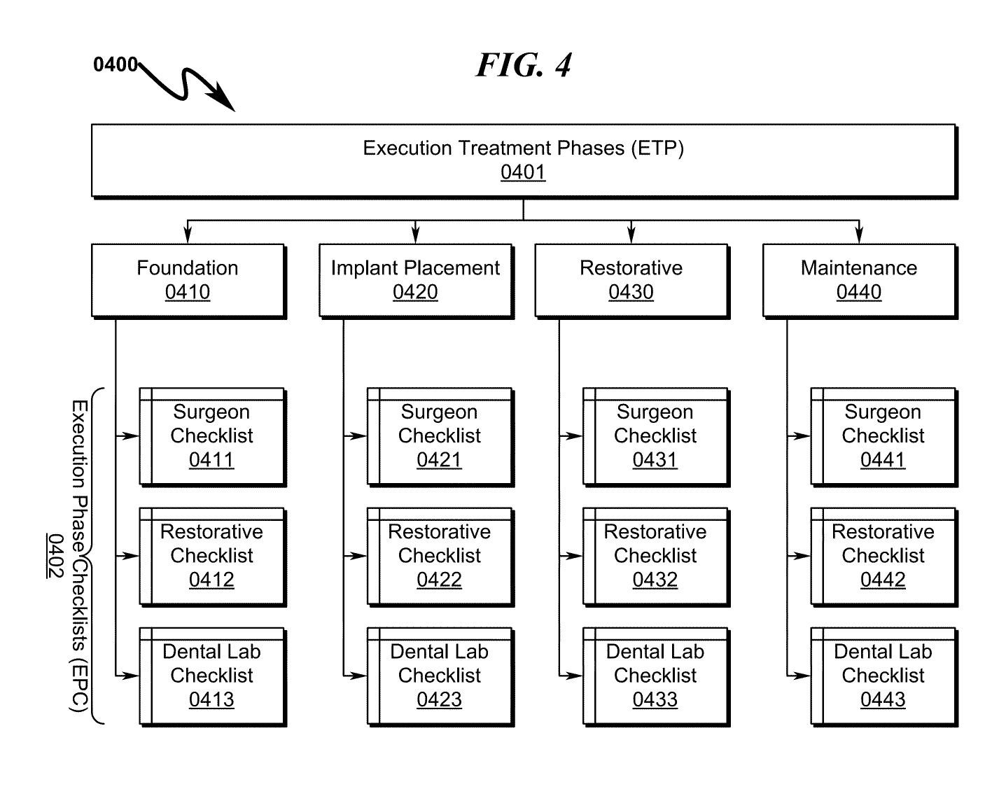

As stated previously, the present invention fractures the overall dental implant process into Execution Treatment Phases (ETP) that act as execution milestones for both the patient and dental implant professionals (DIPs). An exemplary embodiment of this ETP structure is depicted in FIG. 4 (0400) wherein a typical ETP structure (0401) comprises FOUNDATION (0410), IMPLANT PLACEMENT (0420), RESTORATIVE (0430), and MAINTENANCE (0440) phases. While these particular ETPs (0410, 0420, 0430, 0440) are anticipated as optimal within the dental implant process, the present invention is not necessarily limited to these particular phase designations nor is the number of phases limited to the four as indicated. Each of these phase milestones (0410, 0420, 0430, 0440) may have associated with them Execution Phase Checklists (EPC) (0402) that may be specific to each DIP.

As given in this example, the EPCs (0402) may be incorporated within the ETPs (0410, 0420, 0430, 0440) such that each dental implant professional (surgeon, restorative doctor, dental lab, etc.) may have associated EPCs that are separated within each ETP milestone. As indicated here, the surgeon may have EPCs (0411, 0421, 0431, 0441) that span the various ETPs (0410, 0420, 0430, 0440), and this may also be true for the restorative doctor (0412, 0422, 0432, 0442) and the dental lab (0413, 0423, 0433, 0443). In this manner, the particular practice guidelines adopted by each individual DIP may be automatically incorporated into the overall flow of the dental implant process and as such there is much less chance of a critical step being omitted or bypassed during the overall patient treatment process.

It should be noted here that the ability to integrate disparate treatment methodologies from a variety of DIPs in the generation of a patient treatment plan is a very useful feature of the present invention. This enables dental professionals to merge disparate practices into a cohesive patient treatment plan and avoid the confusion associated with differing treatment methodologies that may be associated with the different DIP practices. By allowing each DIP the ability to maintain (and improve) their own practice methodologies and still be able to integrate this knowledge into a cohesive patient treatment plan that adheres to a phased milestone execution approach, the best practices of a wide variety of dental professionals can be merged to provide optimal patient care and procedure outcome.

### Passive Scheduling Method (0500)

The present invention may incorporate a variety of automated scheduling methodologies within the implementation scope of a particular invention embodiment. The general goal of this integrated scheduling methodology is to ensure that the procedure timeline for the patient is minimized while simultaneously improving the appointment coverage ratio for the dental implant professionals (DIPs) treating the patient. This is accomplished by matching the execution phase checklist (EPC) items that the DIPs have determined must be completed by the patient/DIP with appointment time slots that are available with the particular DIP. This matching function accommodates not only the schedule of the patient but that of the DIP provider and takes into account lead/delay times associated with a particular EPC entry.

Since many invention embodiments are web-based singly-threaded execution through a website portal, the system in many embodiments may incorporate a “schedule rethreading” operation upon patient login that determines if any appointments can be scheduled based on outstanding unsatisfied EPC milestones.

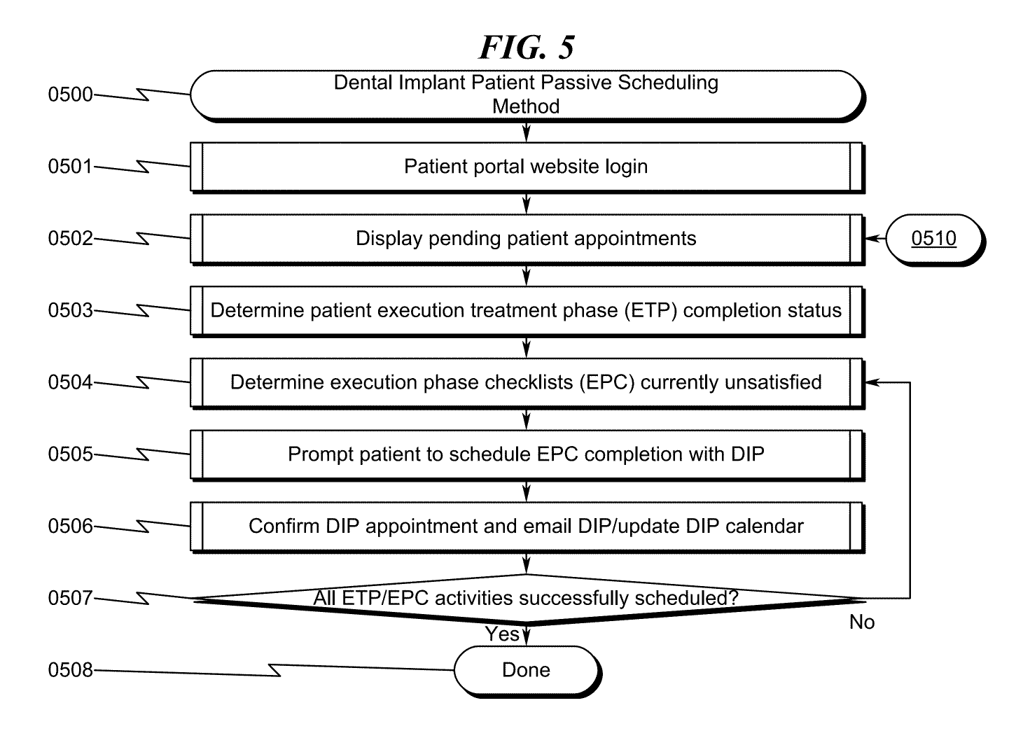

An exemplary passive patient scheduling method supporting this functionality is generally depicted in the flowchart of FIG. 5 (0500). This method can be generalized as a dental implant patient passive scheduling method comprising the following steps:
(1) Logging the patient into the website patient access portal (0501);
(2) Displaying pending patient appointments for the patient to view (0502);
(3) Interrogating the implant management database (IMD) to determine patient execution treatment phase (ETP) completion status (0503);
(4) Determining execution phase checklist (EPC) items within the current ETP phase that are currently unsatisfied (0504);
(5) Prompting the patient to schedule completion of unsatisfied EPC milestones with the DIP associated with each particular EPC milestone (0505);
(6) Confirming the DIP appointment and emailing/updating information to the DIP to schedule the appointment (0506);
(7) Determining if all ETP/EPC activities that are currently outstanding have been scheduled for appointments, and if not, proceeding to step (4) (0507); and
(8) Indicating completion of the dental implant passive scheduling procedure for the patient (0508).

This general method may be modified heavily depending on a number of factors, with rearrangement and/or addition/deletion of steps anticipated by the scope of the present invention. Integration of this and other preferred exemplary embodiment methods in conjunction with a variety of preferred exemplary embodiment systems described herein is anticipated by the overall scope of the present invention.

### Passive Scheduling Update Method (0600)

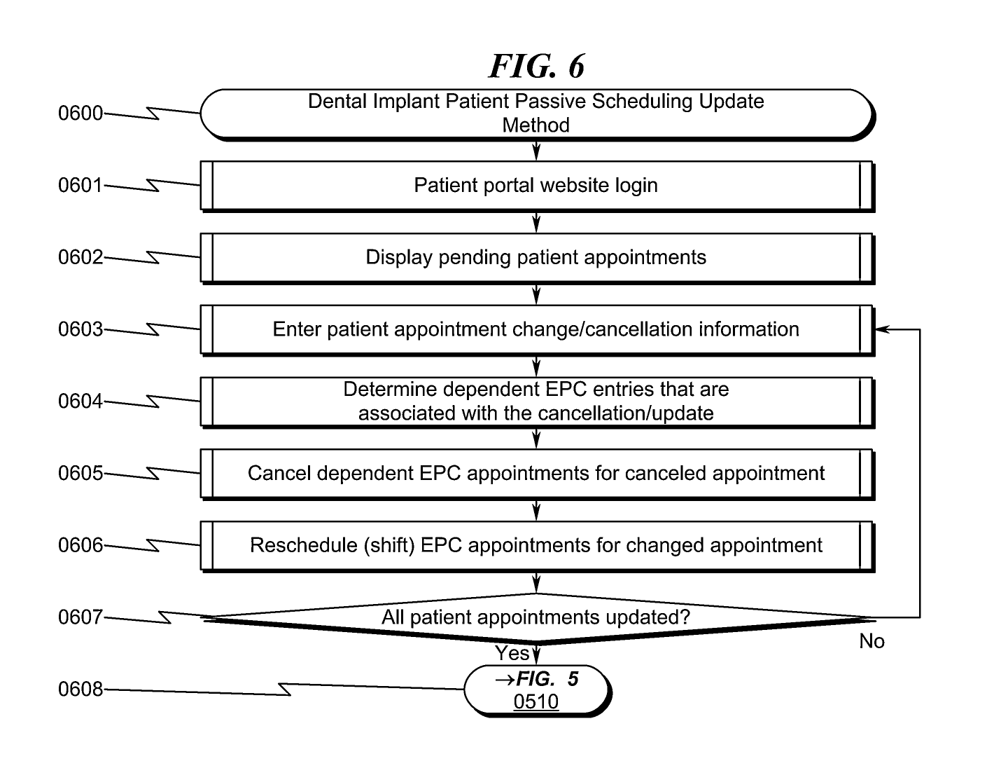

The passive patient scheduling method depicted in FIG. 5 (0500) may incorporate a method to allow the patient to cancel/modify a pending EPC appointment with a DIP and in doing so affect a full update of all appointments associated with the ETP grouping. This methodology is generally illustrated in the flowchart of FIG. 6 (0600). This method can be generalized as a dental implant management patient passive scheduling update method comprising the following steps:
(1) Logging the patient into the website patient portal (0601);
(2) Displaying pending patient appointments for the patient to view (0602);
(3) Entering patient appointment change/cancellation from the website patient access portal (0603);
(4) Determining dependent EPC entries that are associated with the appointment change/cancellation (0604);
(5) Cancelling dependent EPC appointments for a cancelled patient appointment (0605);
(6) Rescheduling (time shifting) EPC appointments for a changed patient appointment (0606);
(7) Determining if all patient appointment changes/cancellations have been propagated through the EPC checklist within the current ETP, and if not, proceeding to step (3) (0607); and
(8) Proceeding to the patient passive scheduling method in step (2) (FIG. 5 (0500, 0510)) (0608).

This general method may be modified heavily depending on a number of factors, with rearrangement and/or addition/deletion of steps anticipated by the scope of the present invention. Integration of this and other preferred exemplary embodiment methods in conjunction with a variety of preferred exemplary embodiment systems described herein is anticipated by the overall scope of the present invention.

### Active Scheduling Method (0700)

The scheduling method depicted in FIG. 5 (0500) was termed “passive” because it involved the patient initiating the process and having the scheduling flow then directed towards the DIP providers for appointment confirmation. The present invention also anticipates that the DIPs may initiate patient scheduling based on a review of patients they are treating and the various ETP phases they are stationed within and the current EPC milestones that are yet to be completed by each patient. This scan of the patient information contained in the IMD permits a variety of long-term scheduling to be coordinated among the various DIPs and a given patient that not only minimizes the patient time of overall treatment but also improves the number of patient appointment slots that are filled for a given DIP provider.

A side benefit of this scheduling process is that dental parts associated with the overall dental implant process need not be stocked by the individual DIPs but can be ordered “just in time” based on the long-term patient scheduling profiles. The scheduling of particular EPC milestones may be configured to automatically generate e-mails to manufacturer representatives for dental parts suppliers to order the particular dental parts needed for the scheduled procedure.

Since many invention embodiments are web-based singly-threaded execution through a website portal, the system in many embodiments may incorporate a “schedule rethreading” operation upon DIP login that determines if any appointments can be scheduled based on outstanding unsatisfied EPC milestones for all patients treated by a given DIP.

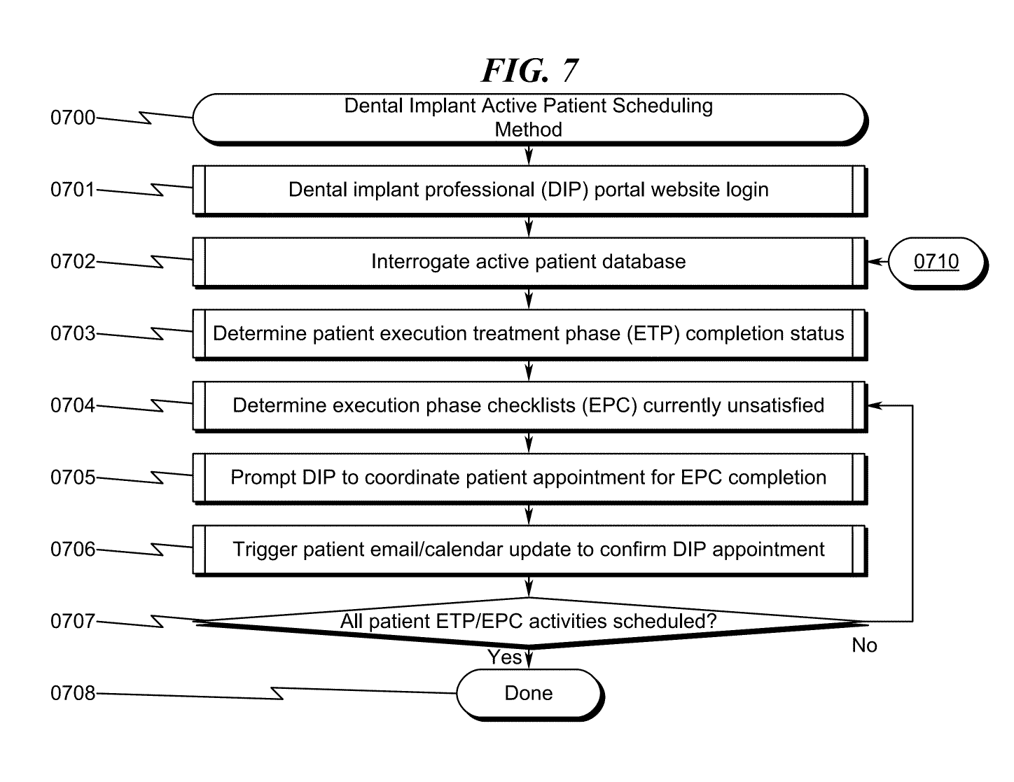

An exemplary active patient scheduling method supporting this functionality is generally depicted in the flowchart of FIG. 7 (0700). This method can be generalized as a dental implant patient active scheduling method comprising the following steps:
(1) Logging the DIP into the website access portal (0701);
(2) Interrogating active patients from the IMD (0702);
(3) Determining the patient execution treatment phase (ETP) completion status for a given patient (0703);
(4) Determining execution phase checklist (EPC) items within the current patient ETP phase that are currently unsatisfied (0704);
(5) Prompting the DIP to coordinate a patient appointment for completion of unsatisfied EPC milestones for the patient (0705);
(6) Triggering patient email/calendar updates to confirm the DIP procedure appointment (0706);
(7) Determining if all ETP/EPC activities that are currently outstanding have been scheduled for appointments, and if not, proceeding to step (4) (0707); and
(8) Indicating completion of the dental implant active scheduling procedure (0708).

This general method may be modified heavily depending on a number of factors, with rearrangement and/or addition/deletion of steps anticipated by the scope of the present invention. Integration of this and other preferred exemplary embodiment methods in conjunction with a variety of preferred exemplary embodiment systems described herein is anticipated by the overall scope of the present invention.

### Active Scheduling Update Method (0800)

The active patient scheduling method depicted in FIG. 7 (0700) may incorporate a method to allow the DIP to resequence pending appointments based on canceling/modifying and EPC appointment or due to situations in which the patient treatment plan is modified and as a result the EPC milestone list associated with a particular patient ETP must be modified. Since the treatment plan for a given patient is somewhat fluid and may require modification based on new/changed information that is discovered during various EPC treatment milestones, the present invention anticipates this eventuality and provides a methodology whereby the DIP may modify the EPC milestone list for a patient and have this information “ripple” through the system to reschedule appointments and other dependencies to ensure that minimal overall patient treatment time in conjunction with optimum DIP utilization/profit is maintained.

Without this appointment rescheduling methodology, a cancelled appointment may require significant and unnecessary communication between the patient and DIPs to ensure that no time is lost because of the missed/cancelled appointment. Furthermore, since it is often the case that a particular EPC milestone may discover a previously undiscovered problem with the patient that must be addressed using one or more new/modified EPC milestones added to the treatment plan, the present invention permits this new information to cascade through the system to permit a long-term patient treatment schedule to be maintained without the need for additional manual intervention by either the patient or individual DAP.

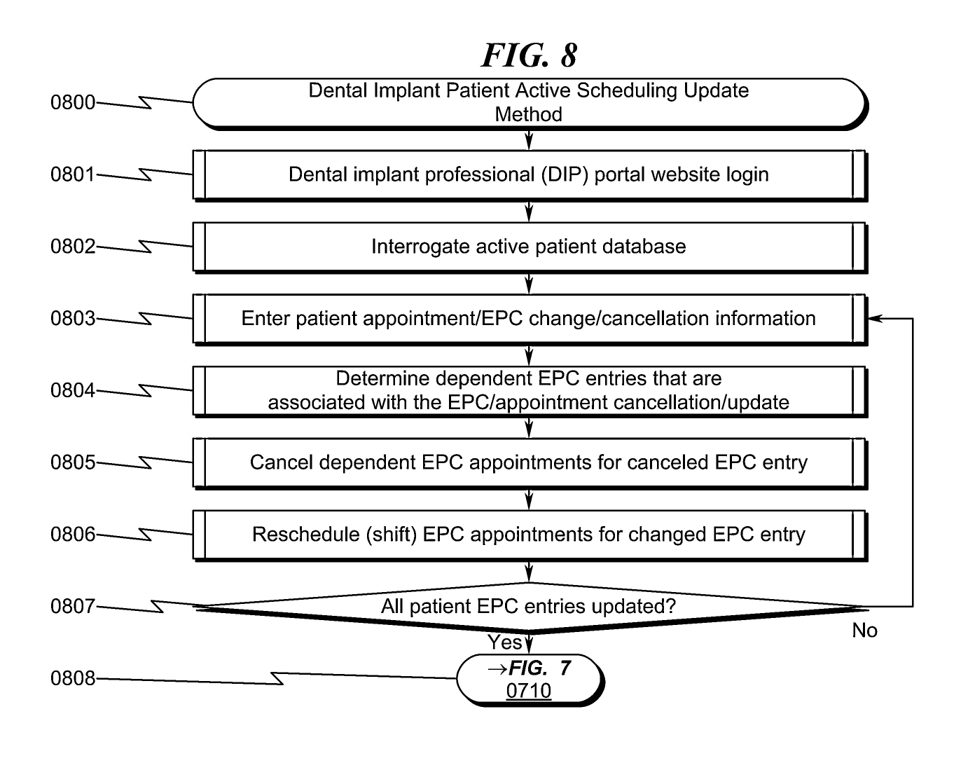

This methodology is generally illustrated in the flowchart of FIG. 8 (0800). This method can be generalized as a dental implant management patient active scheduling update method comprising the following steps:
(1) Logging the DIP into the website DIP portal (0801);
(2) Interrogating the active patient database from the IMD for the DIP (0802);
(3) Entering patient appointment/EPC change/cancellation information from the website DIP access portal (0803);
(4) Determining dependent EPC entries that are associated with the EPC/appointment change/cancellation as defined by the DIP data entries (0804);
(5) Cancelling dependent EPC appointments for a cancelled EPC/appointment entries (0805);
(6) Rescheduling (time shifting) EPC appointments for a changed EPC/appointment entry (0806);
(7) Determining if all EPC/appointment changes/cancellations have been propagated through the EPC checklist within the current ETP, and if not, proceeding to step (3) (0807); and
(8) Proceeding to the patient active scheduling method in step (2) (FIG. 7 (0700, 0710)) (0808).

This general method may be modified heavily depending on a number of factors, with rearrangement and/or addition/deletion of steps anticipated by the scope of the present invention. Integration of this and other preferred exemplary embodiment methods in conjunction with a variety of preferred exemplary embodiment systems described herein is anticipated by the overall scope of the present invention.

This updating methodology takes the approach that EPC and/or appointment dependencies may be “shifted” in time due to a rescheduled DIP appointment associated with a given EPC procedure, but may necessarily have to be cancelled if a given EPC procedure is deleted from the patient treatment plan. Similarly, if a new EPC milestone is added to the treatment plan, the EPC milestones may necessarily trigger new patient appointments to be triggered and scheduled from the active patient scheduler depicted in FIG. 7 (0700).

Since a given DIP typically utilizes a scheduling coordinator/assistant (SCA) to monitor the patient flow through the DIP practice, the SCA can utilize the active patient scheduling as depicted to ensure that the DIP office is fully scheduled based on an optimal intake of patients consistent with optimum utilization of DIP resources. Note that while it may be possible to manually coordinate the appointments for a few patients within a given DIP practice, the ability to cross domains among various DIPS and the patient while still ensuring that the ETP protocols and associated EPC milestones are properly synchronized is not currently possible using current standards of care without resorting to telephone calls between the individual DIP practices. This quickly becomes an inefficient and unmanageable quagmire of timing dependencies that is both frustrating to the patient and individual DIP practices.

### Exemplary Dental Implant Communication Flow (0900)-(1000)

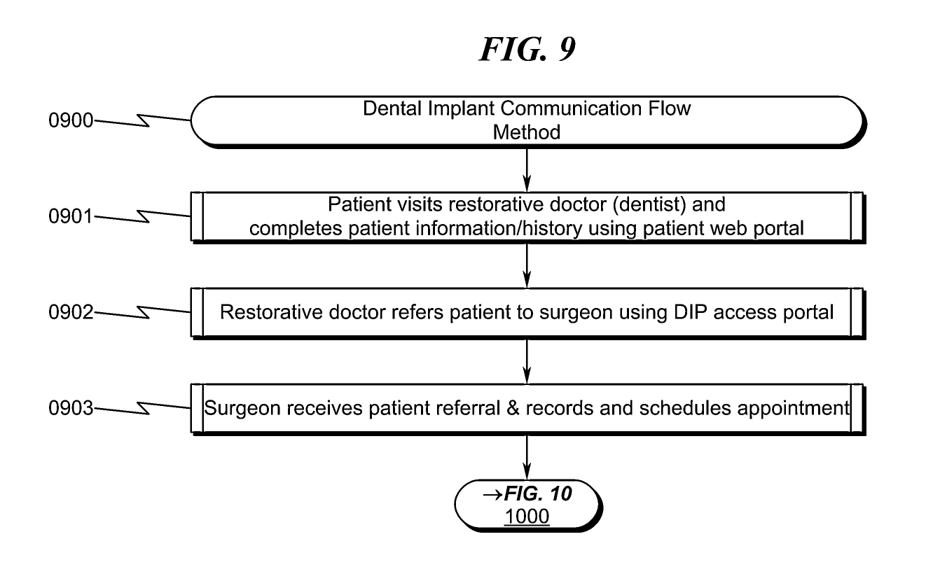

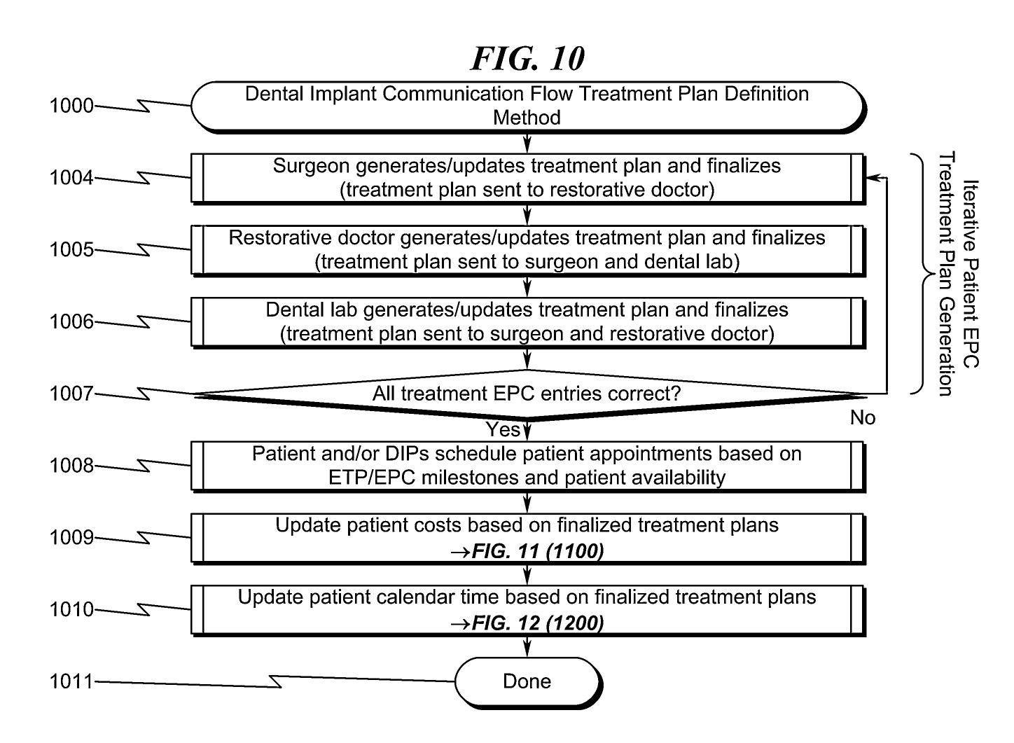

The scheduling methodologies depicted in FIG. 5 (0500)-FIG. 8 (0800) are typically associated with a predefined communication flow between the patient and the dental implant professionals that is generally depicted in FIG. 9 (0900) and FIG. 10 (1000). This flowchart depicts a typical interaction between DIPs comprising a surgeon, restorative dentist, and dental laboratory. Here the communication and interaction may be defined in the following steps:
(1) Patient visit to dentist (0901). Here the patient typically visits their dentist (restorative doctor) and is instructed to interact with the patient access portal to provide patient information, medical history, and dental history to the dentist. The dentist may perform an analysis of the patient's dental needs and deduce that a dental implant is warranted.
(2) Referral to surgeon (0902). The dentist refers the patient to a surgeon using the restorative doctor web access portal. This automatically associates the surgeon with the patient treatment team and provides the surgeon access to the patient medical history, including case file information provided by the dentist.
(3) Surgeon appointment (0903). The surgeon schedules an appointment with the patient using the surgeon web access portal that interacts with the patient web access portal to schedule and trigger the appointment.
(4) Surgeon treatment plan (1004). The surgeon generates a treatment plan for the patient and finalizes the plan which is then distributed to the restorative doctor and the dental laboratory.
(5) Restorative doctor treatment plan (1005). The restorative doctor generates a treatment plan for the patient and finalizes the plan which is then distributed to the surgeon and the dental laboratory.
(6) Dental laboratory treatment plan (1006). The dental laboratory generates a treatment plan for the patient and finalizes the plan which is then distributed to the surgeon and the restorative doctor.
(7) Updating coordinated treatment plans (1007). The treatment plans for the surgeon, restorative doctor, and dental laboratory may be updated/iterated based on information from the other cooperating DIP parties to ensure that a complete treatment plan including all anticipated EPC milestones is completed. This may involve multiple iterations of steps (4)-(6).
(8) Patient scheduling (1008). Once the treatment plans have been finalized for the surgeon, restorative doctor, and laboratory, the appointments may be scheduled for the patient with all DIPs. This step may include generation of patient calendaring to inform all parties as to the anticipated scheduling of events as well as cost estimate generation for all phases of the process. This process may incorporate anticipatory ordering of dental parts by various DIPs as well as preliminary scheduling of appointments based on anticipated completion of individual EPC milestones.
(9) Cost Updating (1009). Once the treatment plan has been defined by the DIPs in terms of the various EPC milestones associated with each portion of the treatment plan (as fractured within the various ETP phases), the patient cost associated with each ETP phase may be calculated as well as the overall total cost of the dental implant procedure. This information may be made available to the patient as well as each DIP in the dental implant team so that the patient is continuously apprised of the current expected costs of the procedure. Note that the iterative nature of the treatment plan modification (during execution of the EPC milestones) permits updating of the cost as any changes are made to the treatment plan by the DIPs.
(10) Calendar Updating (1010). Once the treatment plan has been defined by the DIPs in terms of the various EPC milestones associated with each portion of the treatment plan (as fractured within the various ETP phases), the EPC milestones once defined can have associated with them an expected timeframe for completion that allows a calendar completion dashboard to be made available to the patient and DIPs so that all parties are aware of the timeframe for procedure completion and where the patient is currently positioned within the overall dental implant procedure. Note that the iterative nature of the treatment plan modification (during execution of the EPC milestones) permits updating of the completion time as any changes are made to the treatment plan by the DIPs.

While this is not the only communication/interaction scenario that may occur between the parties, it generally illustrates how the present invention is used to coordinate communication and activity between the parties to affect the dental implant procedure for the patient.

### Exemplary Cost Updating Method (1100)

A significant problem in the standard of care in the prior art is the inability for the patient and/or any DIP to quickly apprise the patient on the costs associated with the dental implant procedure. Given that many professionals are involved in this procedure and that each involves different information and procedure flows, the ability to integrate this information into cohesive cost breakdowns to the patient and DIPs has not been readily available within the prior art standard of care.

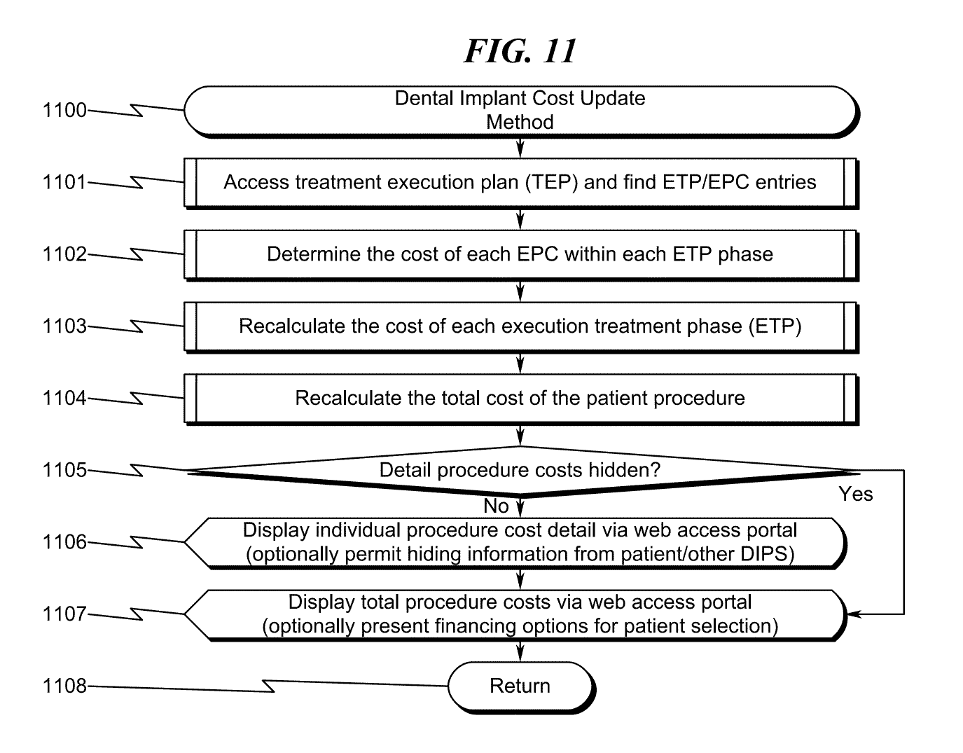

The present invention anticipates a cost updating method as generally described in FIG. 11 (1100) that allows real-time updating of dental implant procedure costs to both the patient and DIPs involved in the process. This cost updating method generally comprises the following steps:
(1) Accessing the patient treatment execution plan (TEP) and finding the ETP/EPC entries for the plan (1101). This step involves patient lookup and itemization of the EPC procedures associated with the overall patient dental implant procedure.
(2) Determining the cost of each EPC procedure within a given ETP phase (1102). Each EPC procedure can have associated with it a procedure cost within the implant management database (IMD) as defined by the particular DIP responsible for maintaining the EPC entry.
(3) Recalculate the cost of each execution treatment phase (ETP) (1103). By collecting the EPC entries for each ETP phase, a subtotal of costs per ETP phase can be generated.
(4) Recalculate the total cost of the patient dental implant procedure (1104). By summing the ETP subtotal costs a total patient cost can be calculated.
(5) Determining if cost detail is to be hidden (1105). If individual DIP cost detail is to be hidden, control passes to step (7).
(6) Displaying individual procedure cost detail via a web access portal (1106). Individual cost breakdowns for each EPC can be presented for inspection by the patient and/or DIPs if authorized. This information may be optionally selected by the providing DIP to be hidden from the patient and/or other DIPs involved in the dental implant procedure. This security measure permits proprietary costing information local to an individual DIP to be maintained in confidence to protect their competitive advantage in the marketplace. These subtotalized costs reflect the current state of the patient ETP/EPC TEP.
(7) Displaying total procedure costs via a web access portal (1107). Total procedure costs, broken down by ETP phase can be displayed to the patient and/or DIPs. These totalized costs reflect the current state of the patient ETP/EPC TEP. This step may also include the presentation/linkage to a financing website or other financial portal to allow the patient to determine the financed cost of the procedure. This optional capability permits a patient to compare the costs of various financing options in conjunction with a variety of implementation timelines for the total dental implant procedure completion. This optional financing feature may link in a number of financing providers to display various financing options to the patient in a menu-style display and thus permit the patient to choose a financing option that meets their needs.
(8) Return from procedure (1108). Cost updating is terminated and control returns to the calling module.

As detailed in this procedure, the individual DIPs have control as to the scope of cost disclosure within this updating scenario. Some DIPs may prefer to “hide” their per-procedure costs and instead only opt to provide disclosure of their “total” procedure cost. This permits individual DIPs to adjust internal optimizations to be competitive in the market yet avoid disclosure of confidential internal pricing information.

### Exemplary Calendar Time Updating Method (1200)

A significant problem in the standard of care in the prior art is the inability for the patient and/or any DIP to quickly apprise the patient on the calendar time (execution time) associated with the dental implant procedure. Given that many professionals are involved in this procedure and that each involves different information and procedure flows, the ability to integrate this information into cohesive timeline breakdowns to the patient and DIPs has to date not been readily available.

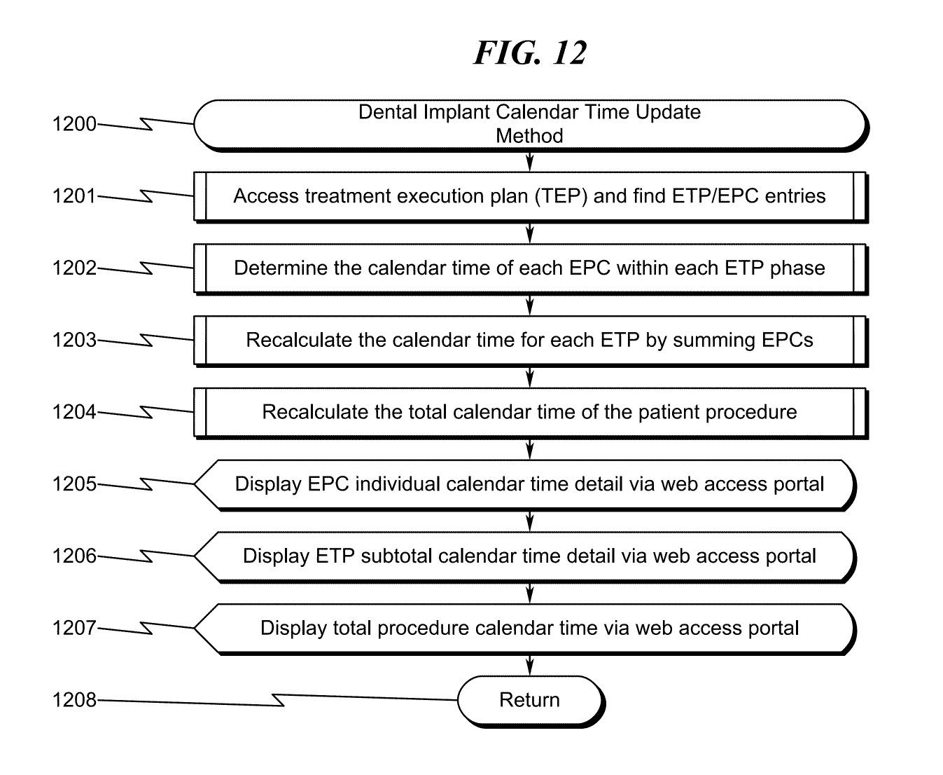

The present invention anticipates a calendar time updating method as generally described in FIG. 12 (1200) that allows real-time updating of dental implant procedure costs to both the patient and DIPs involved in the process. This cost updating method generally comprises the following steps:
(1) Accessing the patient treatment execution plan (TEP) and finding the ETP/EPC entries for the plan (1201). This step involves patient lookup and itemization of the EPC procedures associated with the overall patient dental implant procedure.
(2) Determining the calendar time of each EPC procedure within a given ETP phase (1202). Each EPC procedure can have associated with it a procedure calendar time (execution time) within the implant management database (IMD) as defined by the particular DIP responsible for maintaining the EPC entry.
(3) Recalculate the calendar time of each execution treatment phase (ETP) (1203). By collecting the EPC entries for each ETP phase, a subtotal of calendar time per ETP phase can be generated.
(4) Recalculate the total calendar time of the patient dental implant procedure (1204). By summing the ETP subtotal calendar times a total patient calendar time can be calculated.
(5) Displaying individual procedure calendar time detail via a web access portal (1205). Individual calendar time breakdowns for each EPC can be presented for inspection by the patient and/or DIPs if authorized. These individualized calendar times reflect the current state of the patient ETP/EPC TEP.
(6) Displaying ETP subtotal procedure calendar time detail via a web access portal (1206). Subtotal calendar time breakdowns for each EPC/ETP group can be presented for inspection by the patient and/or DIPs if authorized. These subtotalized calendar times reflect the current state of the patient ETP/EPC TEP.
(7) Displaying total procedure calendar times via a web access portal (1207). Total procedure calendar times, broken down by ETP phase can be displayed to the patient and/or DIPs. These totalized costs reflect the current state of the patient ETP/EPC TEP.
(8) Return from procedure (1208). Calendar time updating is terminated and control returns to the calling module.

As detailed in this procedure, the method is capable of automatically updating the timeline for completion as each DIP modifies the EPC for the patient (as EPCs may change dynamically based on new information discovered during a previous procedure, etc.). Note that this calendar time updating procedure may work in conjunction with the scheduling methodologies depicted in FIG. 5 (0500)-FIG. 8 (0800) so that scheduling conflicts (for the patient and/or DIPs) which result in EPC execution delays ripple through the calendar time calculation process. Thus, while the EPC calendar time estimates provided in the IMD may be used as a general guide to the formulation of total calendar time estimates, they may be augmented with other calendar scheduling information provided by the patient and or DIPs to form a more formal and accurate overall calendar time estimate.

### EPC Execution Flow Control (1300)-(1600)

### Overview

The present invention anticipates that the execution phase checklists (EPC) associated within a given execution treatment phase (ETP) may be configured by the DIPs to incorporate grouping and sequencing methodologies to ensure minimized patient completion time of the overall dental implant procedure and maximum optimization of available DIP procedure execution appointments. It is significant to realize that to accommodate both the volume and complexity of dental implant procedures over a wide variety of inter-cooperating DIPs with numerous patients that existing methods using spreadsheet completion protocols for patients is insufficient to ensure that all parties cooperate properly, the patient is rapidly moved through the dental implant procedure, and the appointment treatment resources of the various DIPs are efficiently utilized.

The complexities of coordinating schedules among various parties to the process is currently accomplished using manual methodologies, but suffers from inefficiencies associated with dynamically changing schedules and the inability to adequately distinguish EPC procedures that must be sequenced in time and those that can be grouped and executed in any order that is convenient for patient/DIP scheduling.

### General DIP EPC Procedure Flows (1300)

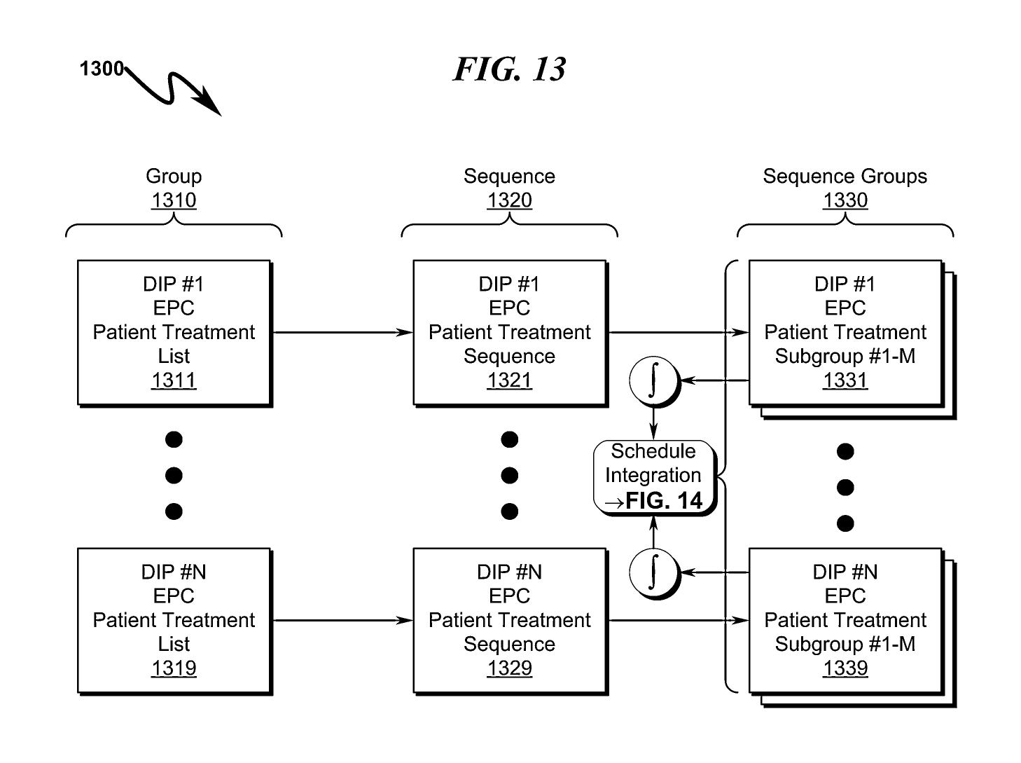

An overview of a generalized EPC procedure flow from the perspective of several DIPs is depicted in FIG. 13 (1300), wherein a number of DIPs (1-N) each may have grouped treatment plans (1310) that individually list the necessary procedures to implement the patient treatment (1311, 1319). Note at this stage of planning each DIP (1-N) has only grouped the “list” of procedures/treatments that must be implemented on the patient.

These grouped treatments (1311, 1319) may then be sequenced (1320) into individual patient treatment sequences (1321, 1329) that may impose strict sequencing “ordering” restrictions on certain procedures and EPC milestones. For example, an X-ray may be required before a surgical consult is scheduled, etc. At this stage each DIP (1-N) may still be operating within the confines of their own specialty with regard to the treatment sequencing operations (1321, 1329).

Within each treatment sequencing operation (1321, 1329) there may exist opportunities to “group” (1330) EPC procedures (1331, 1339) that need not occur in any particular order and which can be executed as “subgroups” (1-M) within the particular treatment sequence (1321, 1329). These sequenced groups (1330) represent an opportunity to optimize patient scheduling with the various DIPs to ensure that total patient treatment calendar time is minimized while filling all available DIP patient treatment appointment slots.

### Exemplary Schedule Integration Methodology (1400)

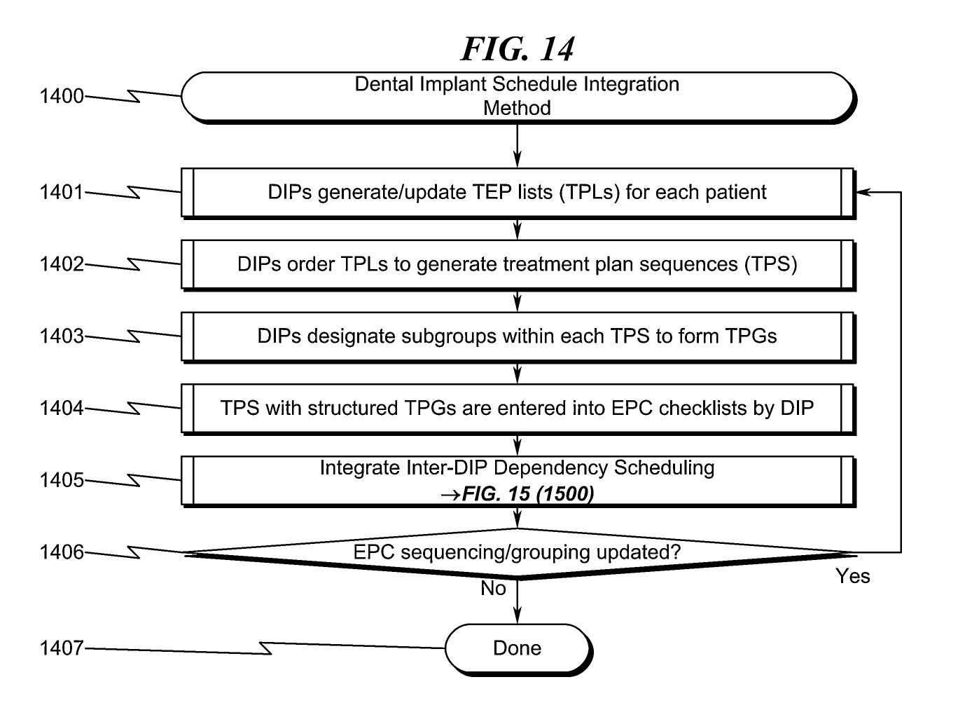

An exemplary methodology depicting integration of the schedules illustrated generally in FIG. 13 (1300) is provided in the flowchart of FIG. 14 (1400), wherein a schedule integration method is depicted that generally comprises the following steps:
(1) Allowing the DIPs (via a GUI) to generate/update treatment execution plan (TEP) lists (TPLs) for each patient (1401). This step allows each DIP the opportunity to determine what procedures must be incorporated into the EPC, but not necessarily what order they are to be performed.
(2) Allowing the DIPs (via a GUI) to order the TPLs to generate treatment plan sequences (TPS) for the patient (1402). Here the EPC procedures are ordered by the DIP to ensure they occur in the proper sequence.
(3) Allowing the DIPs (via a GUI) to define subgroups within the TPS to form treatment plan groups (TPGs) that may be simultaneously executed (1403). This allows a given TPS thread to be subgrouped to permit simultaneous activity. For example, a dental X-ray and photograph might be taken in a single setting at the restorative dentist office.
(4) Allowing the DIPs (via a GUI) to enter the TPGs into the EPC checklist associated with the patient (1404). This step permits integration of the TPS sequence thread and TPG subgroups into the EPC definition for the patient. This may occur using a GUI that permits resequencing of items in a list, dragging/dropping items from one sequence/group to another, dragging/dropping items to resequenced them within a list, or selecting various items as being subgrouped or fixed as a sequence.
(5) Integrating inter-DIP dependency scheduling (1405). This step allows a given DIP to cross-link dependencies between their TPS/TPG ECP structure to those defined by another DIP. This permits a given DIP to define sequencing and grouping across DIP-EPC boundaries.
(6) Determining if EPC sequencing/grouping has been modified, and if so, proceeding to step (1) (1406). If the DIP has modified the dependencies within the EPC either directly or via an inter-DIP sequence/grouping reference, there may be a need for additional EPC modification by the DIP. If so, the procedure is iterated until the DIP is satisfied with the overall patient treatment plan.
(7) Procedure termination (1407). Scheduling integration terminates and returns to any calling module.

As detailed previously, updating of the patient EPC milestone definitions may result in automatic updating of estimated treatment costs and estimated calendar time for the overall dental implant procedure.

### Exemplary Schedule Integration Inter-DIP Dependency Methodology (1500)

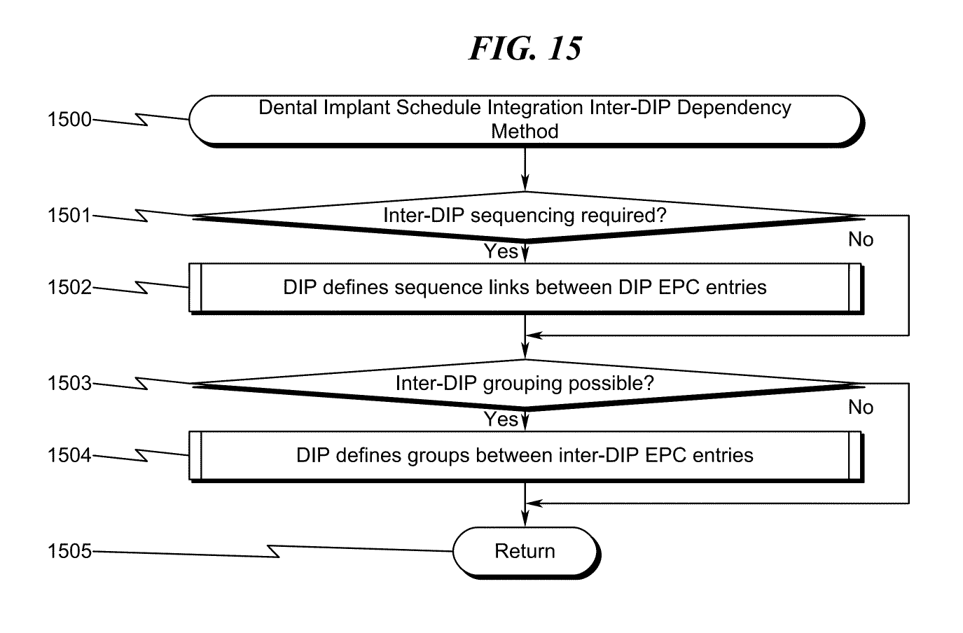

The inter-DIP dependency integration methodology generally depicted in FIG. 14 (1400) is provided further detail in the flowchart of FIG. 15 (1500), wherein a schedule integration inter-DIP dependency definition method is depicted that generally comprises the following steps:
(1) Determining if inter-DIP sequencing is required, desirable, or possible, and if not, proceeding to step (3) (1501). This step allows the DIP to determine if sequencing is to be performed between inter-DIP EPC entries.
(2) Allowing the DIPs (via a GUI) to define sequence links between DIP EPC entries (1502). This interface graphically permits a DIP to associate a sequence link between their EPC procedure and that of another provider. Typical sequence restrictions might include “before”, “after”, “coincident within <time>”, etc.
(3) Determining if inter-DIP grouping is required, desirable, or possible, and if not, proceeding to step (5) (1503). This step allows the DIP to determine if grouping is to be performed between inter-DIP EPC entries.
(4) Allowing the DIPs (via a GUI) to define groups between inter-DIP EPC entries (1504). This interface graphically permits a DIP to associate a group link between their EPC procedure (or group of EPC procedures) and that of another provider. Typical group conditions may include preferred ordering within the grouping, etc.
(5) Procedure termination (1505). Inter-DIP dependency scheduling integration terminates and returns to any calling module.

One skilled in the art may implement this methodology in a variety of ways, including incorporating this procedure within intra-DIP EPC definition/editing dialogs or other DIP GUI website portals.

### Exemplary Group/Sequencing EPC Data Flow (1600)

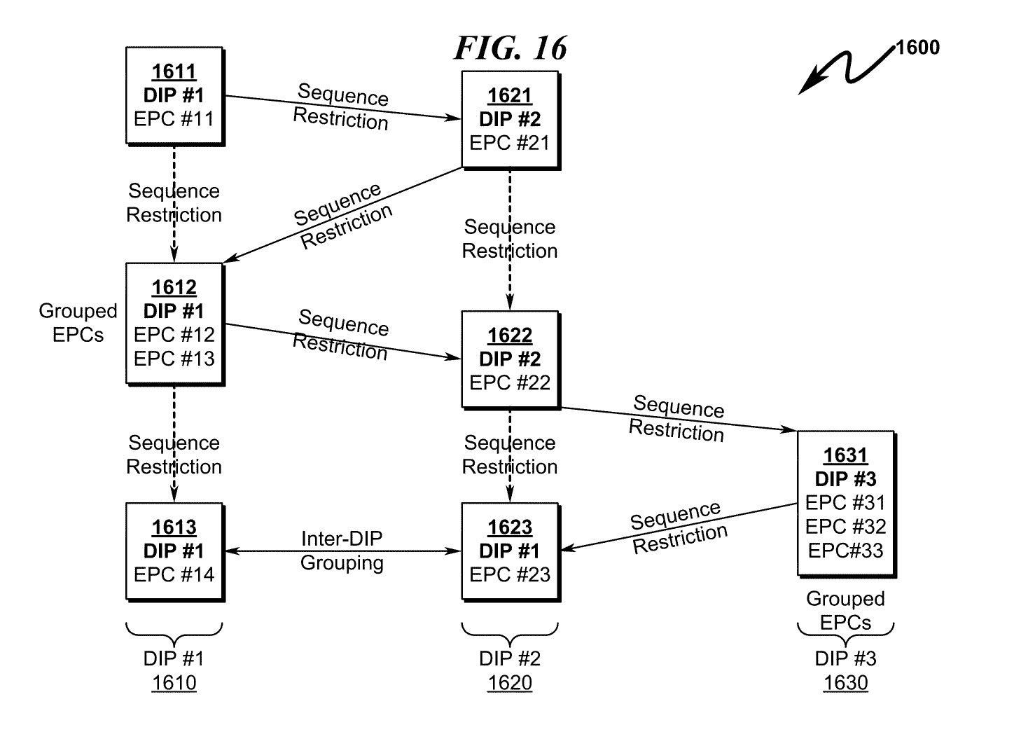

An exemplary group/sequencing EPC data flow diagram depicting the concepts of grouping and sequencing both in intra-DIP and inter-DIP EPC procedure scheduling is provided in FIG. 16 (1600). Here there are provided examples of three separate DIPs (1610, 1620, 1630) each with their respective separate treatment plan sequences ((1611, 1612, 1613); (1621, 1622, 1623); (1631)). Within each DIP-specific treatment plan there are implicit sequence restrictions (within a particular vertical DIP flow) that require a particular order of execution, and these may involve grouped EPCs (1612, 1631) that may be executed in any order.

As depicted in the flow diagram, inter-DIP sequence restrictions (represented by diagonal sequence restriction arrows) require that ordering of particular inter-DIP EPC elements be performed in a particular sequence. Inter-DIP grouping may also be performed as illustrated in the diagram, where various inter-DIP EPCs (1613, 1623) may be performed in any order. In this case, the inter-DIP sequence dependency between (1631) and the inter-DIP grouping (1613, 1623) requires that the grouped elements (1613, 1623) may be performed in any order subject to initiation after completion of EPC (1631).

### Dental Implant Inventory Optimization

Within this context, the ability to initiate parts ordering based on this dependency diagram permits an additional cost optimization for the DIPs to occur with respect to reduction of dental implant part inventories. A typical DIP can substantially reduce the inventory of required dental implant parts by using this schedule dependency structure to order implant parts only when critical stages in the dental implant process have occurred. Since a typical DIP may incur USD$100,000.00 in dental implant inventory using current prior art standard of care guidelines, the ability to order dental implant parts “just in time” based on the optimized patient scheduling depicted in FIG. 13 (1300)-FIG. 16 (1600) can significantly improve the profitability of a given DIP professional practice.

### Exemplary Patient Web Portal (1700)-(2400)

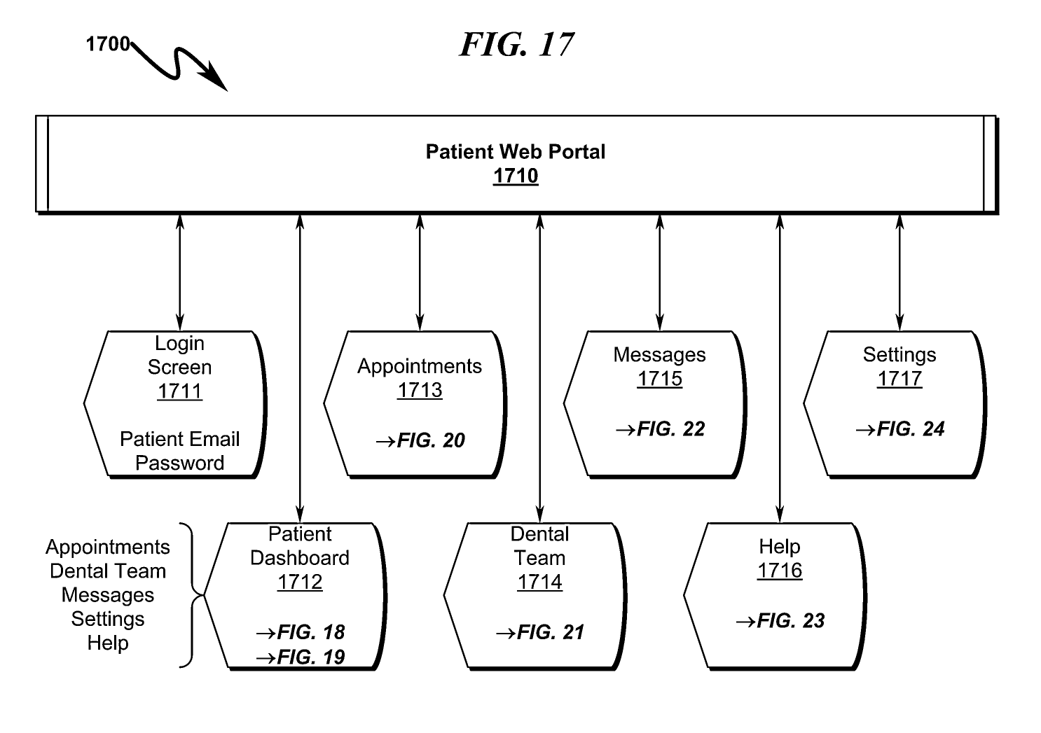

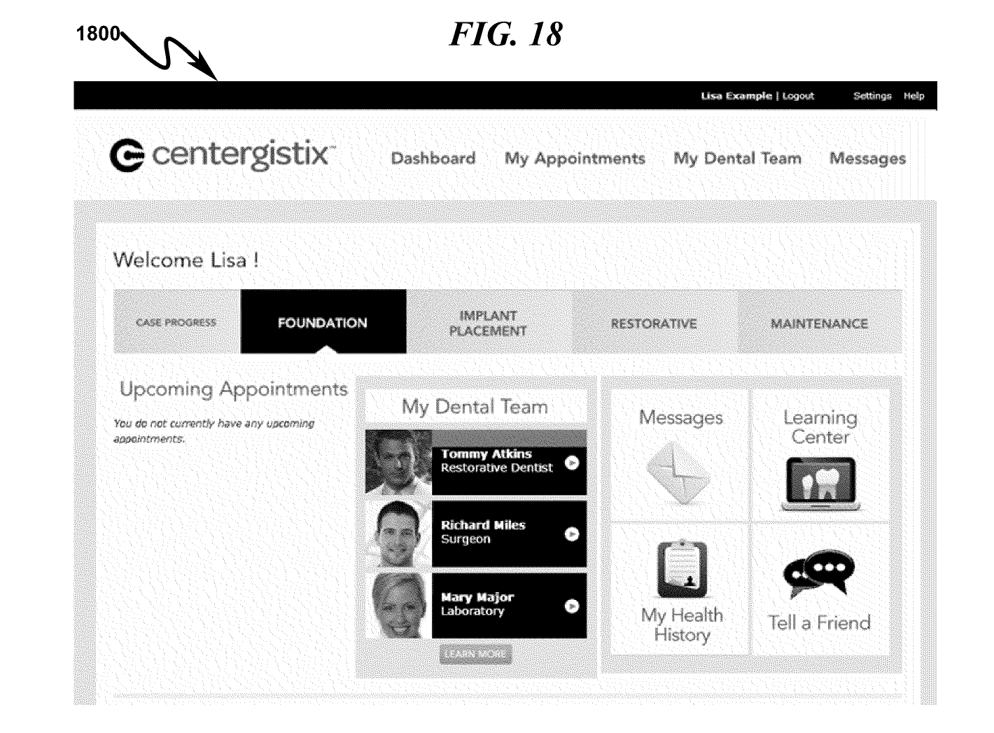

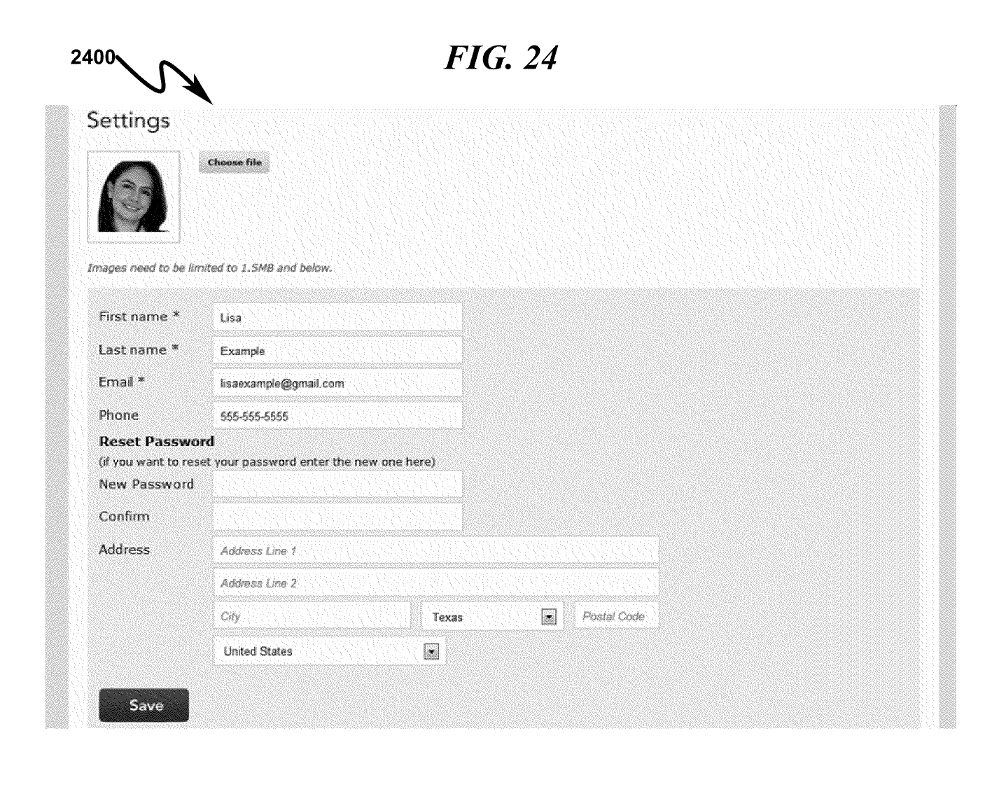

A preferred exemplary patient web portal embodiment is generally illustrated in the overview structure of FIG. 17 (1700) and the exemplary dialog screens depicted in FIG. 18 (1800)-FIG. 24 (2400). These various exemplary dialogs will be discussed in more detail below.

### Login Screen (1711)

The login screen provides secure access to the patient web portal using a patient identifier (username) (typically a patient e-mail address) and an associated password. This dialog is not depicted in detail as it is well known to one skilled in the art.

### Patient Dashboard (1712)

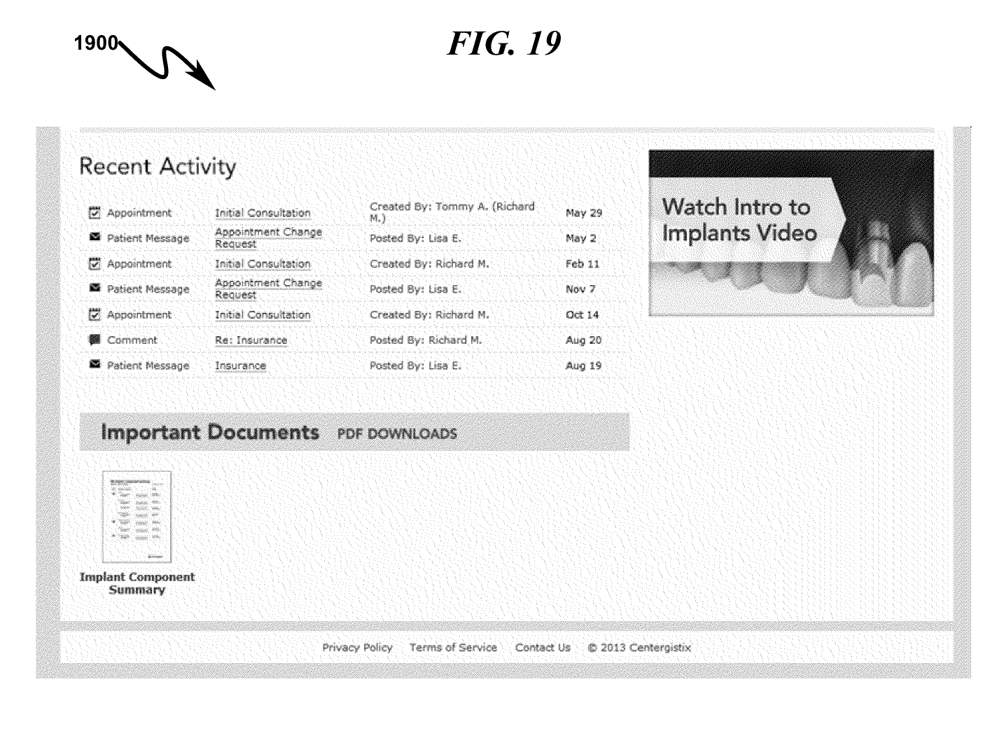

This dialog as generally depicted in FIG. 18 (1800)-FIG. 19 (1900) provides an overview as to the patient progress through the dental implant process and also tabbed access to other informational and setup patient dialogs.

As indicated, this dialog may also provide an Implant Component Summary document to allow the patient to have access to the dental parts that are associated with the implant procedure. This document is an important historical document for the patient to ensure that they have this information for future maintenance of their dental implants.

### Appointments (1713)

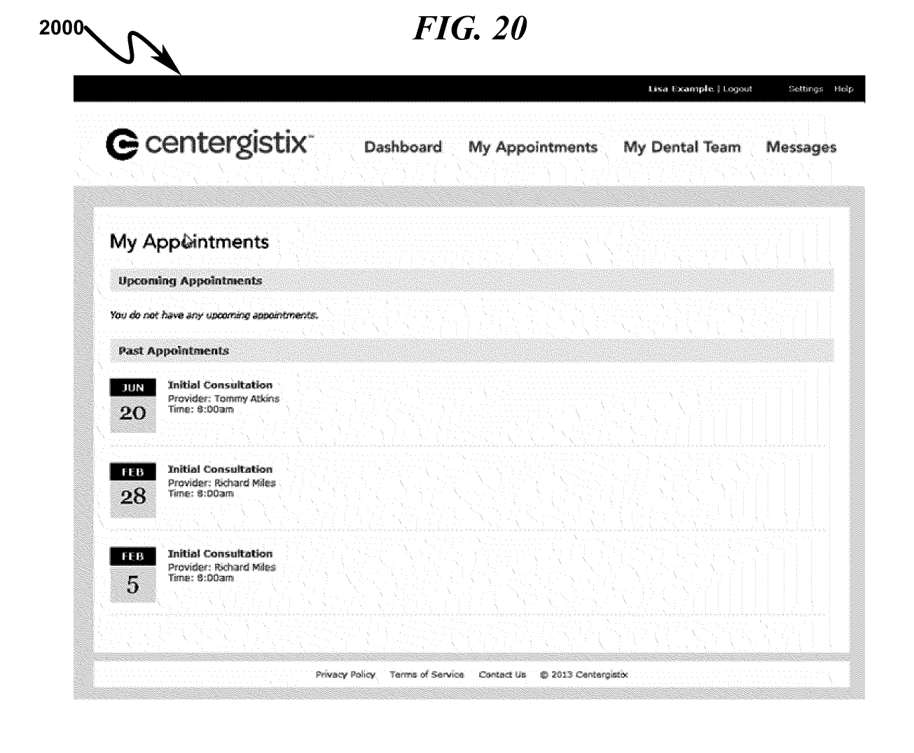

This dialog as generally depicted in FIG. 20 (2000) provides an up-to-date schedule of appointments with various dental professionals associated with the dental implant process. As various dental professionals interact with the integrated treatment plan for the patient, appointments are scheduled and coordinated between the various dental professionals and the patient.

### Dental Team (1714)

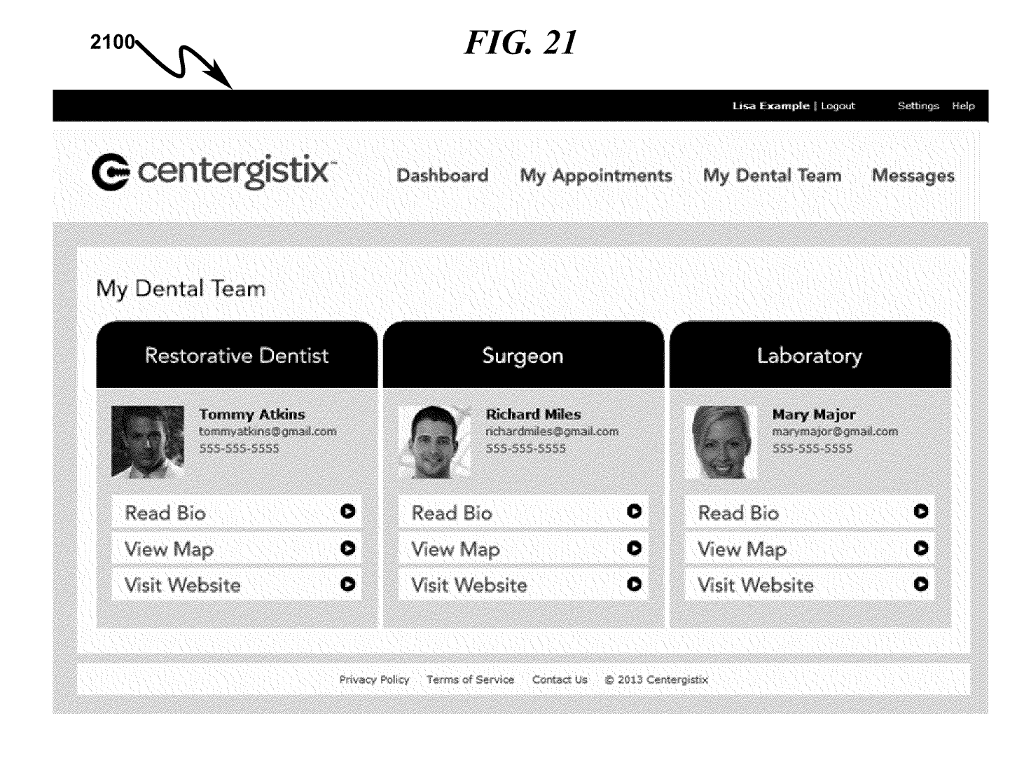

This dialog as generally depicted in FIG. 21 (2100) provides information on the dental professionals that are responsible for the dental implant process. This dialog permits biographic information to be retrieved as well as information on practice facility location and any website associated with the dental professional.

### Messages (1715)

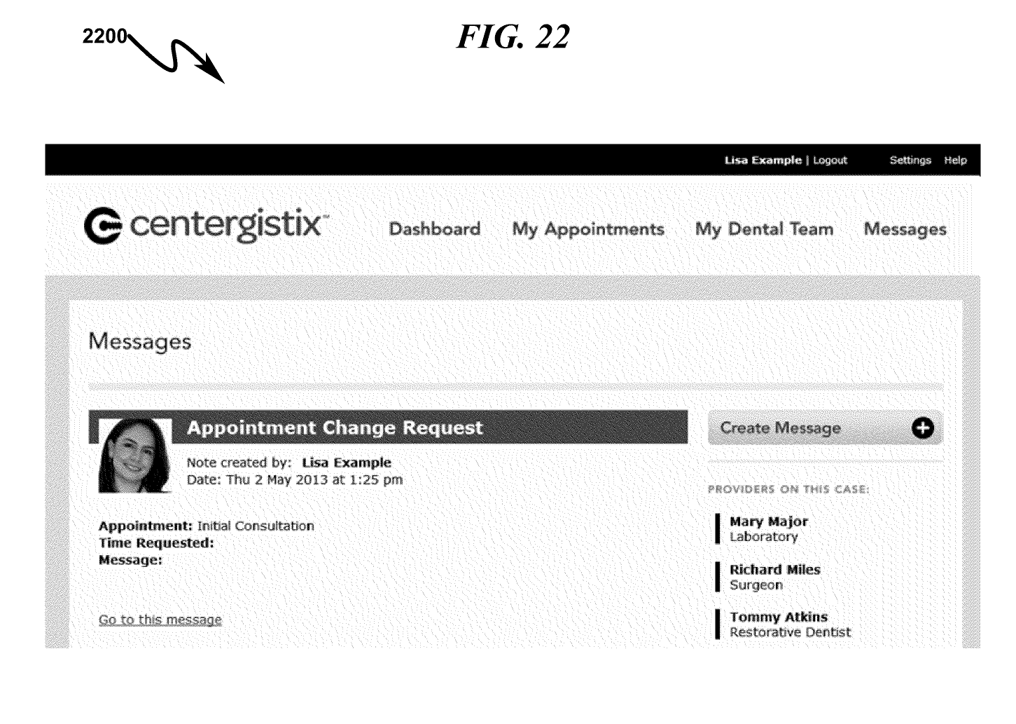

This dialog as generally depicted in FIG. 22 (2200) provides a secure messaging system for communication between the patient and the dental implant professionals. This feature of the system is important to ensure the security of patient information from unauthorized access.

### Help (1716)

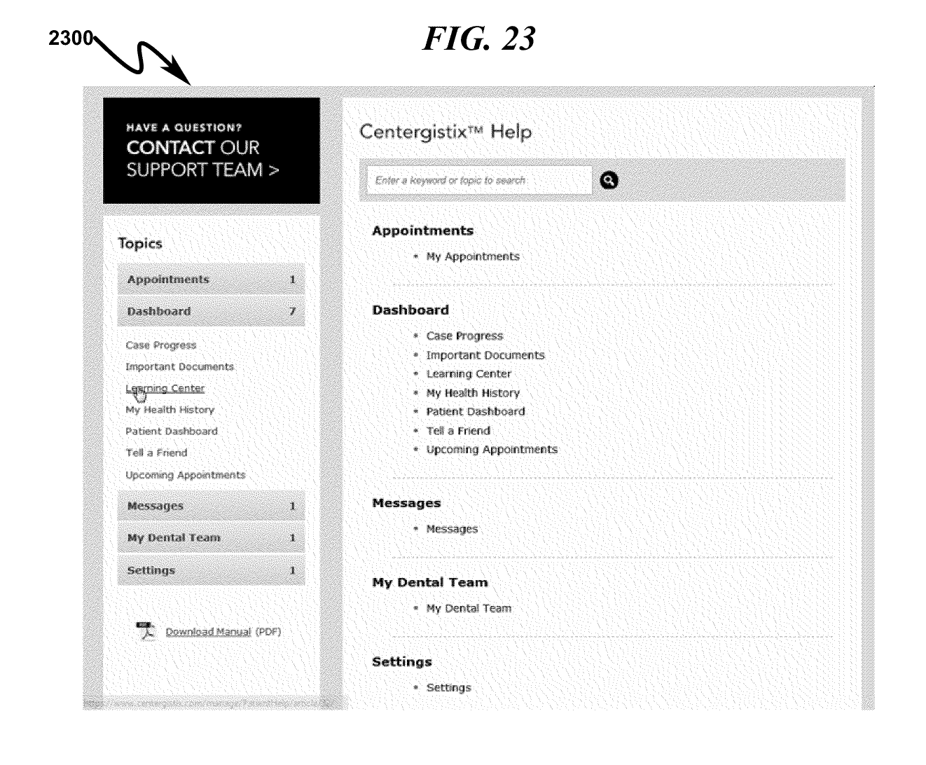

This dialog as generally depicted in FIG. 23 (2300) provides a conventional help screen with information and instructions on how to interact with the system. As generally illustrated on the left side of this dialog, the help information may be indexed for easy access by the patient.

This help dialog may incorporate links to instructional videos used to inform the patient on the dental implant process, as well as a link to an instructional manual covering the patient portal interface.

### Settings (1717)

This dialog as generally depicted in FIG. 24 (2400) allows the patient to enter and configure a patient profile that includes personal information and medical/dental health history. This information is stored in a secure database to ensure that only the patient and authorized dental implant professionals have access to this information.

### Exemplary DIP Web Portal (2500)-(5900)

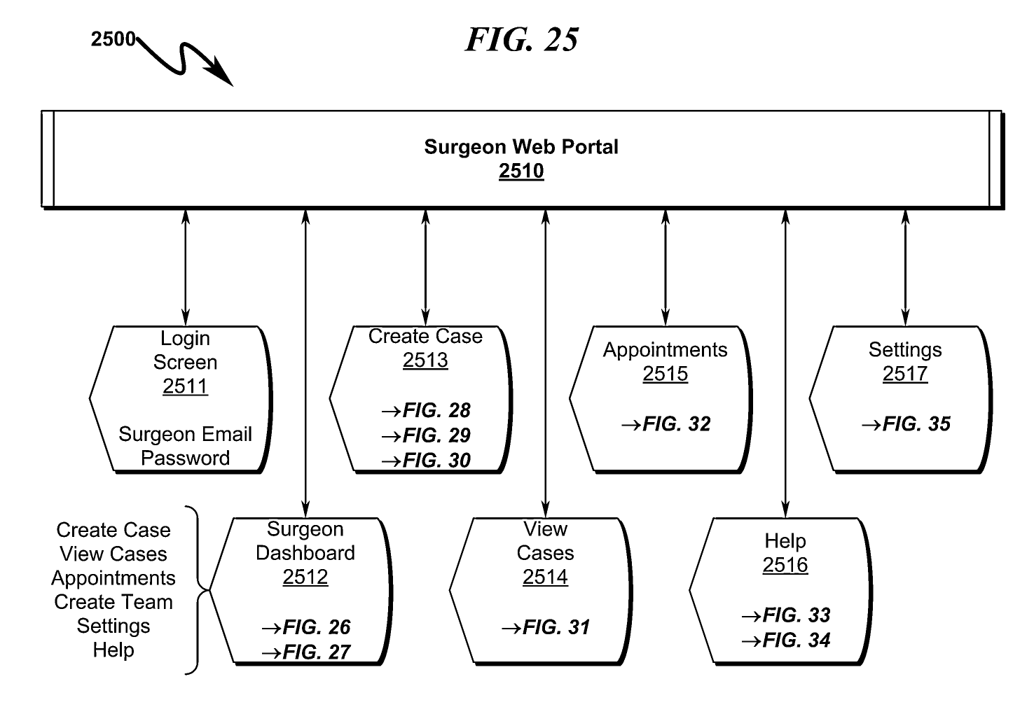

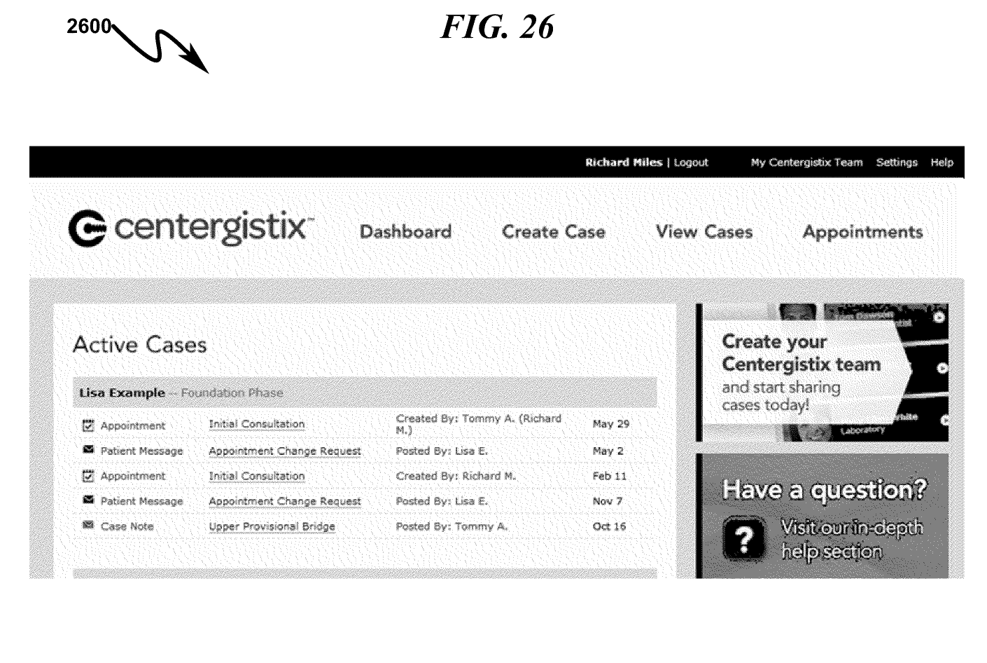

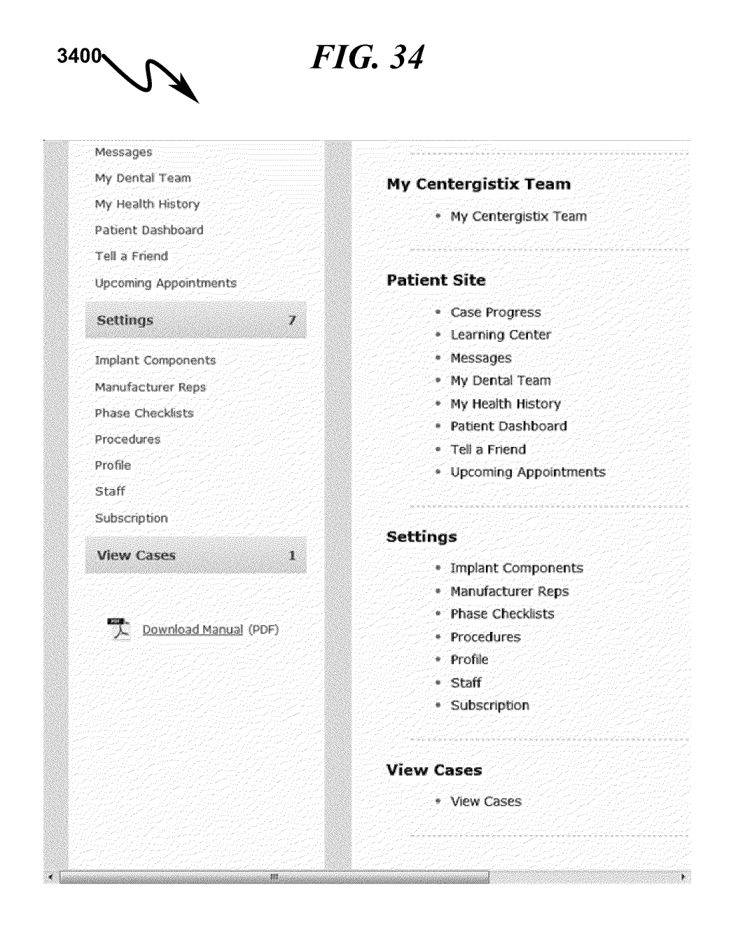

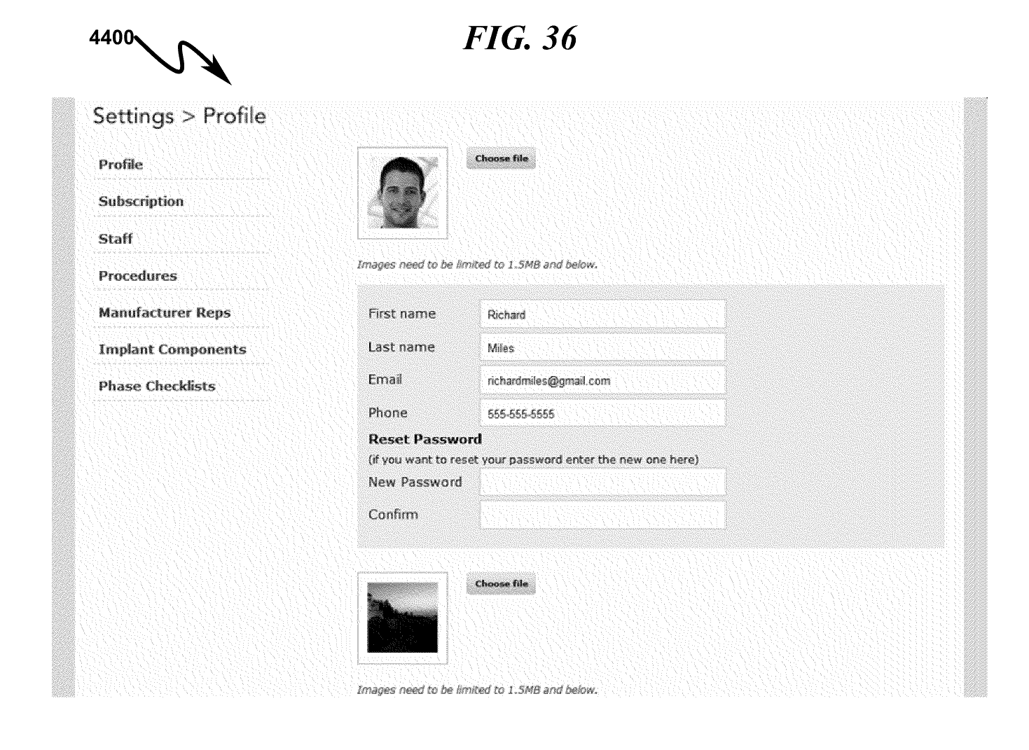

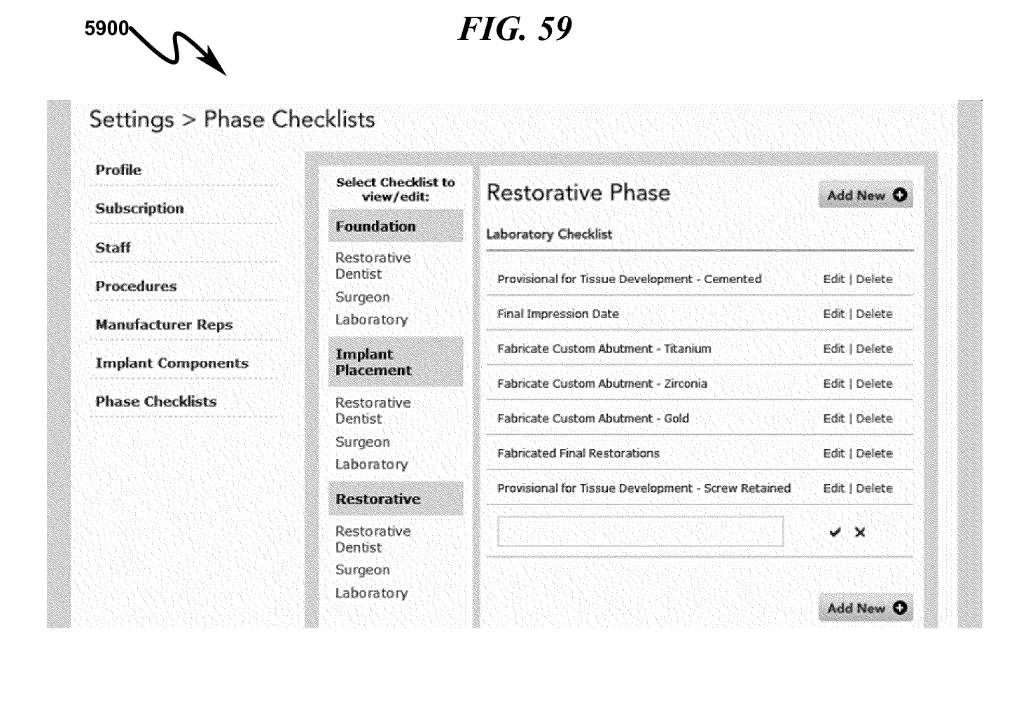

A preferred exemplary dental implant professional (DIP) web portal embodiment is generally illustrated in the overview structure of FIG. 25 (2500). This example is provided in the context of a surgeon web portal (2510), but may be easily modified to support other DIPs such as the restorative doctor and dental laboratory. The structural overview depicted in FIG. 25 (2500) is further detailed in the exemplary dialog screens depicted in FIG. 26 (2600)-FIG. 34 (3400) and FIG. 36 (3600)-FIG. 59 (5900). These various exemplary dialogs will be discussed in more detail below. Again, while the discussion below will be in terms of a surgeon web portal description, the teachings and concepts are equally applicable to other DIPs.

### Login Screen (2511)

The login screen provides secure access to the surgeon web portal using a patient identifier (username) (typically a surgeon e-mail address) and an associated password. This dialog is not depicted in detail as it is well known to one skilled in the art.

### Surgeon Dashboard (2512)

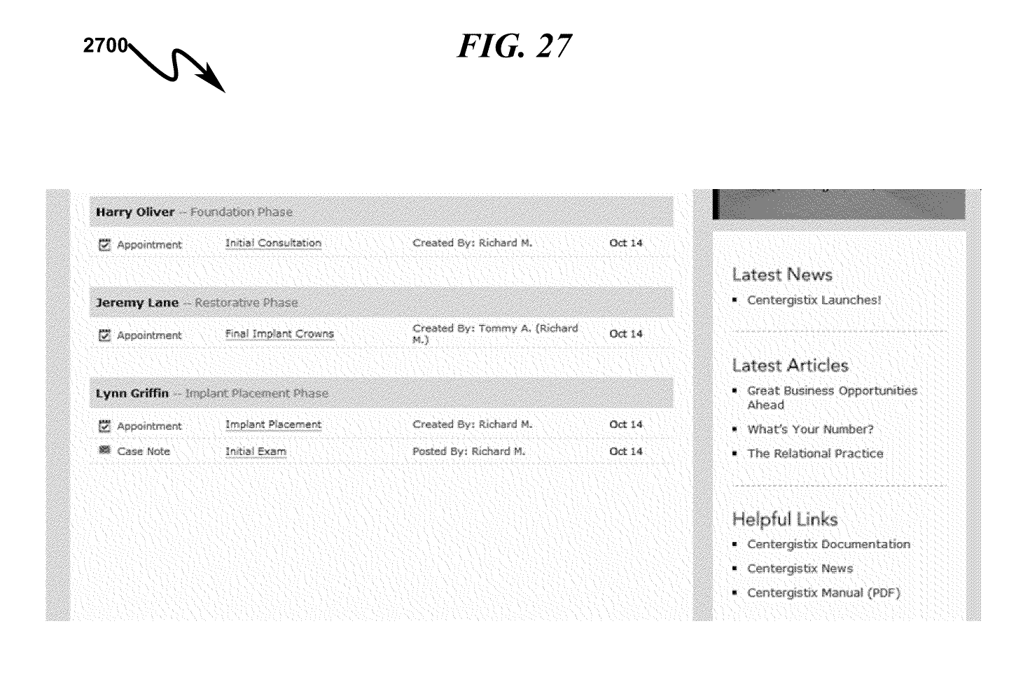

This dialog as generally depicted in FIG. 26 (2600)-FIG. 27 (2700) provides an overview as to the surgeon's patients and their progress through the dental implant procedures and also tabbed access to other informational and setup surgeon dialogs.

As indicated, this dialog may also provide access to the CREATE CASE (2513), VIEW CASES (2514), APPOINTMENTS (2515), HELP (2516) and SETTINGS (2517) dialogs.

### Create Case (2513)

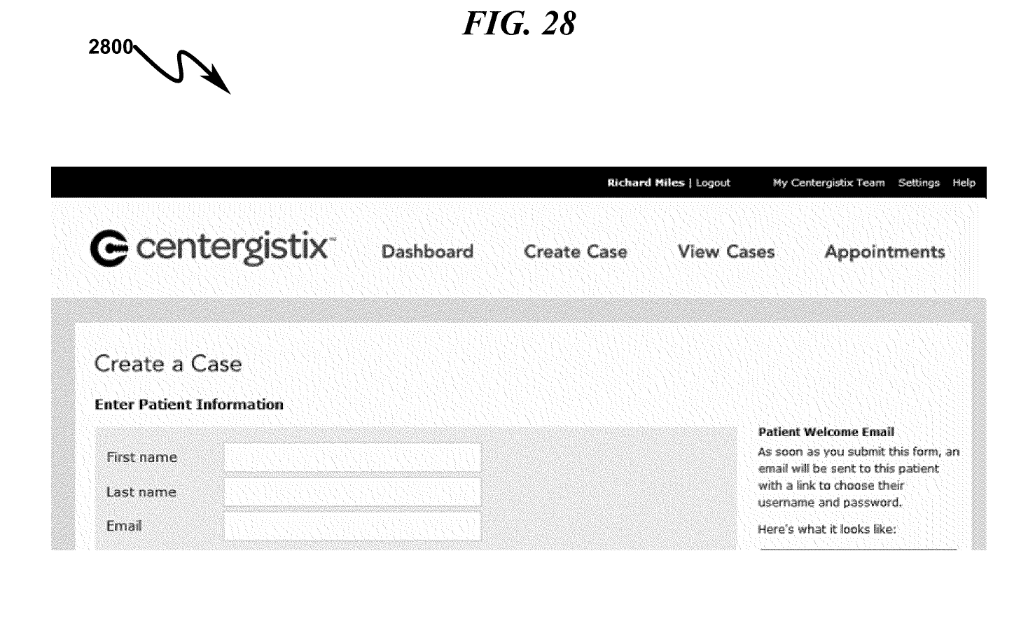

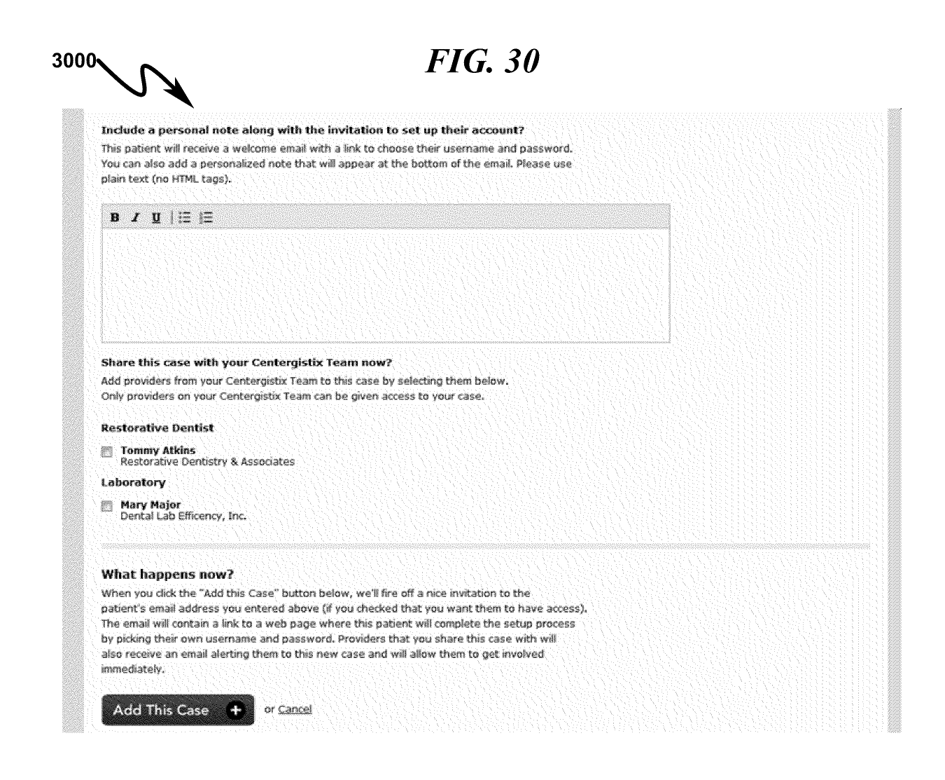

This dialog as generally depicted in FIG. 28 (2800)-FIG. 30 (3000) allows the surgeon to create a patient case by entering patient information and other information necessary to contact and communicate with the patient.

### View Cases (2514)

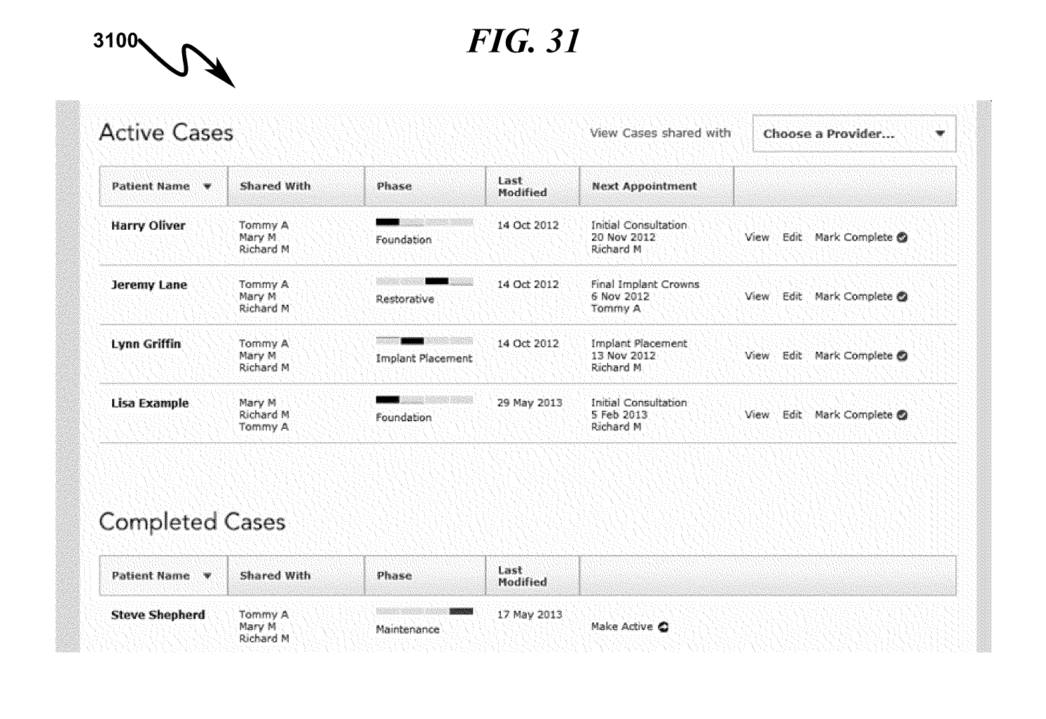

This dialog as generally depicted in FIG. 31 (3100) provides information on active and completed cases for which the surgeon has responsibility.

### Appointments (2515)

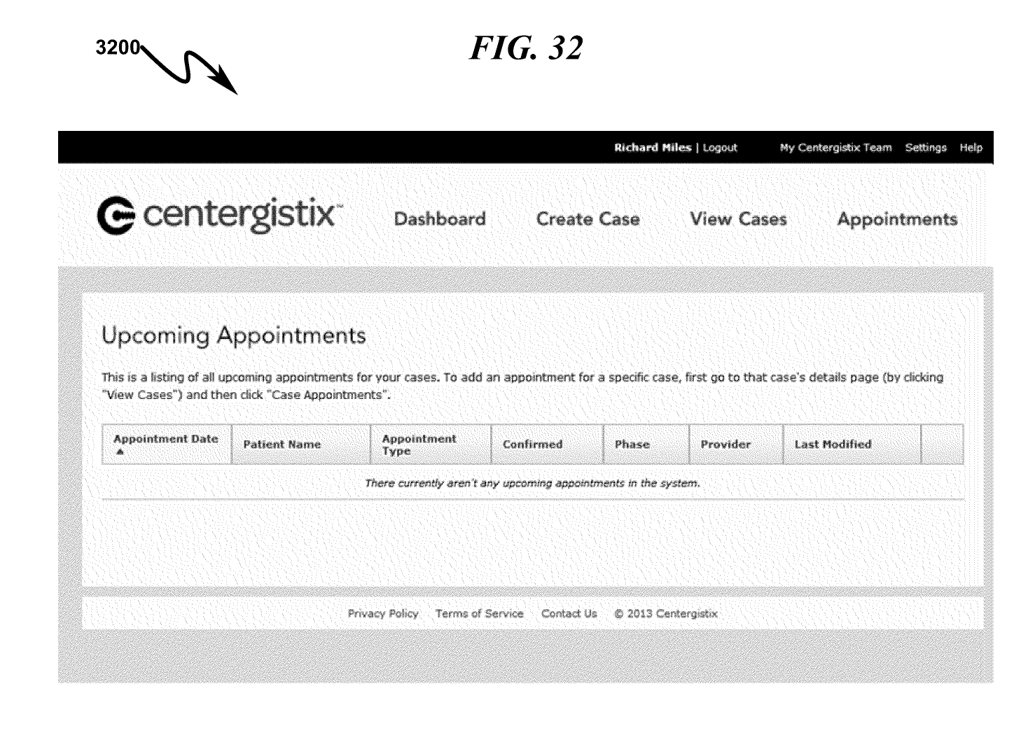

This dialog as generally depicted in FIG. 32 (3200) provides a list of upcoming dental patient appointments and their associated patient information. This information in conjunction with data received from other DIPs helps the surgeon properly plan for the patient appointment.

### Help (2516)

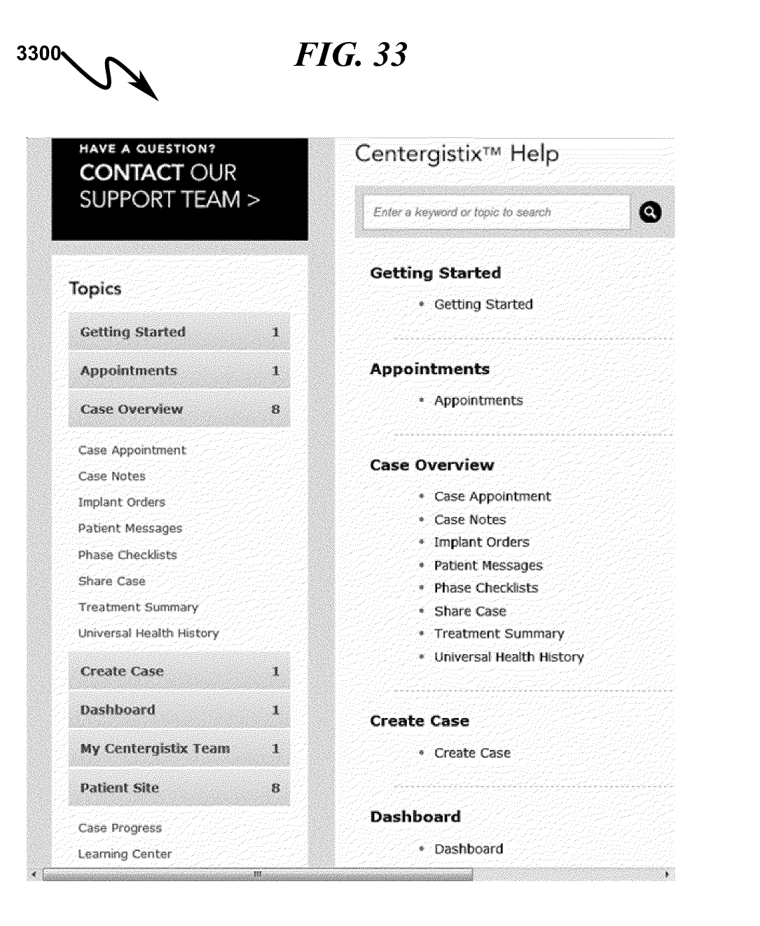

This dialog as generally depicted in FIG. 33 (3300)-FIG. 34 (3400) provides a conventional help screen with information and instructions on how to interact with the system. As generally illustrated on the left side of this dialog, the help information may be indexed for easy access by the surgeon.

### Settings (2517)

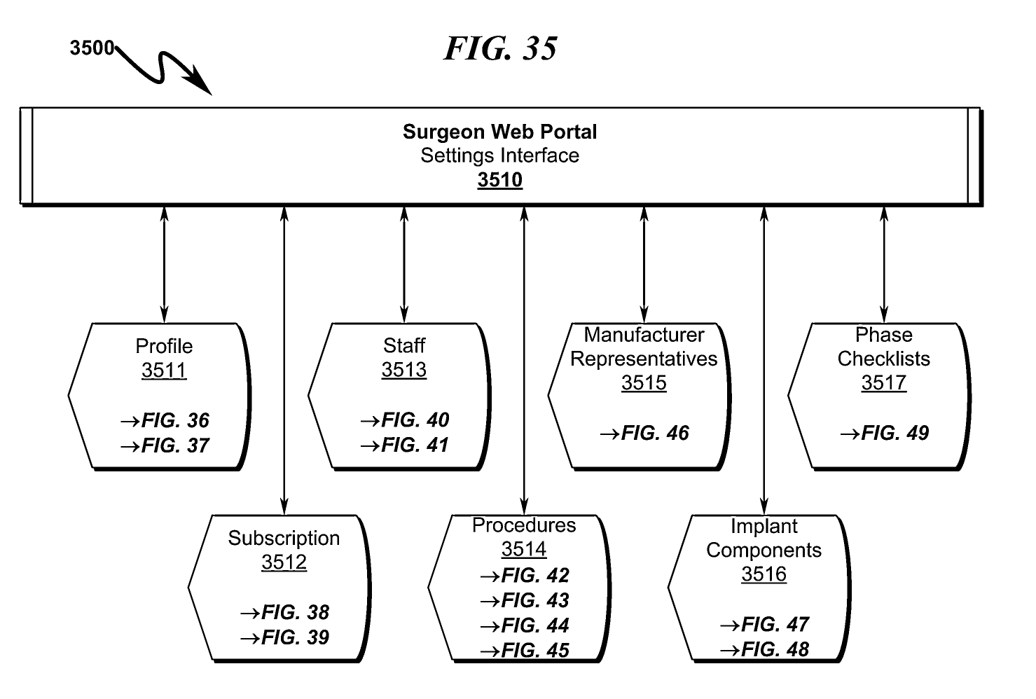

The structure of this dialog tree as generally depicted in FIG. 35 (3500) allows the surgeon to enter and configure a surgeon PROFILE (3511) that includes professional information and practice history. This series of dialogs also includes the ability to support SUBSCRIPTION (3512) information regarding the system, information on STAFF (3513), PROCEDURES (3514), dental implant part MANUFACTURER REPRESENTATIVES (3515), IMPLANT COMPONENTS (3516), and PHASE CHECKLISTS (3517). These various exemplary dialogs will be discussed in more detail below.

### Profile (3511)

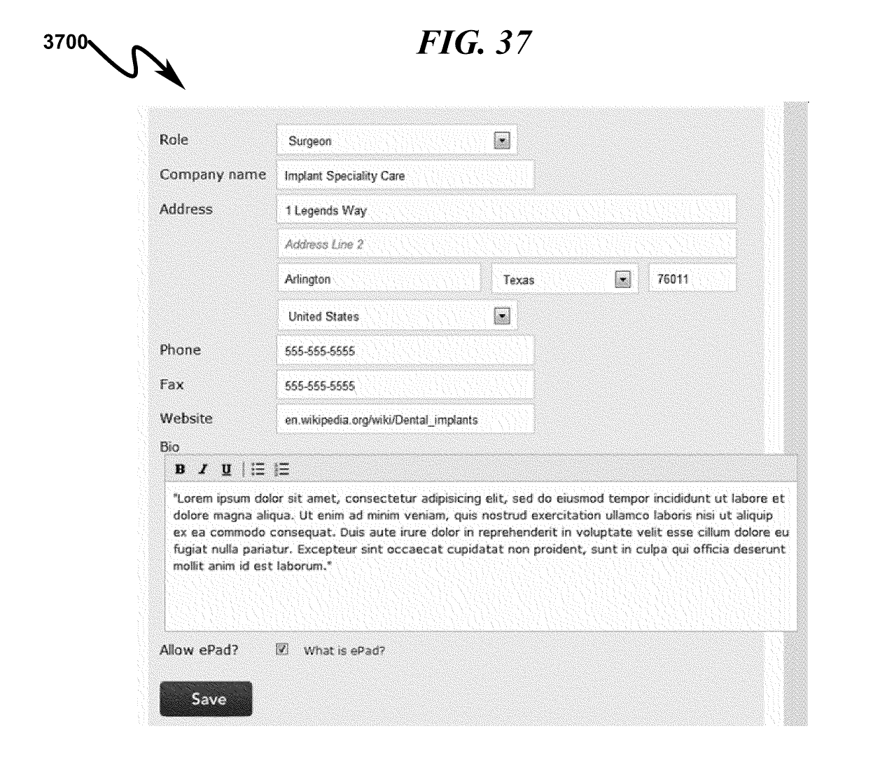

This dialog as generally depicted in FIG. 36 (3600)-FIG. 37 (3700) allows information on the surgeon and his/her practice to be entered. This information is then used to inform the patient and other DIPs regarding the surgeon's practice, location, and other contact information.

### Subscription (3512)

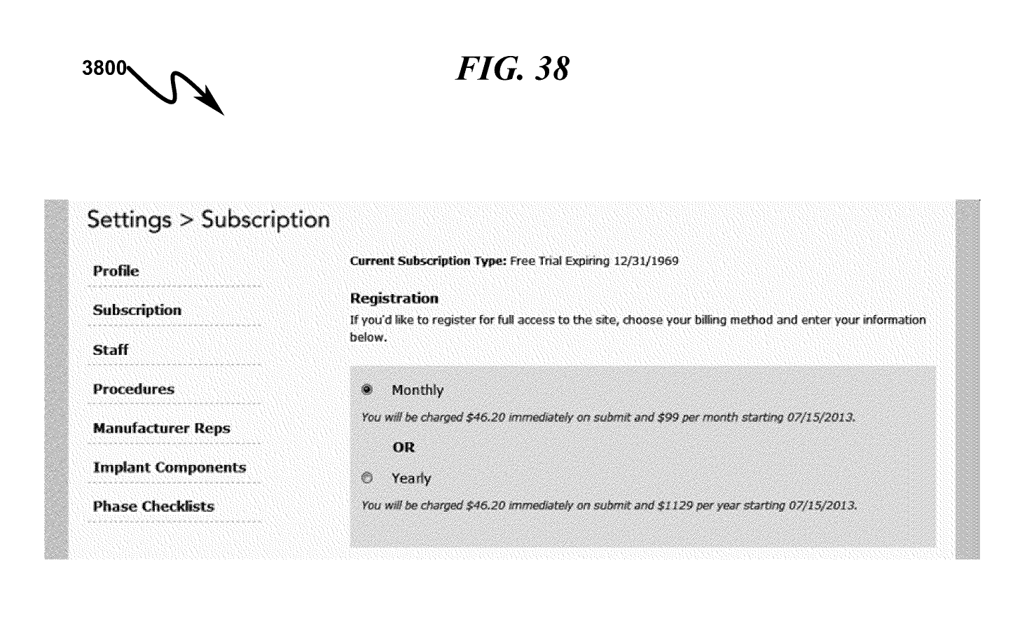

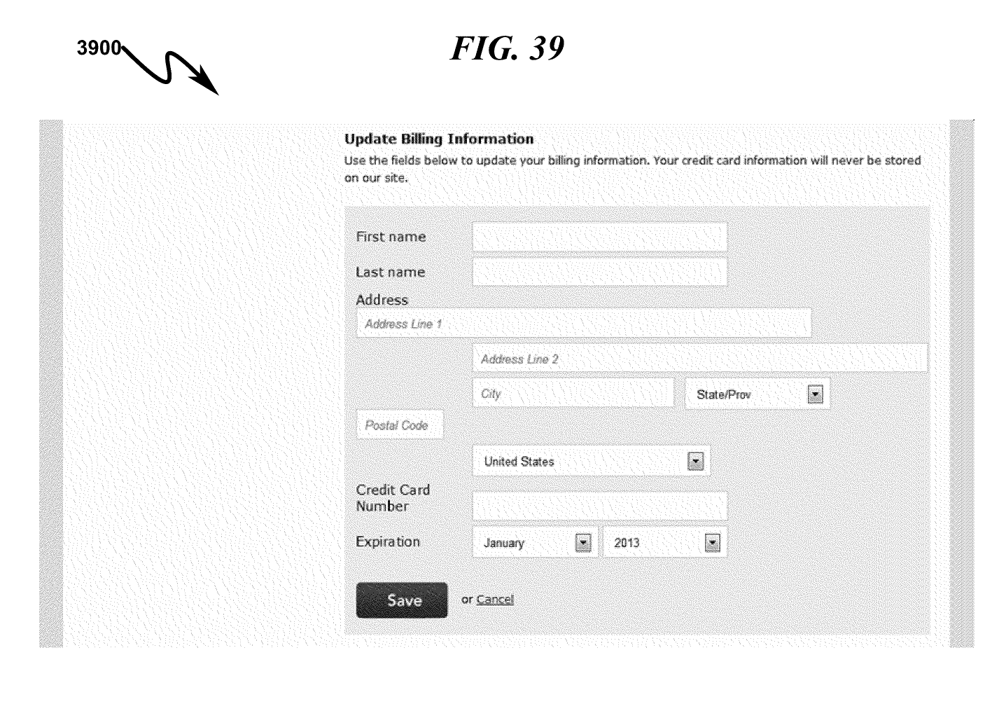

This dialog as generally depicted in FIG. 38 (3800)-FIG. 39 (3900) allows the surgeon to enter information regarding subscription support for the system. The present invention anticipates that maintenance functions associated with the operation of the system will be optimally performed within the context of the Implant Web Server (IWS) and therefore the surgeon and other DIPs will enter subscription arrangements to maintain support on this hardware platform.

### Staff (3513)

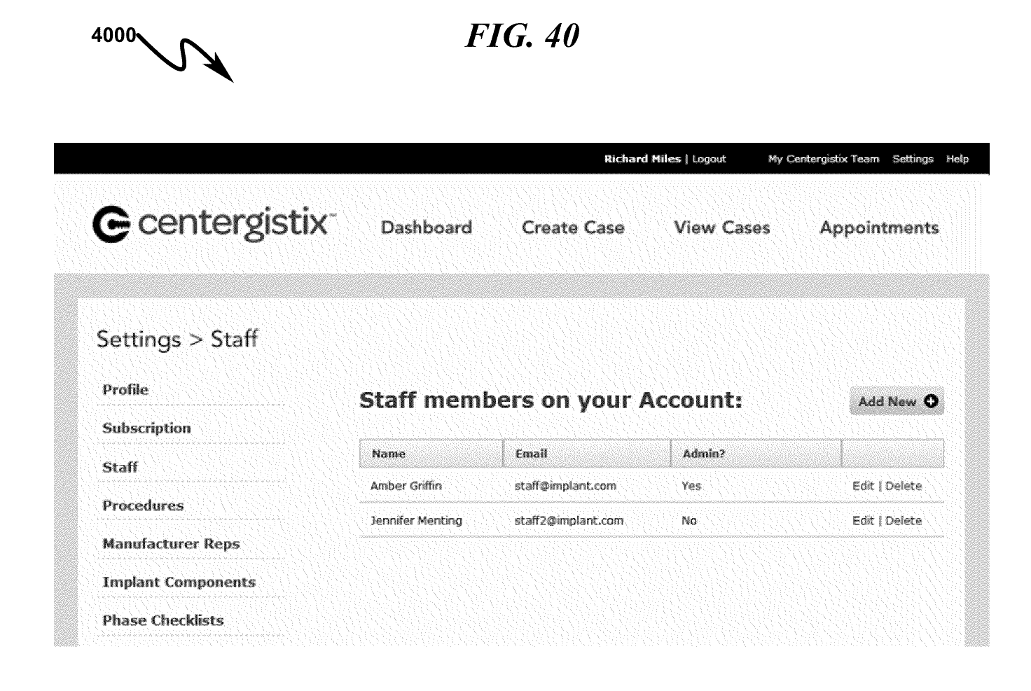

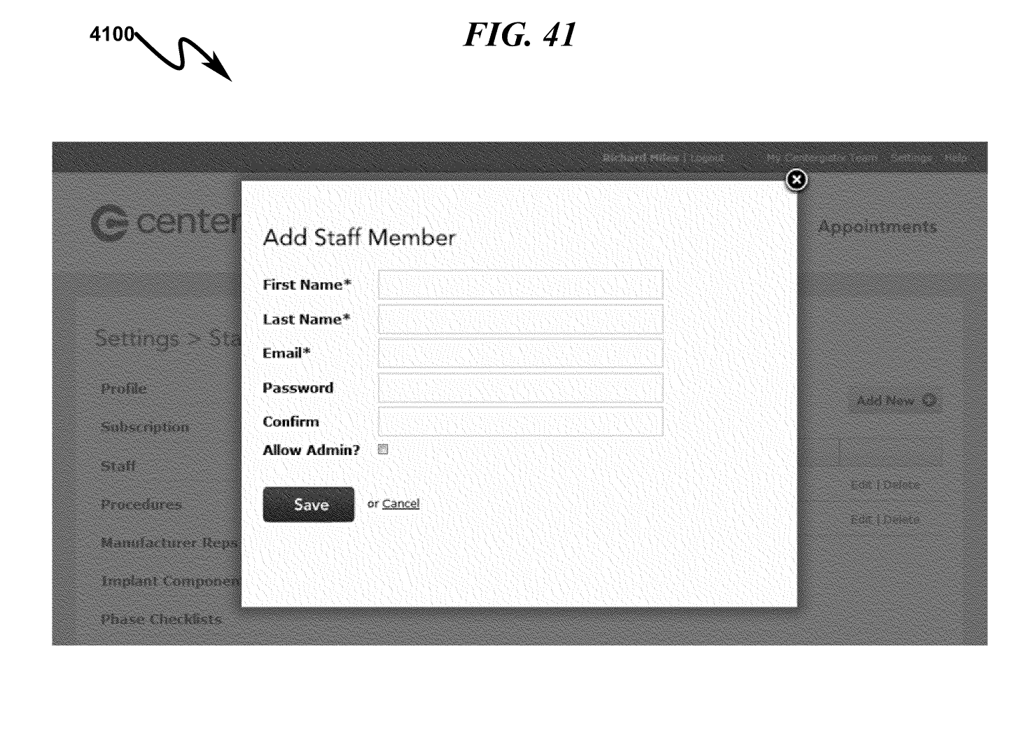

This dialog as generally depicted in FIG. 40 (4000)-FIG. 41 (4100) allows the surgeon to associate staff members on a given account and thus define the scope of information dispersal within a given team of dental implant professionals. This process also permits limited access to administrative functions as depicted in FIG. 41 (4100).

### Procedures (3514)

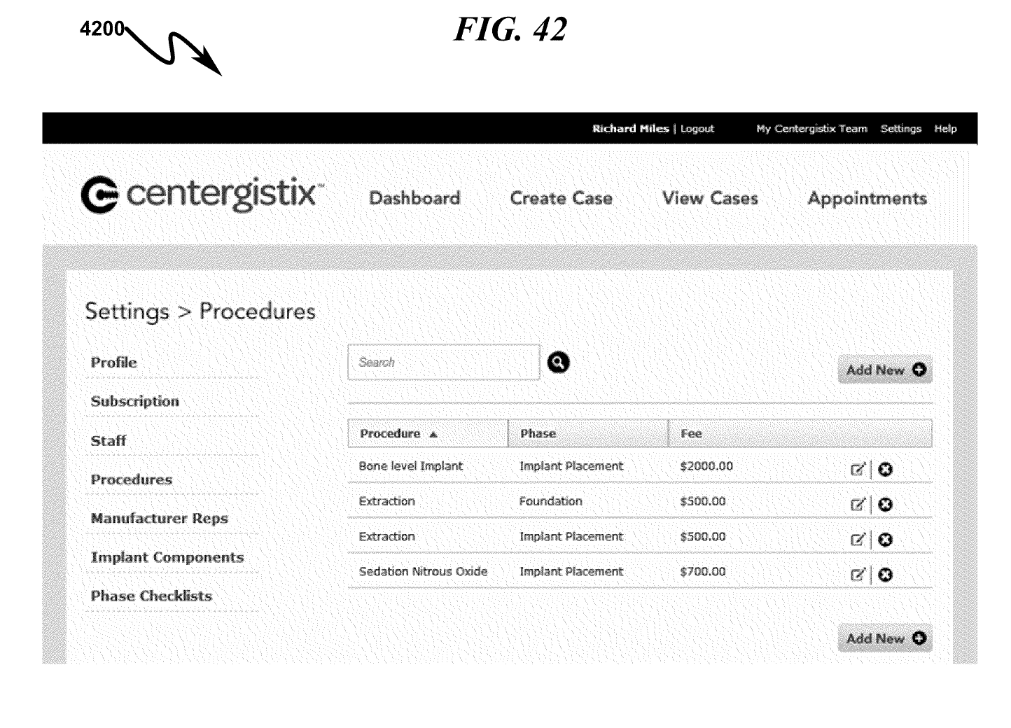

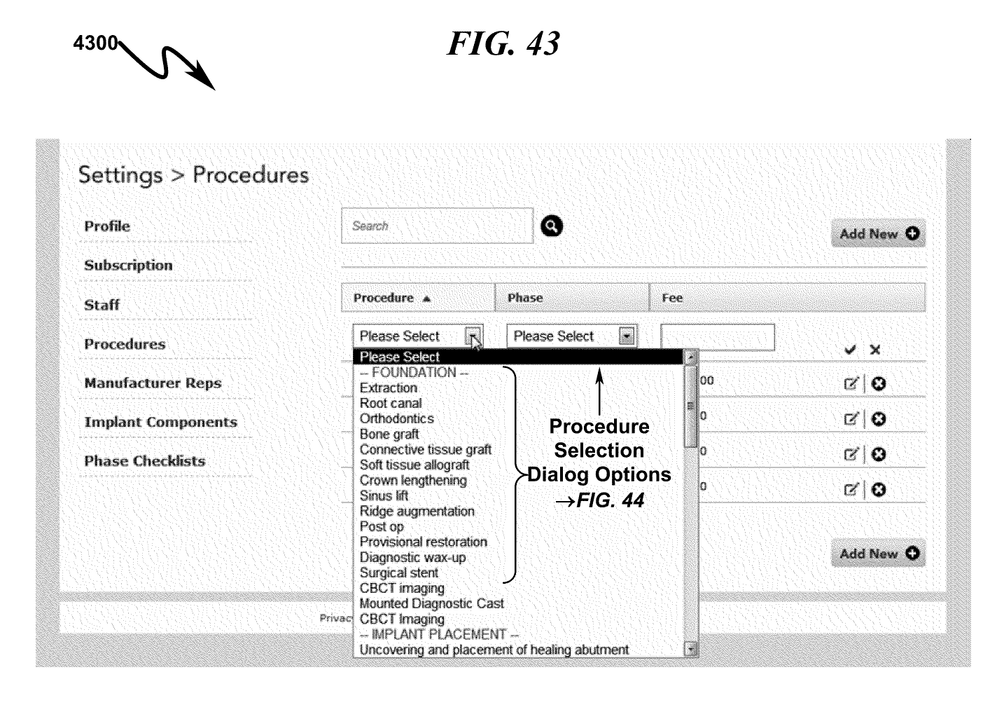

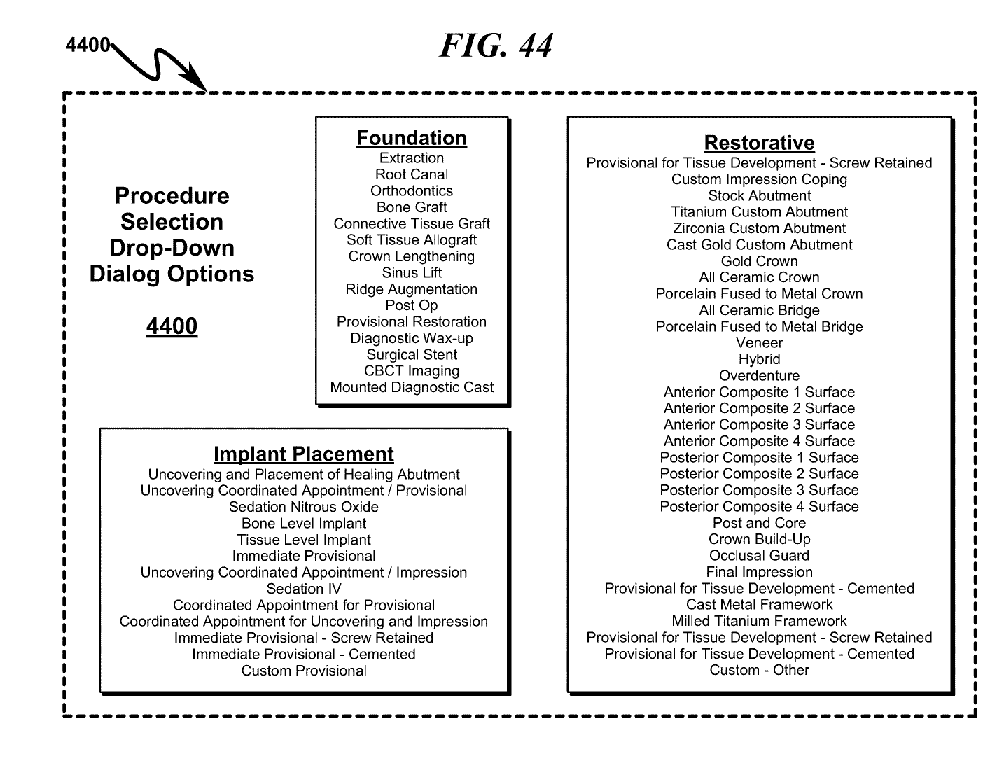

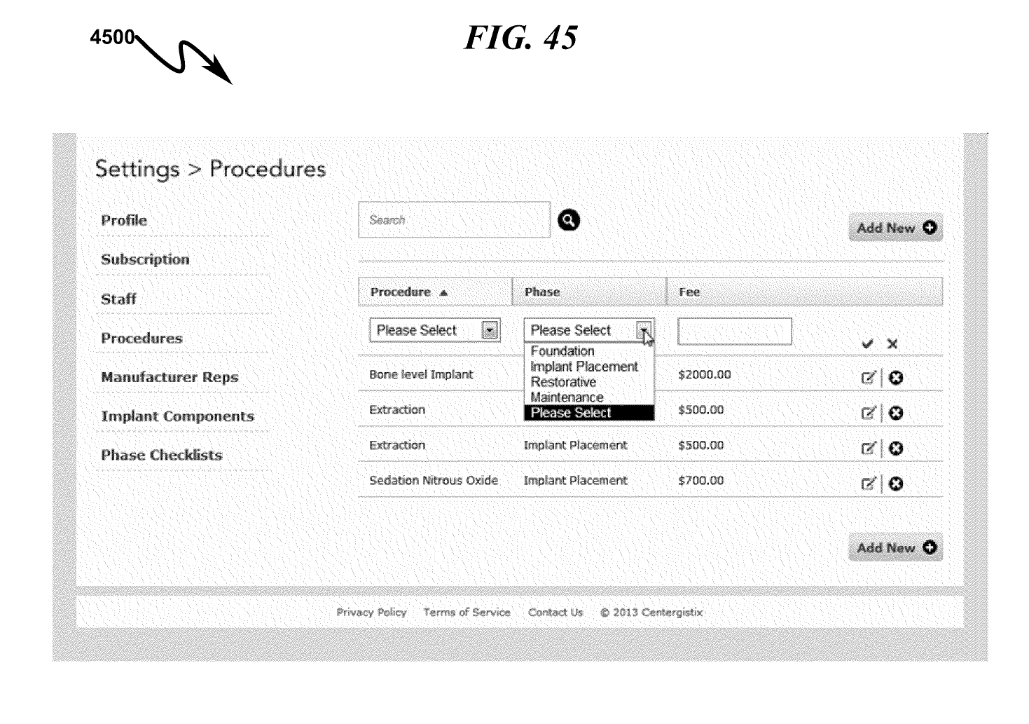

This dialog as generally depicted in FIG. 42 (4200)-FIG. 45 (4500) allows the surgeon to generate standardized and customized procedure definitions (execution phase checklists (ECPs)) associated with execution treatment phases (ETPs) for the patient. As depicted in FIG. 42 (4200), the procedure may be given a name, associated phase, and fee (cost). The definition of a new procedure as depicted in FIG. 43 (4300) may incorporate the use of drop-down options to enter the procedure in some circumstances. FIG. 44 (4400) provides an exemplary list of drop-down dialog options for the various execution treatment phases (ETPs) (FOUNDATION, IMPLANT PLACEMENT, RESTORATIVE). As depicted in FIG. 45 (4500), the procedure configuration dialog also permits ETP phase to be associated with the procedure as well as the surgeon fee (patient cost).

### Manufacturer Representatives (3515)

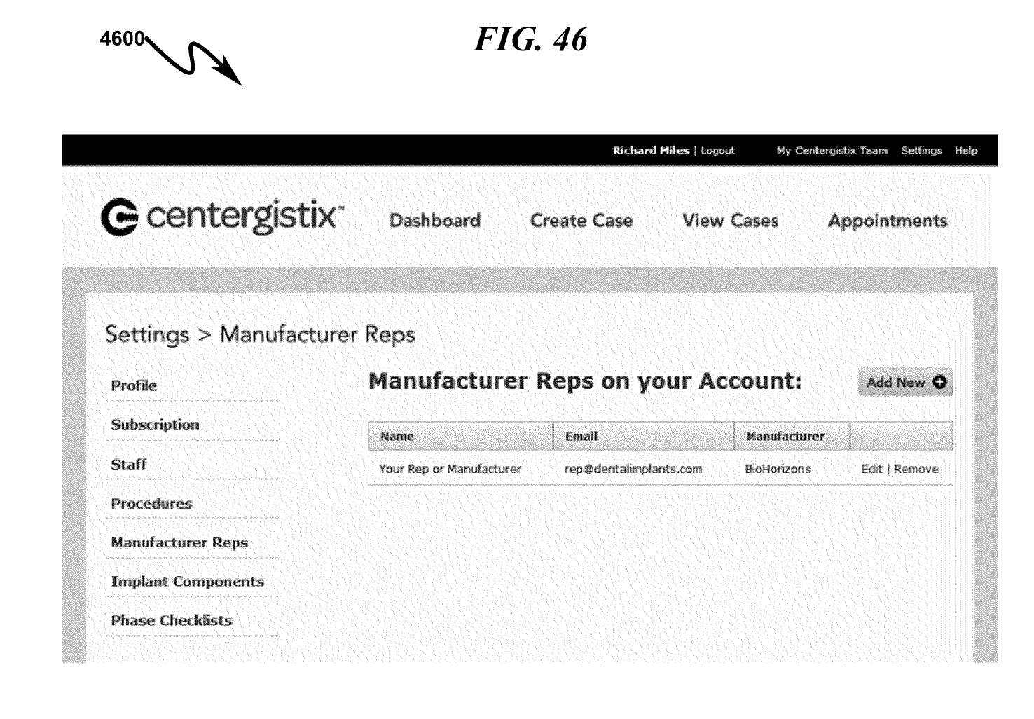

This dialog as generally depicted in FIG. 46 (4600) allows the surgeon to define information associated with dental implant manufacturer representatives. This information can be used to automatically generate e-mails and other communication to the dental implant manufacturer representative in response to EPCs that are scheduled for execution on a given patient.

The scheduling system described herein has the ability to interrogate the manufacturer representative database and trigger dental parts ordering based on anticipated patient need. This “just in time” ordering methodology is a useful tool for the surgeon to reduce the cost of maintaining a complete stock of dental implant parts within their practice.

### Implant Components (3516)

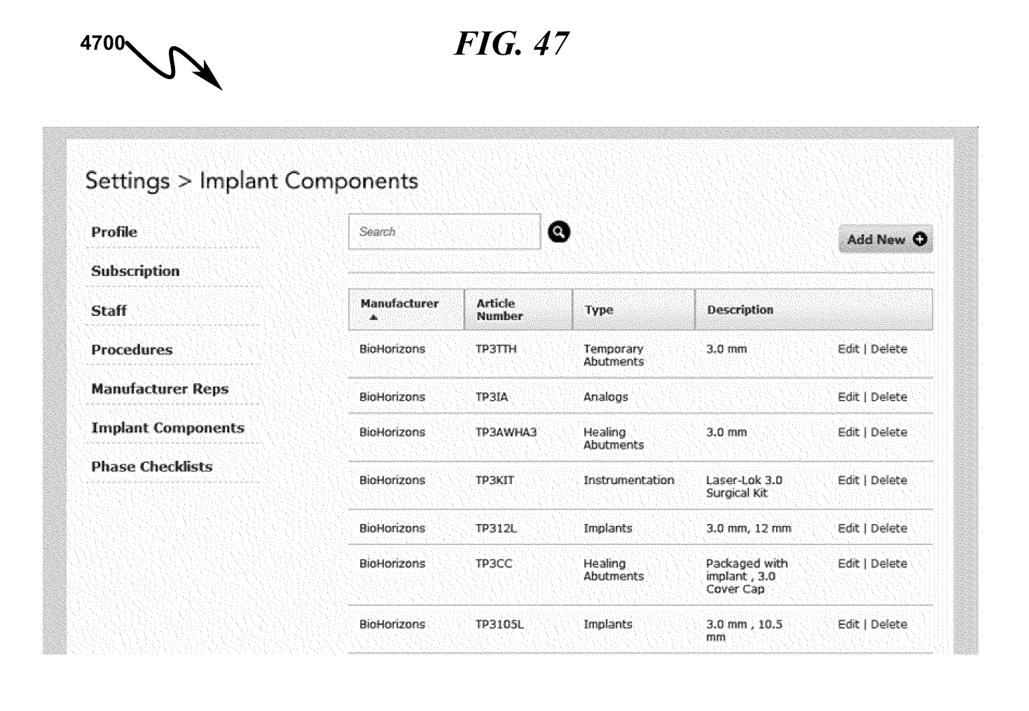

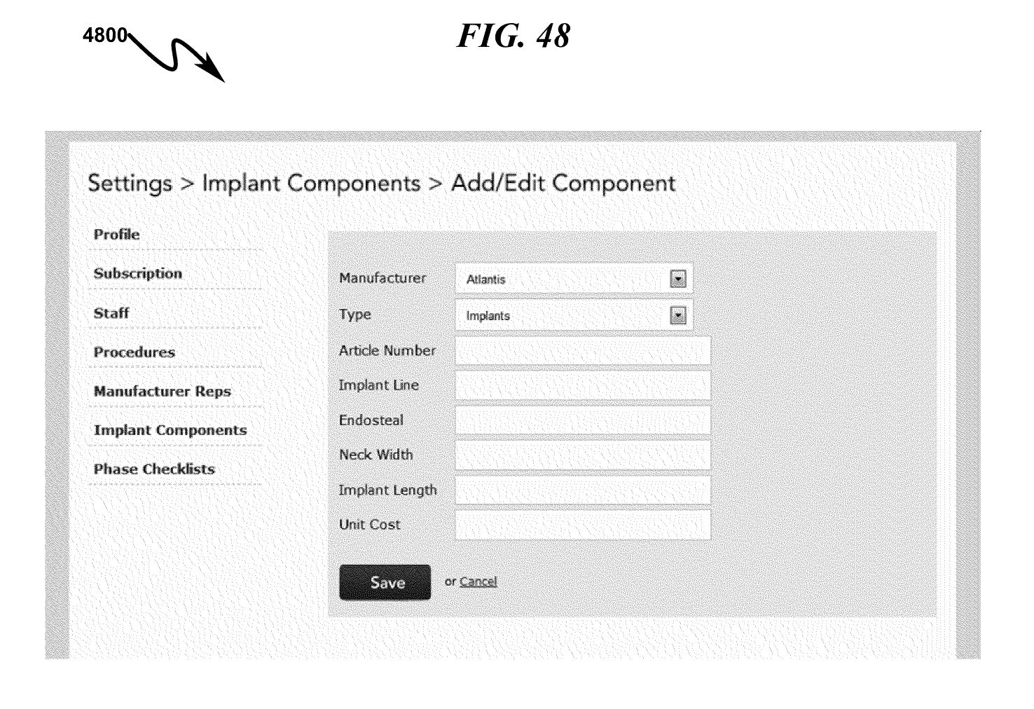

This dialog as generally depicted in FIG. 47 (4700)-FIG. 48 (4800) allows the surgeon to display available dental implant components (FIG. 47 (4700)) that may be necessary for a given dental implant procedure and also define specific dental implant parts (and their source supplier) (FIG. 48 (4800)) to satisfy specific dental patient requirements.

### Phase Checklists (EPCs) (3517)

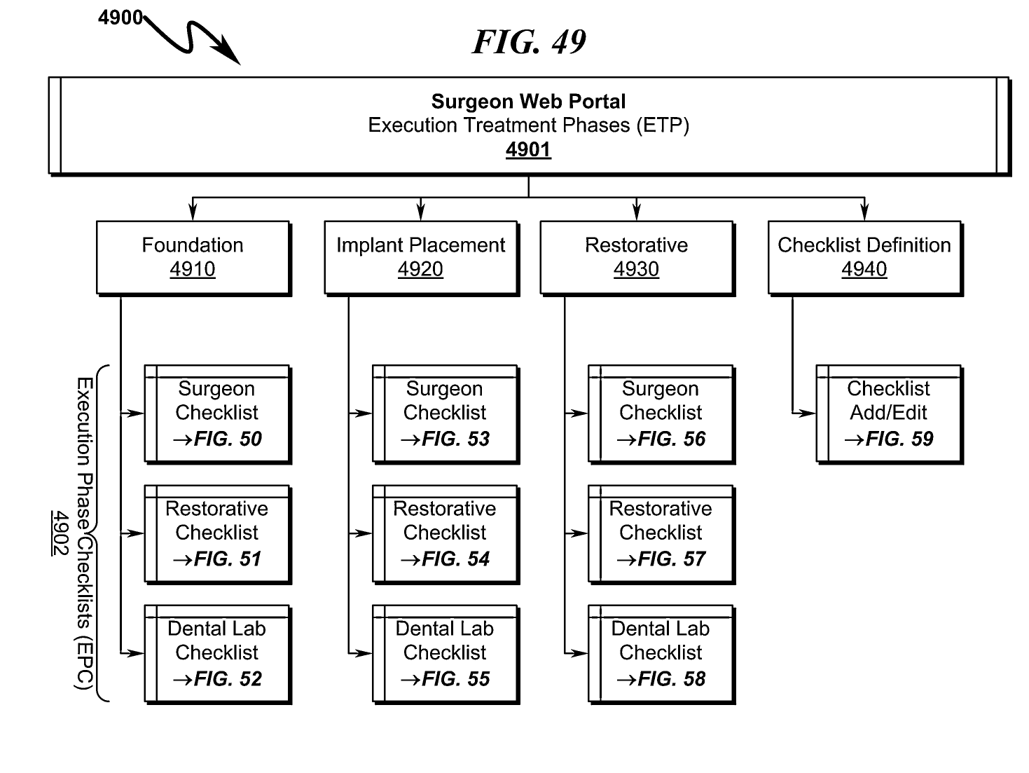

The structure of this dialog tree as generally depicted in FIG. 49 (4900) allows the various DIPs the ability to collaborate on a patient treatment plan incorporating execution treatment phases (ETPs) (4901) that as depicted generally include FOUNDATION (4910), IMPLANT PLACEMENT (4920), and RESTORATIVE (4930) phases. The execution phase checklists (EPCs) (4902) are associated with this patient treatment plan can then have provisions to allow the surgeon, restorative doctor, and dental laboratory input into the overall treatment plan generation process.

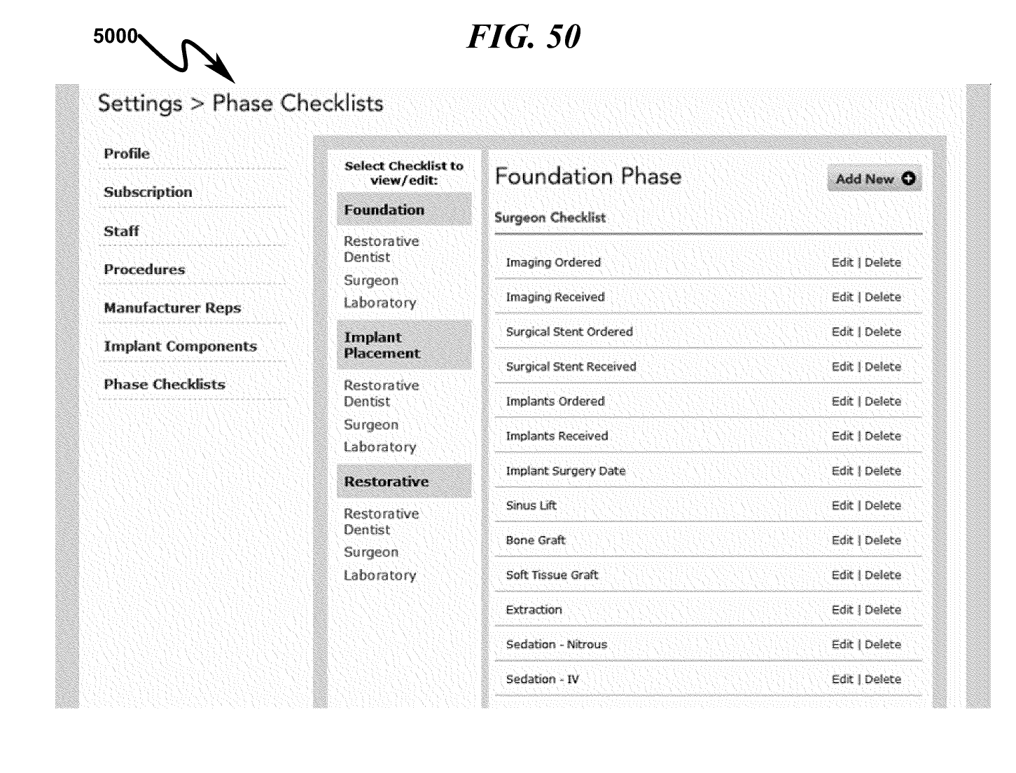

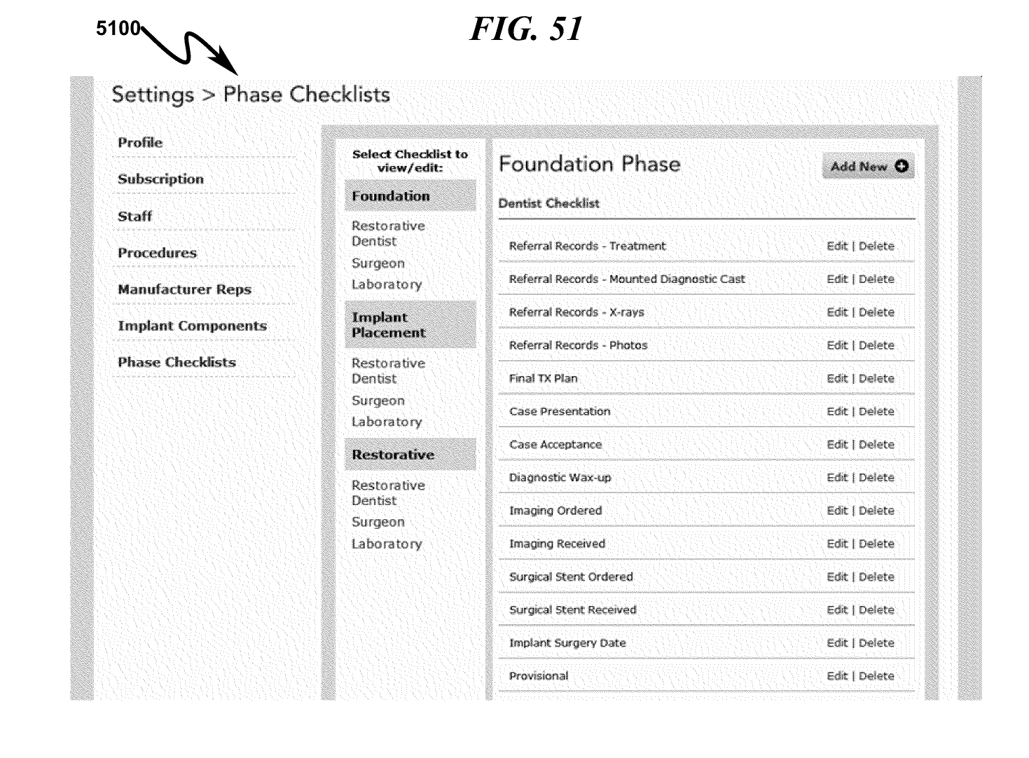

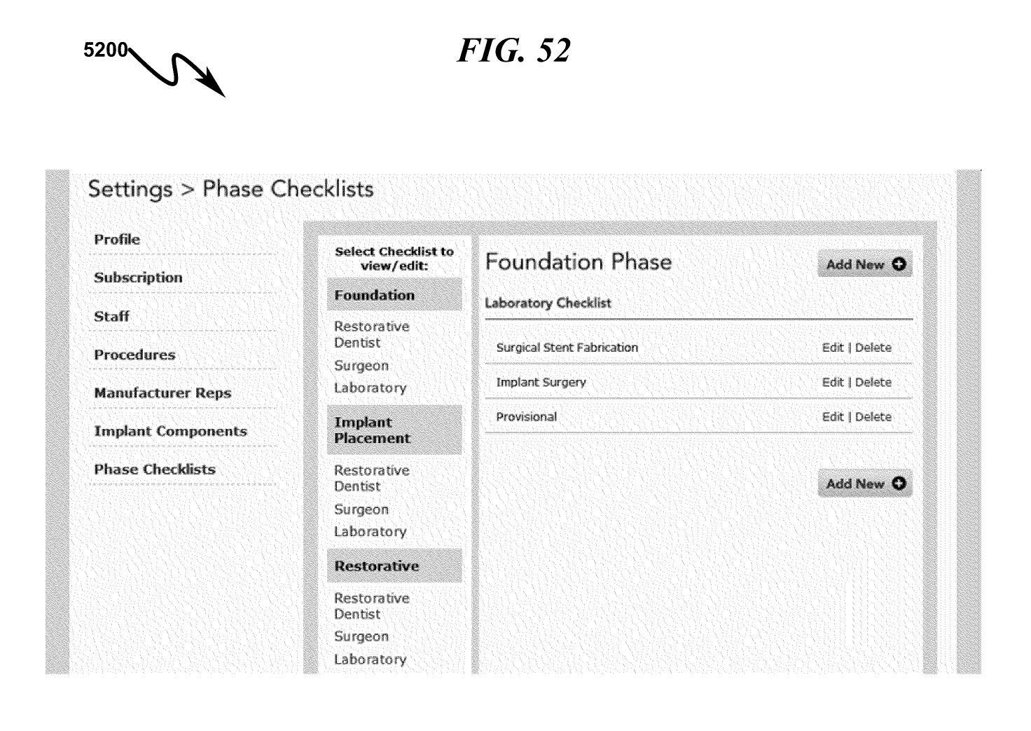

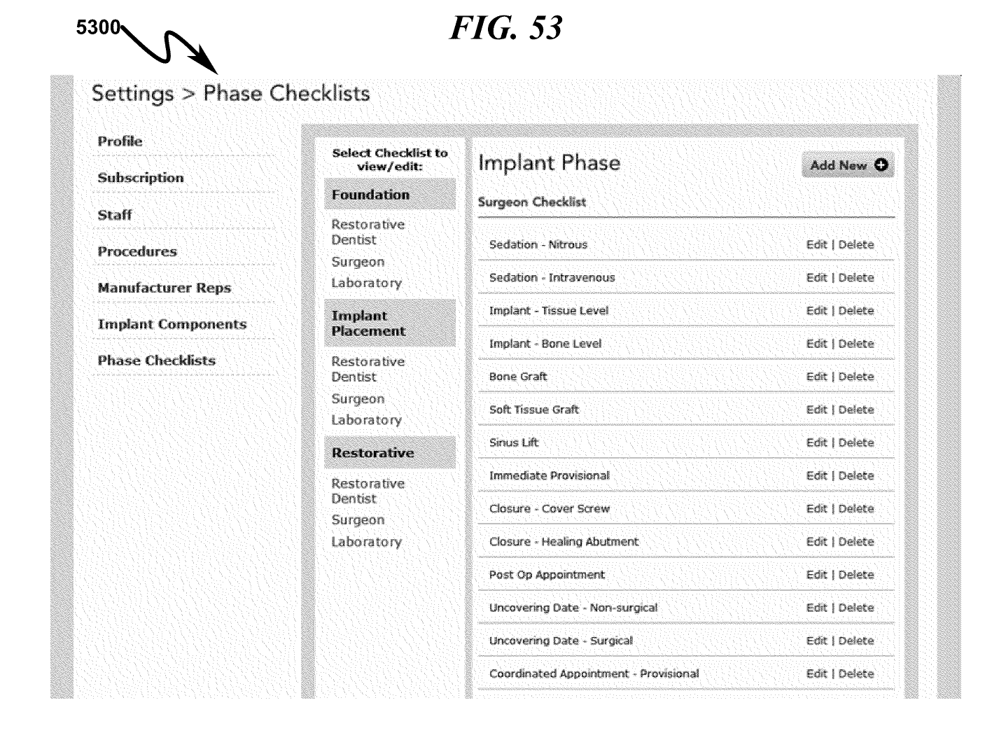

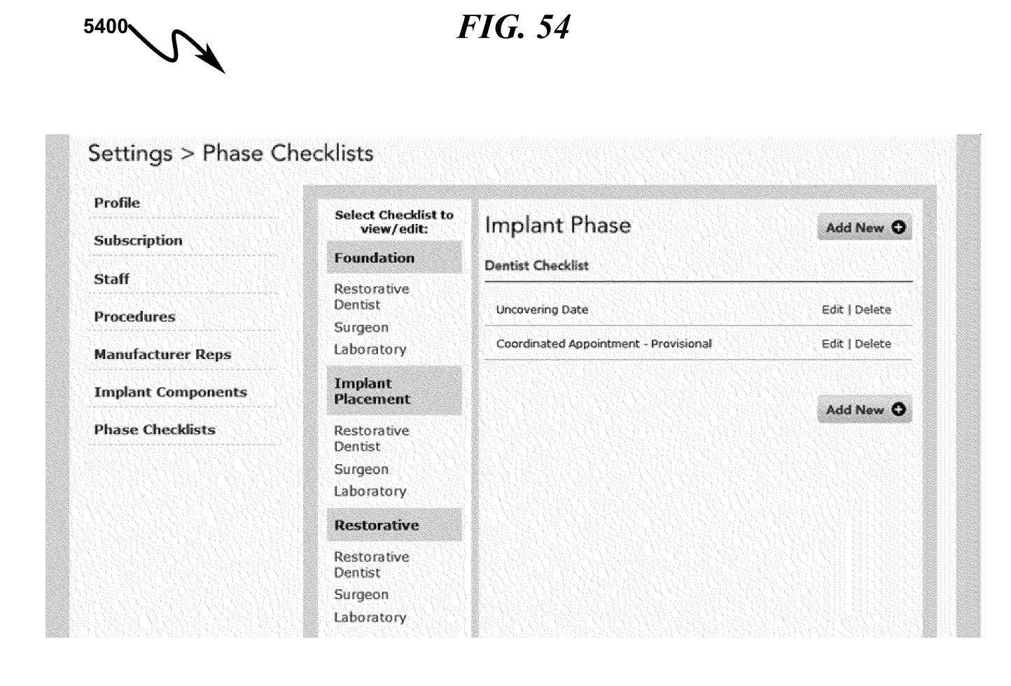

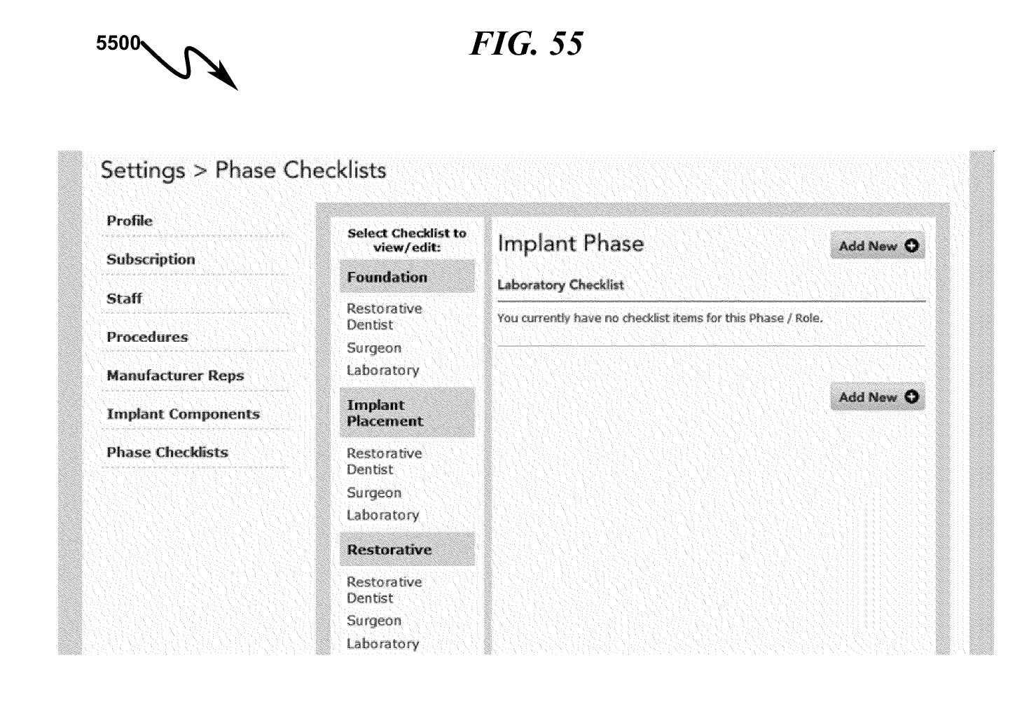

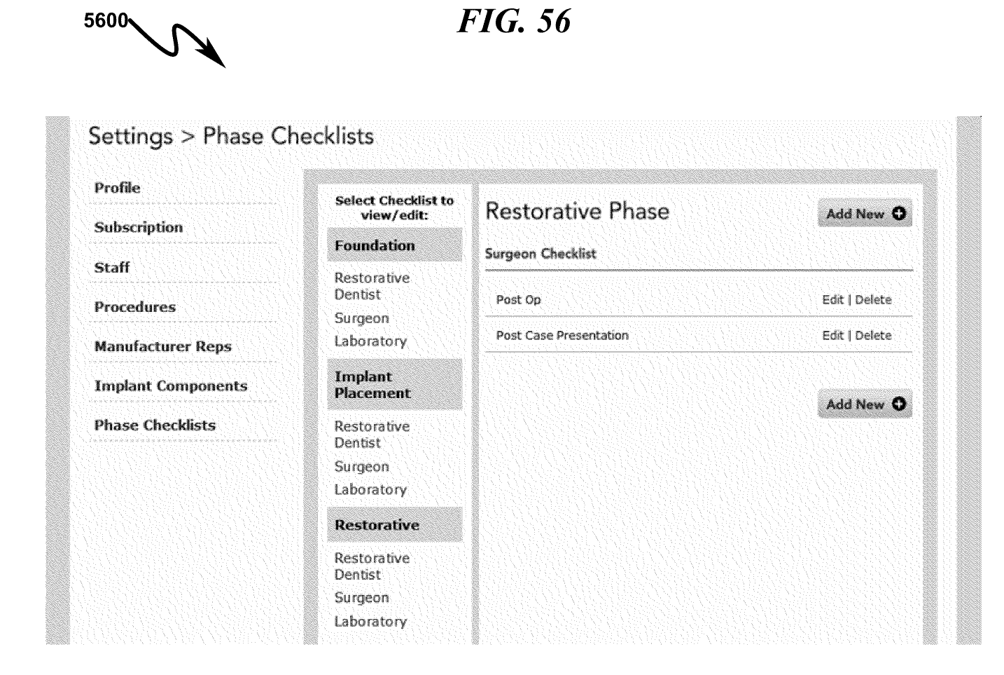

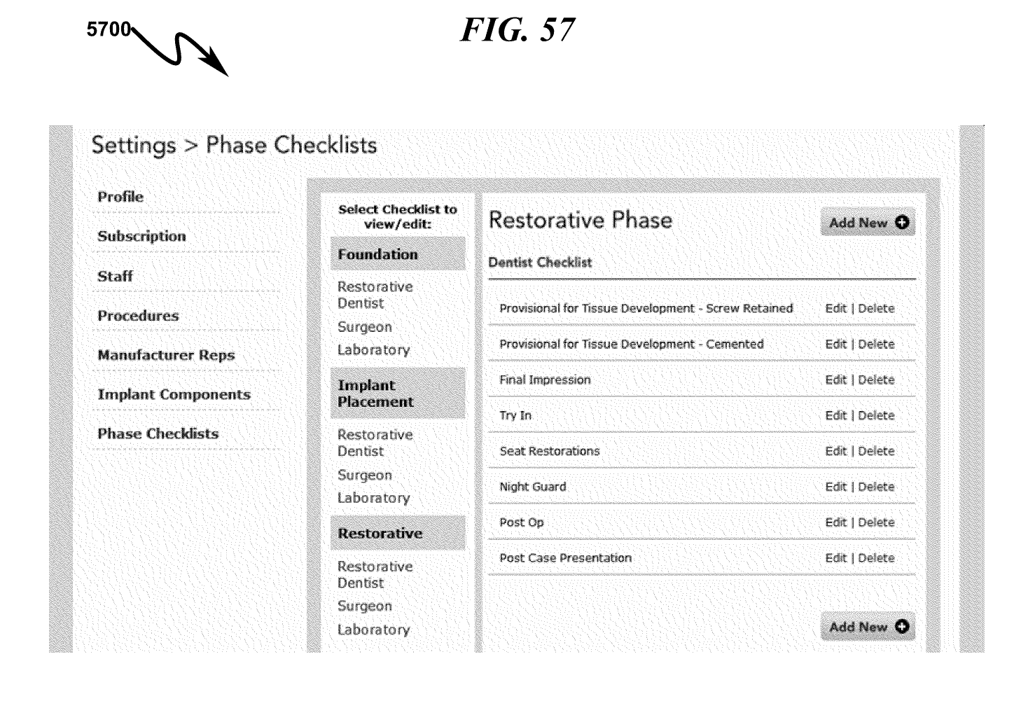

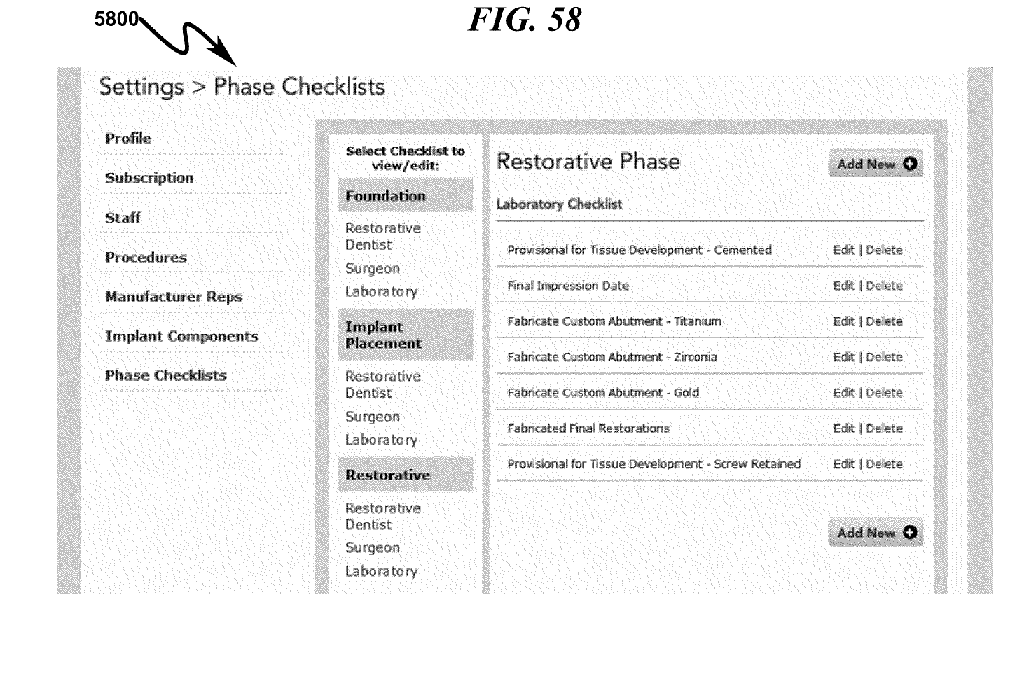

Exemplary EPC dialogs associated with the FOUNDATION phase (4910) are generally illustrated in FIG. 50 (5000) (surgeon), FIG. 51 (5100) (restorative doctor), and FIG. 52 (5200) (dental laboratory). Exemplary EPC dialogs associated with the IMPLANT PLACEMENT phase (4920) are generally illustrated in FIG. 53 (5300) (surgeon), FIG. 54 (5400) (restorative doctor), and FIG. 55 (5500) (dental laboratory). Exemplary EPC dialogs associated with the RESTORATIVE phase (4930) are generally illustrated in FIG. 56 (5600) (surgeon), FIG. 57 (5700) (restorative doctor), and FIG. 58 (5800) (dental laboratory).

FIG. 59 (5900) provides an exemplary dialog illustrating how a given EPC checklist item may be created or edited using any of these exemplary dialogs. Note also that the DIP has the option of dragging/dropping the procedures to resequenced their order and priority as discussed in the grouping/sequencing discussion associated with FIG. 13 (1300)-FIG. 16 (1600).

### DIP Case Menu Navigation Dialog (6000)

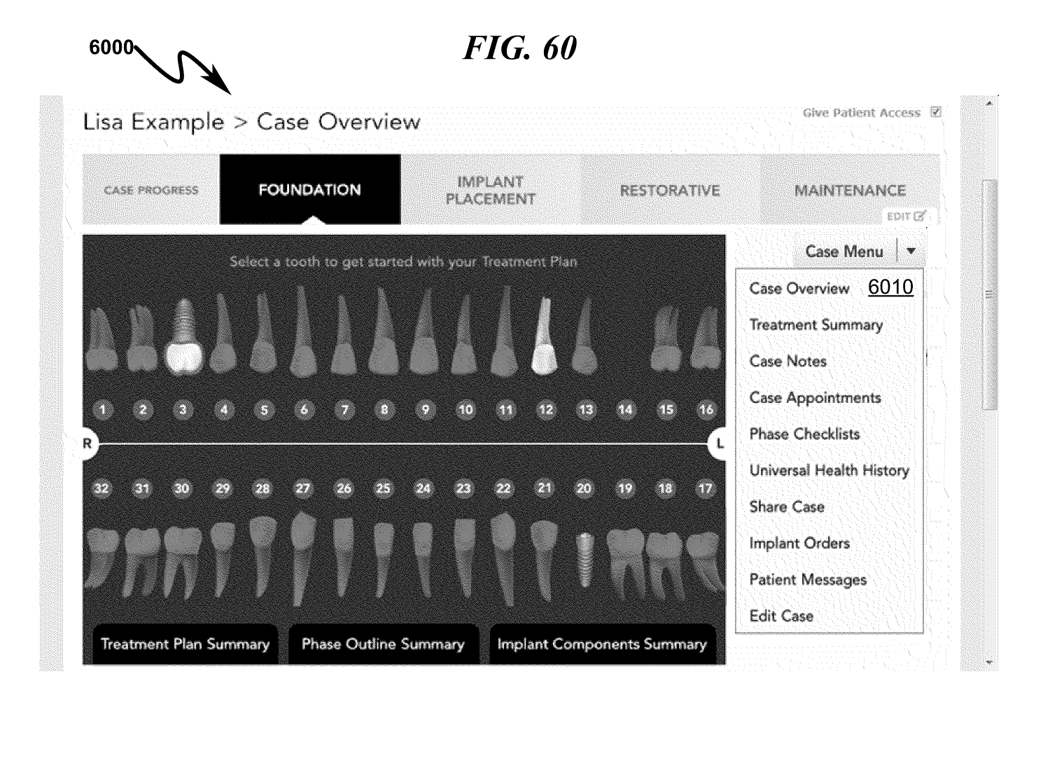

The present invention anticipates incorporation of a case menu navigation dialog within one or more portions of the website interface that allows the DIPs involved in treating the dental patient to have access to a variety of integrated information necessary for proper patient treatment. As generally illustrated in FIG. 60 (6000), this dialog navigation (6010) may incorporate Case Overview, Treatment Summary, Case Notes, Phase Checklist, Universal Health History, Case Sharing, Implant Ordering, Patient Messaging, and Case Editing functions.

Within these navigation dialogs the DIPs may inspect and display a given dental patient and the ETP in which the patient is phased along with information regarding particular EPC milestones that have been met and which are yet to be accomplished by the patient and/or DIP.

### Exemplary Patient Treatment Plan (6000)-(6400)

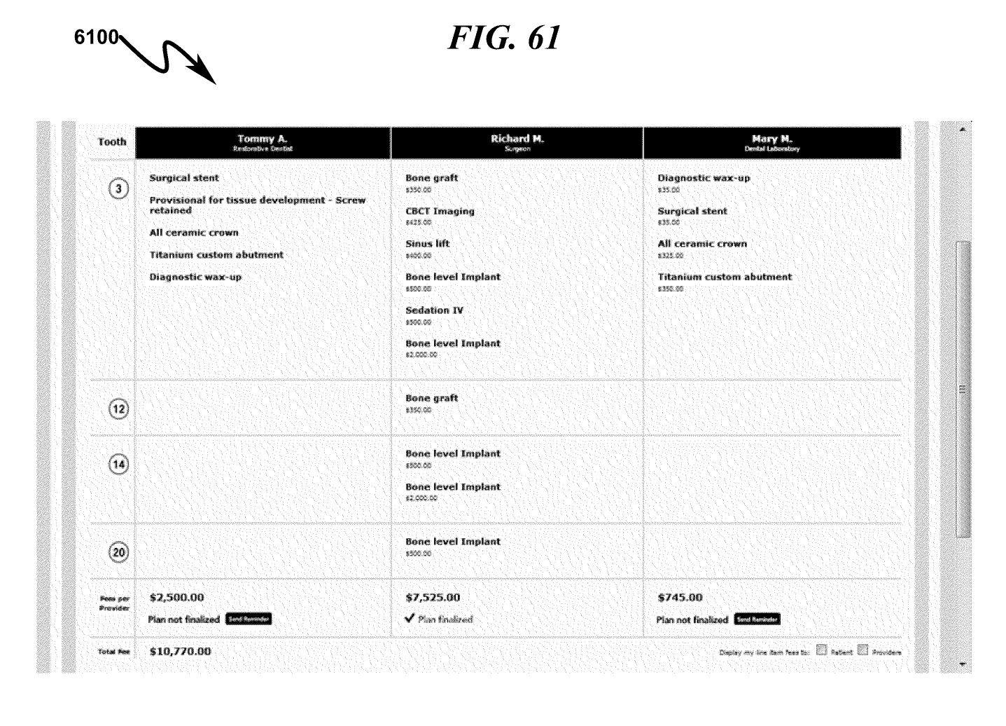

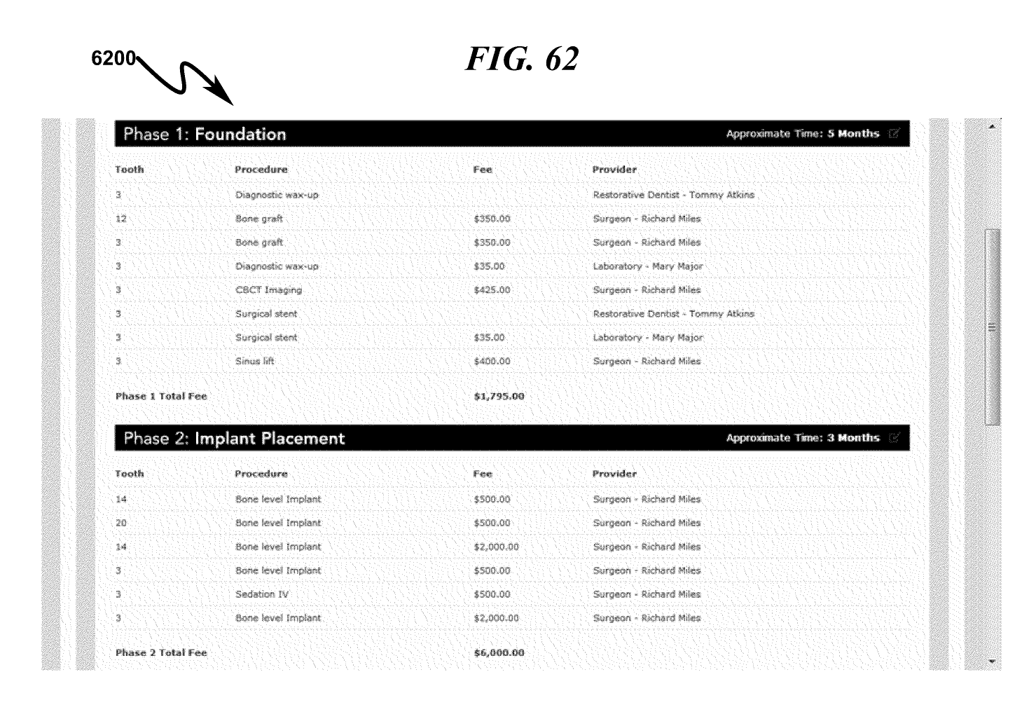

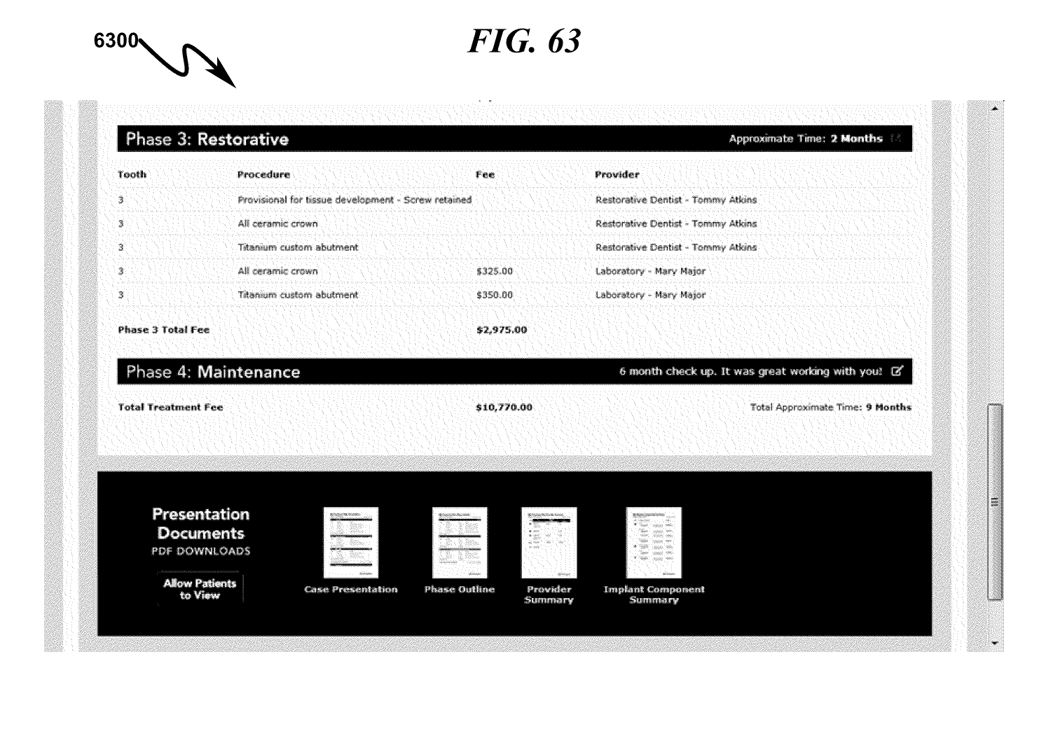

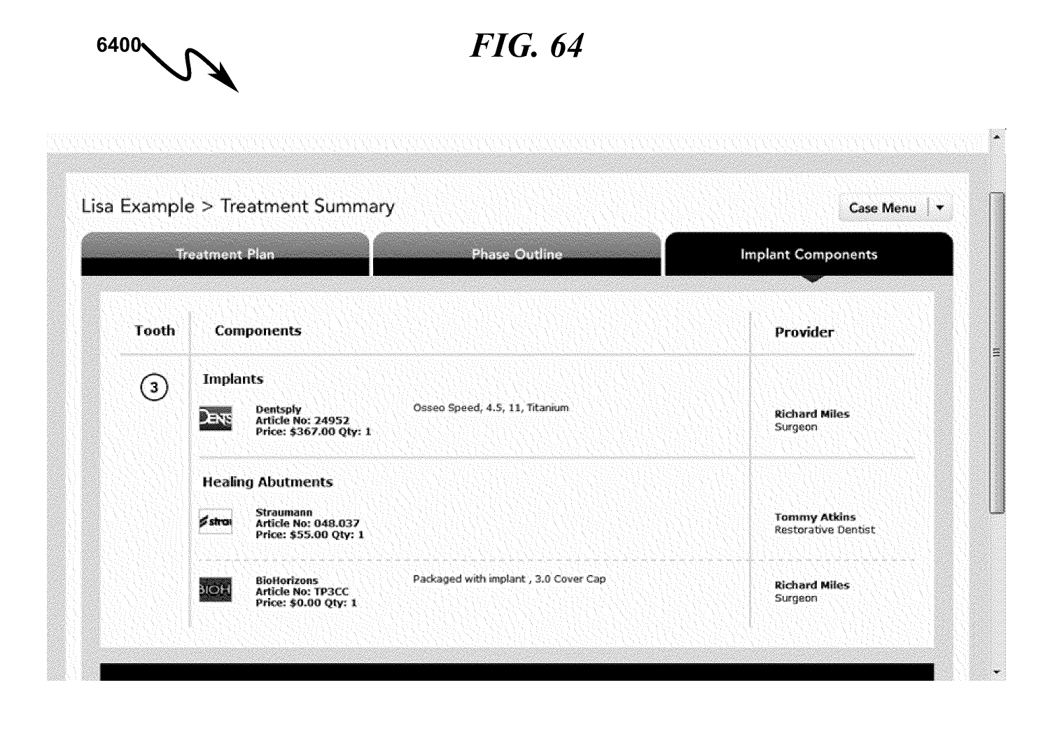

An exemplary treatment plan for a dental patient is generally illustrated in FIG. 60 (6000)-FIG. 64 (6400). Here the DIP is presented with a visual (FIG. 60 (6000)) representing the patient's dental X-rays and associates the procedures to be performed with specific teeth. The DIP may also be presented with a chronological list of patient activity in this dialog including appointments, patient messages, comments, case notes, etc. The visual patient overview information is summarized in FIG. 61 (6100) which illustrates the various DIP practitioners and the procedures they will each execute on the dental patient. The phase outline associated with these individual procedures is given in more detail in FIG. 62 (6200)-FIG. 63 (6300). Implant component specifications for the treatment procedure are generally illustrated in FIG. 64 (6400). Note that each breakdown of the treatment plan provides the DIP provider information on subtotal/total costs associated with the procedures and components as well as indications of treatment plan status (finalized/not finalized). As described previously, the DIP may opt to screen internal costs associated with specific procedures from other DIPs and/or the patient.

### Patient Document Generation (6300)

The present invention may in some preferred embodiments be configured to generate documents (typically in PDF format) for the DIP and/or patient. As generally illustrated in FIG. 63 (6300), these may include any of the following:

### Case Presentation PDF

The Case Presentation document is specifically designed to give the patient a thorough summary of the entire team's treatment plan. This useful tool will allow the patient to stay on track with their dental treatment. In each phase the patient will know approximately how much time it will take to get the patient to the next phase. The patient will also know which teeth are being treated, the type of procedure they will receive, and the specific provider who will be working with the patient. The patient will also be able to view the approximate total fees due in each phase.

### Phase Outline PDF

This Phase Outline document is specifically designed to give the patient a thorough summary of the entire team's treatment plan. Use this helpful tool to stay on track with their dental treatment. In each phase the patient will know approximately how much time it will take to get the patient to the next phase. The patient will also know which teeth are being treated, the type of procedure they will receive, and the specific provider who will be working with the patient. The patient will also be able to view the approximate total fees due in each phase.

### Provider Summary PDF

The Provider Summary document allows the patient's provider to discuss details about their specific dental treatment.

### Implant Component Summary PDF

The Implant Component Summary document is a detailed dental implant record for future use. An accurate record of the patient's dental implants is very important to maintain for patient long-term dental healthcare. This is because the implant industry is changing day by day and a dental implant and its components may require replacement in the future. This information can help the patient's provider quickly and easily meet their dental needs. The patient can access this information at any time for reference.

### Patient Document Referral

The present invention allows patient information stored in the IMD to be shared among a group of DIP providers in a secure manner such that a given patient file is only available to members of a team associated with the individual patient treatment. This patient file sharing capability permits (for example) patient contact information, health history, dental history, photographic images, X-rays, CAT scans, implant parts inventory, insurance, financial payment arrangements, etc. to be shared electronically among the various DIP professionals.

### Patient Medical History/Signature

The present invention anticipates that as depicted in FIG. 1 (0100) and FIG. 2 (0200), the patient may interface with the system to enter patient medical/dental history in a secure portion of the IMD that may be accessed by DIPs associated with their dental implant procedure. This information may also include patient waivers and other signed documents that are signed using any number of electronic signature methods. Optimal implementations of many preferred embodiments may utilize EPAD® USB-based electronic signature entry hardware available from ePADlink.com for this purpose. This allows the patient to fill out all relevant paperwork before the initial dental appointment and then simply sign the documents electronically when attending the DIP office.

### Patient Document Archival

A significant benefit of the web-based application context of the present invention is that the IMD and all associated patient information can be archived such that neither the patient nor any DIP need provide for records storage. This has both a short-term and long-term consequence to the patient and DIPs, in that in the short-term each DIP need not maintain a paper record for the patient and can also share the constantly updated patient file with other dental implant team members. In the long-term, the patient has access to their complete dental implant history, permitting this information to be used by other dental professionals in the maintenance of their dental implants.

It cannot be overstressed that historically dental implant maintenance has been hampered significantly by loss of dental implant information for a given patient. Often patients needing dental implant maintenance have been unable to access their dental records from a DIP practice that is no longer in operation or who has lost their records. Those DIP practices that are able to provide patient records often do so with significant delays in production. Finally, if records are not available or delayed, the cost associated with determining what dental implants are installed in a patient can be daunting for any DIP practitioner. Determination of an existing implant type with no available dental history can be expensive and time consuming to perform.

### Version Control

The present invention anticipates that the treatment plan for a given patient (and the associated EPC milestones) may change during the treatment of the dental patient and as such a methodology to maintain historical copies of the treatment plans is necessary. Thus, many preferred invention embodiments incorporate version control information such that changes to the treatment plan by any DIP are archived and can be reviewed to indicate treatment plan changes, their date, and responsible party. This information is vital to maintaining a patient history that can be used by subsequent DIP teams to treat the dental patient.

### DIP Procedure Capability Segregation

It should be mentioned that among the various DIPs involved in patient treatment, each DIP practice may possess different equipment and capability that may be used to affect patient treatment. For example, one DIP may possess photographic images, X-ray, and CAT scan capability that permits accurate rendering of the patient dental status. This information may permit EPC milestones to be shifted among DIP providers to ensure that there is no duplication of procedures among the various providers. As indicated above, the ability to share documentation among various DIP providers in the treatment group ensures that all DIP providers have access to important patient information. This also allows all DIP providers the opportunity to review current patient information prior to a given patient appointment or procedure. This ensures that each DIP-initiated procedure occurs with the most up-to-date patient information.

### Scheduled Reminders

The scheduling processes described herein may in some preferred embodiments incorporate “reminder” appointment notifications to the patient and/or DIP.

### Dental Implant Manufacturer Part Specification/Ordering

The present invention has as an objective in some preferred embodiments the reduction of dental implant parts inventories for DIPs. This feature can be accomplished in some embodiments by integrating the ordering of dental implant parts with patient scheduling such that dental implant parts are automatically ordered from the manufacturer representatives “just in time” for the scheduled dental implant patient appointment with the DIP.

As an aid to this process, the present invention in some preferred embodiments allows the DIP to specify information on a particular dental implant part. This information can include any of the following exemplary data:
Manufacturer;
Article;
Description;
Implant line;
Neck width;
Price;
Endosteal;
Implant length;
Height;
Closed open tray;
Tissue height;
Vertical height.

One skilled in the art will recognize that this data is only exemplary of possible specifications for dental implant parts.

### System Summary

The present invention system anticipates a wide variety of variations in the basic theme of construction, but can be generalized as a dental implant management system comprising:
(a) Implant Management Web Server (IWS); and
(b) Implant Management Database (IMD);
wherein
the IWS is configured to present a website via a graphical user interface (GUI) to remote users;
the remote users interact with the website and communicate via a computer network with the IWS using a web browser operating on individual remote computer systems associated with each of the remote users;
the remote users comprise a dental patient and dental implant professionals (DIP);
the DIP further comprises a surgeon, restorative doctor, and dental lab;
the IWS is configured to operate the website to coordinate the interaction between the dental patient and the DIP to affect a dental implant procedure on the dental patient that is performed by the DIP;
the website comprises a plurality of data access portals (DAPs) configured to permit each of the remote users control of and access to information contained within the IMD;
the DAPs consist of a patient access portal (PAP) and implant access portals (IAPs);
the IAPs comprise a surgeon access portal, restorative doctor access portal, and dental lab access portal;
the IWS is configured to store and retrieve information on the IMD responsive to interactions of the remote users with the DAPs;
the PAP is configured to permit the dental patient to define patient information on the IMD;
the IAPs are configured to permit the surgeon, the restorative doctor, and the dental lab to each define a treatment execution plan (TEP) for the dental patient and store the TEP on the IMD;
the IWS is configured to monitor the TEP for the dental patient within the context of execution treatment phases (ETP) and associated execution phase checklists (EPC) stored within the IMD;
the IWS is configured to allow the DIP to create and update the EPC via the use of the IAPs;
the IWS is configured to schedule appointments between the dental patient and the DIP via the use of patient communication over the computer network;
the IWS is configured to trigger appointments between the dental patient and the DIP via the use of patient communication over the computer network;
the IWS is configured to interact with the DIP via the IAPs to update the ETP in which the dental patient is positioned based on the completion of the EPC within the ETP;
the IWS is configured to enable presentation of the status of the dental implant procedure to the dental patient via the PAP; and
the IWS is configured to enable presentation of the status of the dental implant procedure to the DIP via the IAPs.

This general system summary may be augmented by the various elements described herein to produce a wide variety of invention embodiments consistent with this overall design description.

### Method Summary

The present invention method anticipates a wide variety of variations in the basic theme of implementation, but can be generalized as a dental implant management method comprising:
(1) Configuring setup information for a dental patient and dental implant professionals (DIP) in an Implant Management Database (IMD) via use of graphical user interface (GUI) website data access portals (DAPs) executed by an Implant Management Web Server (IWS);
(2) Executing instructions on the IWS to define a patient-specific treatment execution plan (TEP) by coordinating input from the DIP that is collected via the DAPs;
(3) Executing instructions on the IWS to integrate the TEP into specific execution treatment phases (ETP);
(4) Executing instructions on the IWS to associate execution phase checklists (EPC) for each DIP with each ETP;
(5) Executing instructions on the IWS to schedule appointments between the dental patient and the DIP via the use of patient communication over the computer network;
(6) Executing instructions on the IWS to trigger appointments between the dental patient and the DIP via the use of patient communication over the computer network; and
(7) Executing instructions on the IWS to verify that all EPC entries within an ETP are successfully completed;
wherein
the DAPs consist of a patient access portal (PAP) and implant access portals (IAPs);
the IAPs comprise a surgeon access portal, restorative doctor access portal, and dental lab access portal; and
the GUI DAPs are accessed via a computer network using one or more remote computers each of the one or more remote computers executing a website browser.

This general method may be modified heavily depending on a number of factors, with rearrangement and/or addition/deletion of steps anticipated by the scope of the present invention. Integration of this and other preferred exemplary embodiment methods in conjunction with a variety of preferred exemplary embodiment systems described herein is anticipated by the overall scope of the present invention.

### System/Method Variations

The present invention anticipates a wide variety of variations in the basic theme of construction. The examples presented previously do not represent the entire scope of possible usages. They are meant to cite a few of the almost limitless possibilities.

This basic system and method may be augmented with a variety of ancillary embodiments, including but not limited to:
An embodiment wherein the computer network comprises the Internet.
An embodiment wherein the IWS is configured to support an application programming interface (API) allowing third-party application software executed on a remote computer system access to data stored in the IMD.
An embodiment wherein the patient communication is selected from a group consisting of: e-mail messages; and electronic calendaring messages; SMS text messages; voicemail messages delivered within e-mail; and voicemail messages delivered using a public switched telephone network (PSTN).
An embodiment wherein the ETP comprises FOUNDATION, IMPLANT PLACEMENT, RESTORATIVE, and MAINTENANCE phases.
An embodiment wherein the DAPs comprise a web page configured to provide a patient navigation dashboard further comprising Case Progress, Upcoming Appointments, Implant Team, Messages, Learning Center, Health History, Tell a Friend, Recent Activity, and Important Document navigation options.
An embodiment wherein the IWS is configured to store costs associated with the EPC within the IMD; calculate a total cost of the dental implant procedure by summing the costs associated with the EPCs within the TEP associated with the dental patient; and display the total cost via the DAPs.
An embodiment wherein the total cost is automatically updated after any modification of the TEP by the DIP.
An embodiment wherein the IWS is configured to store calendar time associated with the EPC within the IMD; calculate a total calendar time of the dental implant procedure by summing the calendar time associated with the EPCs within the TEP associated with the dental patient; and display the total calendar time via the DAPs.
An embodiment wherein the total calendar time is automatically updated after any modification of the TEP by the DIP.
An embodiment wherein the IWS is configured to present the ETP in which the dental patient is currently phased to the dental patient via the PAP.
An embodiment wherein the IWS is configured to present the ETP in which the dental patient is currently phased to the DIP via the DAPs.
An embodiment wherein the IWS is configured to present the status of the EPC associated with the ETP in which the dental patient is currently phased to the DIP via the DAPs.
An embodiment wherein the IAPs comprise a web page configured to provide a surgeon setup dialog further comprising Profile, Subscription, Staff, Procedures, Manufacturer Representatives, Implant Components, and Phase Checklist definition configuration options.
An embodiment wherein the IAPs comprise a web page configured to provide a restorative doctor setup dialog further comprising Profile, Subscription, Staff, Procedures, Manufacturer Representatives, Implant Components, and Phase Checklist definition configuration options.
An embodiment wherein the IAPs comprise a web page configured to provide a dental lab setup dialog further comprising Profile, Subscription, Staff, Procedures, Manufacturer Representatives, Implant Components, and Phase Checklist definition configuration options.
An embodiment wherein the IWS is configured to collect treatment planning data from the DIP and present a totalized cost for the dental implant procedure to the dental patient via the PAP.
An embodiment wherein the IWS is configured to define dental part suppliers and dental parts within the IMD and allow the DIP to associate this information with the TEP for the dental patient.
An embodiment wherein the IWS is configured to place an order for a dental part defined within the IMD based on the TEP for the dental patient by sending a communication to the dental part vendor associated with the dental part as defined within the IMD.
An embodiment wherein the communication is selected from a group consisting of: electronic mail; fax; SMS text message; and voicemail.
An embodiment wherein the IWS is configured to allow a plethora of dental implant professionals to associate in a treatment group to facilitate the implementation of patient treatment execution plans generated within the treatment group to affect the dental implant procedure.
An embodiment wherein the IWS is configured to initiate scheduling of appointments between the dental patient and the DIP when the dental patient accesses the PAP.
An embodiment wherein the IWS is configured to initiate scheduling of appointments between the dental patient and the DIP when the DIP accesses the IAPs.
An embodiment wherein the IWS is configured to permit procedures within the EPC to be sequenced into treatment plan sequences (TPS) and scheduled for sequential execution.
An embodiment wherein the IWS is configured to permit procedures within the TPS to be subgrouped and scheduled for non-sequenced execution.
An embodiment wherein the IWS is configured to permit procedures within the TPS to be sequenced into treatment plan sequences (TPS) and scheduled for sequential execution between the DIP.
An embodiment wherein the IWS is configured to permit procedures within the TPS to be subgrouped and scheduled for non-sequenced execution.
An embodiment wherein the IWS is configured to inspect electronic calendar data associated with the dental patient and electronic calendar data associated with the DIP to coordinate the appointment scheduling between the dental patient and the DIP.
An embodiment wherein the IWS is configured to inspect electronic calendar data associated with the dental patient and electronic calendar data associated with the DIP to coordinate the appointment triggering between the dental patient and the DIP.
An embodiment wherein the IWS is configured to coordinate the appointment triggering between the dental patient and the DIP via an interface to an electronic calendaring application selected from a group consisting of: APPLE® ICAL®; GOGGLE® CALENDAR; LOTUS® NOTES®; MICROSOFT® EXCHANGE®; MICROSOFT® OUTLOOK®; and YAHOO!® CALENDAR.

One skilled in the art will recognize that other embodiments are possible based on combinations of elements taught within the above invention description.

### Generalized Computer Usable Medium

In various alternate embodiments, the present invention may be implemented as a computer program product for use with a computerized computing system. Those skilled in the art will readily appreciate that programs defining the functions defined by the present invention can be written in any appropriate programming language and delivered to a computer in many forms, including but not limited to: (a) information permanently stored on non-writeable storage media (e.g., read-only memory devices such as ROMs or CD-ROM disks); (b) information alterably stored on writeable storage media (e.g., floppy disks and hard drives); and/or (c) information conveyed to a computer through communication media, such as a local area network, a telephone network, or a public network such as the Internet. When carrying computer readable instructions that implement the present invention methods, such computer readable media represent alternate embodiments of the present invention.

As generally illustrated herein, the present invention system embodiments can incorporate a variety of computer readable media that comprise computer usable medium having computer readable code means embodied therein. One skilled in the art will recognize that the software associated with the various processes described herein can be embodied in a wide variety of computer accessible media from which the software is loaded and activated. Pursuant to In re Beauregard, 35 USPQ2d 1383 (U.S. Pat. No. 5,710,578), the present invention anticipates and includes this type of computer readable media within the scope of the invention. Pursuant to In re Nuijten, 500 F.3d 1346 (Fed. Cir. 2007) (U.S. patent application Ser. No. 09/211,928), the present invention scope is limited to computer readable media wherein the media is both tangible and non-transitory.

### CONCLUSION

A dental implant management system/method that improves communication and coordination between parties associated with dental implant procedures has been disclosed. The system/method operates to permit each dental implant professional (DIP) (typically a surgeon, restorative doctor, and dental laboratory) to iteratively generate a patient treatment execution plan (TEP) for the dental implant procedure that is generally structured within execution treatment phases (ETP) and automatically coordinated among each DIP. The ETP typically defines FOUNDATION, IMPLANT PLACEMENT, RESTORATIVE, and MAINTENANCE phases that may each incorporate custom execution phase checklists (EPC) that permit each DIP to ensure that critical elements of their TEP are properly executed. Coordination of the various DIP-generated TEPs is integrated with treatment planning/sequencing, patient scheduling, DIP fee estimation, and dental parts procurement to ensure maximum revenue to each DIP while simultaneously improving the probability of a successful dental implant procedure for the patient.

1. A dental implant management system comprising:
(a) Implant Management Web Computer Server (IWS); and
(b) Implant Management Computer Database (IMD);
wherein
said IWS is configured to present a website via a graphical user interface (GUI) to remote users;
said remote users interact with said website and communicate via a computer network with said IWS using a web browser operating on individual remote computer systems associated with each of said remote users;
said remote users comprise a dental patient and dental implant professionals (DIP);
said DIP further comprises a surgeon, restorative doctor, and dental lab;
said IWS is configured to operate said website to coordinate the interaction between said dental patient and said DIP to affect a dental implant procedure on said dental patient that is performed by said DIP;
said website comprises a plurality of data access portals (DAPs) configured to permit each of said remote users control of and access to information contained within said IMD;
said DAPs consist of a patient access portal (PAP) and implant access portals (IAPs);
said IAPs comprise a surgeon access portal, restorative doctor access portal, and dental lab access portal;
said IWS is configured to store and retrieve information on said IMD responsive to interactions of said remote users with said DAPs;
said PAP is configured to permit said dental patient to define patient information on said IMD;
said IAPs are configured to permit said surgeon, said restorative doctor, and said dental lab to each define specific treatment execution plans (TEP) for said dental patient and store said TEP on said IMD;
said IWS is configured to integrate said TEP for said dental patient within the context of execution treatment phases (ETP) stored within said IMD;
said IWS is configured to associate with said ETP execution phase checklists (EPC) stored within said IMD;
said IWS is configured to allow said DIP to create and update said EPC via the use of said IAPs;
said IWS is configured to schedule appointments between said dental patient and said DIP via the use of patient communication over said computer network;
said IWS is configured to trigger appointments between said dental patient and said DIP via the use of patient communication over said computer network;
said IWS is configured to interact with said DIP via said IAPs to update said ETP in which said dental patient is positioned based on the completion of said EPC within said ETP;
said IWS is configured to verify that all entries within said EPC are completed within each said ETP and coordinate and trigger activity between said dental patient and said DIP until said EPC entries are completed;
said IWS is configured to enable presentation of the status of said dental implant procedure to said dental patient via said PAP; and
said IWS is configured to enable presentation of the status of said dental implant procedure to said DIP via said IAPs.

2. The dental implant management system of claim 1 wherein said computer network comprises the Internet.

3. The dental implant management system of claim 1 wherein said IWS is configured to support an application programming interface (API) allowing third-party application software executed on a remote computer system access to data stored in said IMD.

4. The dental implant management system of claim 1 wherein said patient communication is selected from a group consisting of: e-mail messages; and electronic calendaring messages; SMS text messages; voicemail messages delivered within e-mail; and voicemail messages delivered using a public switched telephone network (PSTN).

5. The dental implant management system of claim 1 wherein said ETP comprises FOUNDATION, IMPLANT PLACEMENT, RESTORATIVE, and MAINTENANCE phases.

6. The dental implant management system of claim 1 wherein said DAPs comprise a web page configured to provide a patient navigation dashboard further comprising Case Progress, Upcoming Appointments, Implant Team, Messages, Learning Center, Health History, Tell a Friend, Recent Activity, and Important Document navigation options.

7. The dental implant management system of claim 1 wherein said IWS is configured to store costs associated with said EPC within said IMD; calculate a total cost of said dental implant procedure by summing the costs associated with said EPCs within said TEP associated with said dental patient; and display said total cost via said DAPs.

8. The dental implant management system of claim 7 wherein said total cost is automatically updated after any modification of said TEP by said DIP.

9. The dental implant management system of claim 1 wherein said IWS is configured to store calendar time associated with said EPC within said IMD; calculate a total calendar time of said dental implant procedure by summing the calendar time associated with said EPCs within said TEP associated with said dental patient; and display said total calendar time via said DAPs.

10. The dental implant management system of claim 9 wherein said total calendar time is automatically updated after any modification of said TEP by said DIP.

11. The dental implant management system of claim 1 wherein said IWS is configured to present the ETP in which said dental patient is currently operating to said dental patient via said PAP.

12. The dental implant management system of claim 1 wherein said IWS is configured to present the ETP in which said dental patient is currently phased to said DIP via said DAPs.

13. The dental implant management system of claim 1 wherein said IWS is configured to present the status of said EPC associated with the ETP in which said dental patient is currently phased to said DIP via said DAPs.

14. The dental implant management system of claim 1 wherein said IAPs comprise a web page configured to provide a surgeon setup dialog further comprising Profile, Subscription, Staff, Procedures, Manufacturer Representatives, Implant Components, and Phase Checklist definition configuration options.

15. The dental implant management system of claim 1 wherein said IAPs comprise a web page configured to provide a restorative doctor setup dialog further comprising Profile, Subscription, Staff, Procedures, Manufacturer Representatives, Implant Components, and Phase Checklist definition configuration options.

16. The dental implant management system of claim 1 wherein said IAPs comprise a web page configured to provide a dental lab setup dialog further comprising Profile, Subscription, Staff, Procedures, Manufacturer Representatives, Implant Components, and Phase Checklist definition configuration options.

17. The dental implant management system of claim 1 wherein said IWS is configured to collect treatment planning data from said DIP and present a totalized cost for said dental implant procedure to said dental patient via said PAP.

18. The dental implant management system of claim 1 wherein said IWS is configured to define dental part suppliers and dental parts within said IMD and allow said DIP to associate this information with said TEP for said dental patient.

19. The dental implant management system of claim 1 wherein said IWS is configured to place an order for a dental part defined within said IMD based on said TEP for said dental patient by sending a communication to the dental part vendor associated with said dental part as defined within said IMD.

20. The dental implant management system of claim 19 wherein said communication is selected from a group consisting of: electronic mail; fax; SMS text message; and voicemail.

21. The dental implant management system of claim 1 wherein said IWS is configured to allow a plethora plurality of dental implant professionals to associate in a treatment group to facilitate the implementation of patient treatment execution plans generated within said treatment group to affect said dental implant procedure.

22. The dental implant management system of claim 1 wherein said IWS is configured to initiate scheduling of appointments between said dental patient and said DIP when said dental patient accesses said PAP.

23. The dental implant management system of claim 1 wherein said IWS is configured to initiate scheduling of appointments between said dental patient and said DIP when said DIP accesses said IAPs.

24. The dental implant management system of claim 1 wherein said IWS is configured to permit procedures within said EPC to be sequenced into treatment plan sequences (TPS) and scheduled for sequential execution.

25. The dental implant management system of claim 24 wherein said IWS is configured to permit procedures within said TPS to be subgrouped and scheduled for non-sequenced execution.

26. The dental implant management system of claim 1 wherein said IWS is configured to permit procedures within said TPS to be sequenced into treatment plan sequences (TPS) and scheduled for sequential execution between said DIP.

27. The dental implant management system of claim 26 wherein said IWS is configured to permit procedures within said TPS to be subgrouped and scheduled for non-sequenced execution.

28. The dental implant management system of claim 1 wherein said IWS is configured to inspect electronic calendar data associated with said dental patient and electronic calendar data associated with said DIP to coordinate said appointment scheduling between said dental patient and said DIP.

29. The dental implant management system of claim 1 wherein said IWS is configured to inspect electronic calendar data associated with said dental patient and electronic calendar data associated with said DIP to coordinate said appointment triggering between said dental patient and said DIP.

30. The dental implant management system of claim 1 wherein said IWS is configured to coordinate said appointment triggering between said dental patient and said DIP via an interface to an electronic calendaring application selected from a group consisting of: APPLE® ICAL®; GOGGLE® CALENDAR; LOTUS® NOTES®; MICROSOFT® EXCHANGE®; MICROSOFT® OUTLOOK®; and YAHOO!® CALENDAR.

31. A dental implant management method comprising:
(1) Configuring setup information for a dental patient and dental implant professionals (DIP) in an Implant Management Database (IMD) via use of graphical user interface (GUI) website data access portals (DAPs) executed by an Implant Management Web Server (IWS);
(2) Executing instructions on said IWS to define a patient-specific treatment execution plan (TEP) by coordinating input from said DIP that is collected via said DAPs;
(3) Executing instructions on said IWS to integrate the TEP into specific execution treatment phases (ETP);
(4) Executing instructions on said IWS to associate execution phase checklists (EPC) for each DIP with each ETP;
(5) Executing instructions on said IWS to schedule appointments between said dental patient and said DIP via the use of patient communication over said computer network;
(6) Executing instructions on said IWS to trigger appointments between said dental patient and said DIP via the use of patient communication over said computer network; and
(7) Executing instructions on said IWS to verify that all EPC entries within an ETP are successfully completed;
wherein
said DAPs consist of a patient access portal (PAP) and implant access portals (IAPs);
said IAPs comprise a surgeon access portal, restorative doctor access portal, and dental lab access portal; and
said GUI DAPs are accessed via a computer network using one or more remote computers each of said one or more remote computers executing a website browser.

32. The dental implant management method of claim 31 wherein said computer network comprises the Internet.

33. The dental implant management method of claim 31 wherein said IWS executes instructions to support an application programming interface (API) allowing third-party application software executed on a remote computer system access to data stored in said IMD.

34. The dental implant management method of claim 31 wherein said patient communication is selected from a group consisting of: e-mail messages; and electronic calendaring messages; SMS text messages; voicemail messages delivered within e-mail; and voicemail messages delivered using a public switched telephone network (PSTN).

35. The dental implant management method of claim 31 wherein said ETP comprises FOUNDATION, IMPLANT PLACEMENT, RESTORATIVE, and MAINTENANCE phases.

36. The dental implant management method of claim 31 wherein said DAPs comprise a web page configured to provide a patient navigation dashboard further comprising Case Progress, Upcoming Appointments, Implant Team, Messages, Learning Center, Health History, Tell a Friend, Recent Activity, and Important Document navigation options.

37. The dental implant management method of claim 31 wherein said IWS executes instructions to store costs associated with said EPC within said IMD; calculate a total cost of said dental implant procedure by summing the costs associated with said EPCs within said TEP associated with said dental patient; and display said total cost via said DAPs.

38. The dental implant management method of claim 37 wherein said total cost is automatically updated after any modification of said TEP by said DIP.

39. The dental implant management method of claim 31 wherein said IWS executes instructions to store calendar time associated with said EPC within said IMD; calculate a total calendar time of said dental implant procedure by summing the calendar time associated with said EPCs within said TEP associated with said dental patient; and display said total calendar time via said DAPs.

40. The dental implant management method of claim 39 wherein said total calendar time is automatically updated after any modification of said TEP by said DIP.

41. The dental implant management method of claim 31 wherein said IWS executes instructions to present the ETP in which said dental patient is currently phased to said dental patient via said PAP.

42. The dental implant management method of claim 31 wherein said IWS executes instructions to present the ETP in which said dental patient is currently phased to said DIP via said DAPs.

43. The dental implant management method of claim 31 wherein said IWS executes instructions to present the status of said EPC associated with the ETP in which said dental patient is currently phased to said DIP via said DAPs.

44. The dental implant management method of claim 31 wherein said IAPs comprise a web page configured to provide a surgeon setup dialog further comprising Profile, Subscription, Staff, Procedures, Manufacturer Representatives, Implant Components, and Phase Checklist definition configuration options.

45. The dental implant management method of claim 31 wherein said IAPs comprise a web page configured to provide a restorative doctor setup dialog further comprising Profile, Subscription, Staff, Procedures, Manufacturer Representatives, Implant Components, and Phase Checklist definition configuration options.

46. The dental implant management method of claim 31 wherein said IAPs comprise a web page configured to provide a dental lab setup dialog further comprising Profile, Subscription, Staff, Procedures, Manufacturer Representatives, Implant Components, and Phase Checklist definition configuration options.

47. The dental implant management method of claim 31 wherein said IWS executes instructions to collect treatment planning data from said DIP and present a totalized cost for said dental implant procedure to said dental patient via said PAP.

48. The dental implant management method of claim 31 wherein said IWS executes instructions to define dental part suppliers and dental parts within said IMD and allow said DIP to associate this information with said TEP for said dental patient.

49. The dental implant management method of claim 31 wherein said IWS executes instructions to place an order for a dental part defined within said IMD based on said TEP for said dental patient by sending a communication to the dental part vendor associated with said dental part as defined within said IMD.

50. The dental implant management method of claim 49 wherein said communication is selected from a group consisting of: electronic mail; fax; SMS text message; and voicemail.

51. The dental implant management method of claim 31 wherein said IWS executes instructions to allow a plethora of dental implant professionals to associate in a treatment group to facilitate the implementation of patient treatment execution plans generated within said treatment group to affect said dental implant procedure.

52. The dental implant management method of claim 31 wherein said IWS executes instructions to initiate scheduling of appointments between said dental patient and said DIP when said dental patient accesses said PAP.

53. The dental implant management method of claim 31 wherein said IWS executes instructions to initiate scheduling of appointments between said dental patient and said DIP when said DIP accesses said IAPs.

54. The dental implant management method of claim 31 wherein said IWS executes instructions to permit procedures within said EPC to be sequenced into treatment plan sequences (TPS) and scheduled for sequential execution.

55. The dental implant management method of claim 54 wherein said IWS executes instructions to permit procedures within said TPS to be subgrouped and scheduled for non-sequenced execution.

56. The dental implant management method of claim 31 wherein said IWS executes instructions to permit procedures within said TPS to be sequenced into treatment plan sequences (TPS) and scheduled for sequential execution between said DIP.

57. The dental implant management method of claim 56 wherein said IWS executes instructions to permit procedures within said TPS to be subgrouped and scheduled for non-sequenced execution.

58. The dental implant management method of claim 31 wherein said IWS executes instructions to inspect electronic calendar data associated with said dental patient and electronic calendar data associated with said DIP to coordinate said appointment scheduling between said dental patient and said DIP.

59. The dental implant management method of claim 31 wherein said IWS executes instructions to inspect electronic calendar data associated with said dental patient and electronic calendar data associated with said DIP to coordinate said appointment triggering between said dental patient and said DIP.

60. The dental implant management method of claim 31 wherein said IWS executes instructions to coordinate said appointment triggering between said dental patient and said DIP via an interface to an electronic calendaring application selected from a group consisting of: APPLE® ICAL®; GOGGLE® CALENDAR; LOTUS® NOTES®; MICROSOFT® EXCHANGE®; MICROSOFT® OUTLOOK®; and YAHOO!® CALENDAR.

61. A tangible non-transitory computer usable medium having computer-readable program code means comprising a dental implant management method comprising:
(1) Configuring setup information for a dental patient and dental implant professionals (DIP) in an Implant Management Database (IMD) via use of graphical user interface (GUI) website data access portals (DAPs) executed by an Implant Management Web Server (IWS);
(2) Executing instructions on said IWS to define a patient-specific treatment execution plan (TEP) by coordinating input from said DIP that is collected via said DAPs;
(3) Executing instructions on said IWS to integrate the TEP into specific execution treatment phases (ETP);
(4) Executing instructions on said IWS to associate execution phase checklists (EPC) for each DIP with each ETP;
(5) Executing instructions on said IWS to schedule appointments between said dental patient and said DIP via the use of patient communication over said computer network;
(6) Executing instructions on said IWS to trigger appointments between said dental patient and said DIP via the use of patient communication over said computer network; and
(7) Executing instructions on said IWS to verify that all EPC entries within an ETP are successfully completed;
wherein
said DAPs consist of a patient access portal (PAP) and implant access portals (IAPs);
said IAPs comprise a surgeon access portal, restorative doctor access portal, and dental lab access portal; and
said GUI DAPs are accessed via a computer network using one or more remote computers each of said one or more remote computers executing a website browser.

62. The computer useable medium of claim 61 wherein said computer network comprises the Internet.

63. The computer useable medium of claim 61 wherein said IWS executes instructions to support an application programming interface (API) allowing third-party application software executed on a remote computer system access to data stored in said IMD.

64. The computer useable medium of claim 61 wherein said patient communication is selected from a group consisting of: e-mail messages; and electronic calendaring messages; SMS text messages; voicemail messages delivered within e-mail; and voicemail messages delivered using a public switched telephone network (PSTN).

65. The computer useable medium of claim 61 wherein said ETP comprises FOUNDATION, IMPLANT PLACEMENT, RESTORATIVE, and MAINTENANCE phases.

66. The computer useable medium of claim 61 wherein said DAPs comprise a web page configured to provide a patient navigation dashboard further comprising Case Progress, Upcoming Appointments, Implant Team, Messages, Learning Center, Health History, Tell a Friend, Recent Activity, and Important Document navigation options.

67. The computer useable medium of claim 61 wherein said IWS executes instructions to store costs associated with said EPC within said IMD; calculate a total cost of said dental implant procedure by summing the costs associated with said EPCs within said TEP associated with said dental patient; and display said total cost via said DAPs.

68. The computer useable medium of claim 67 wherein said total cost is automatically updated after any modification of said TEP by said DIP.

69. The computer useable medium of claim 61 wherein said IWS executes instructions to store calendar time associated with said EPC within said IMD; calculate a total calendar time of said dental implant procedure by summing the calendar time associated with said EPCs within said TEP associated with said dental patient; and display said total calendar time via said DAPs.

70. The computer useable medium of claim 69 wherein said total calendar time is automatically updated after any modification of said TEP by said DIP.

71. The computer useable medium of claim 61 wherein said IWS executes instructions to present the ETP in which said dental patient is currently phased to said dental patient via said PAP.

72. The computer useable medium of claim 61 wherein said IWS executes instructions to present the ETP in which said dental patient is currently phased to said DIP via said DAPs.

73. The computer useable medium of claim 61 wherein said IWS executes instructions to present the status of said EPC associated with the ETP in which said dental patient is currently phased to said DIP via said DAPs.

74. The computer useable medium of claim 61 wherein said IAPs comprise a web page configured to provide a surgeon setup dialog further comprising Profile, Subscription, Staff, Procedures, Manufacturer Representatives, Implant Components, and Phase Checklist definition configuration options.

75. The computer useable medium of claim 61 wherein said IAPs comprise a web page configured to provide a restorative doctor setup dialog further comprising Profile, Subscription, Staff, Procedures, Manufacturer Representatives, Implant Components, and Phase Checklist definition configuration options.

76. The computer useable medium of claim 61 wherein said IAPs comprise a web page configured to provide a dental lab setup dialog further comprising Profile, Subscription, Staff, Procedures, Manufacturer Representatives, Implant Components, and Phase Checklist definition configuration options.

77. The computer useable medium of claim 61 wherein said IWS executes instructions to collect treatment planning data from said DIP and present a totalized cost for said dental implant procedure to said dental patient via said PAP.

78. The computer useable medium of claim 61 wherein said IWS executes instructions to define dental part suppliers and dental parts within said IMD and allow said DIP to associate this information with said TEP for said dental patient.

79. The computer useable medium of claim 61 wherein said IWS executes instructions to place an order for a dental part defined within said IMD based on said TEP for said dental patient by sending a communication to the dental part vendor associated with said dental part as defined within said IMD.

80. The computer useable medium of claim 79 wherein said communication is selected from a group consisting of: electronic mail; fax; SMS text message; and voicemail.

81. The computer useable medium of claim 61 wherein said IWS executes instructions to allow a plethora of dental implant professionals to associate in a treatment group to facilitate the implementation of patient treatment execution plans generated within said treatment group to affect said dental implant procedure.

82. The computer useable medium of claim 61 wherein said IWS executes instructions to initiate scheduling of appointments between said dental patient and said DIP when said dental patient accesses said PAP.

83. The computer useable medium of claim 61 wherein said IWS executes instructions to initiate scheduling of appointments between said dental patient and said DIP when said DIP accesses said IAPs.

84. The computer useable medium of claim 61 wherein said IWS executes instructions to permit procedures within said EPC to be sequenced into treatment plan sequences (TPS) and scheduled for sequential execution.

85. The computer useable medium of claim 84 wherein said IWS executes instructions to permit procedures within said TPS to be subgrouped and scheduled for non-sequenced execution.

86. The computer useable medium of claim 61 wherein said IWS executes instructions to permit procedures within said TPS to be sequenced into treatment plan sequences (TPS) and scheduled for sequential execution between said DIP.

87. The computer useable medium of claim 86 wherein said IWS executes instructions to permit procedures within said TPS to be subgrouped and scheduled for non-sequenced execution.

88. The computer useable medium of claim 61 wherein said IWS executes instructions to inspect electronic calendar data associated with said dental patient and electronic calendar data associated with said DIP to coordinate said appointment scheduling between said dental patient and said DIP.

89. The computer useable medium of claim 61 wherein said IWS executes instructions to inspect electronic calendar data associated with said dental patient and electronic calendar data associated with said DIP to coordinate said appointment triggering between said dental patient and said DIP.

90. The computer useable medium of claim 61 wherein said IWS executes instructions to coordinate said appointment triggering between said dental patient and said DIP via an interface to an electronic calendaring application selected from a group consisting of: APPLE® ICAL®; GOGGLE® CALENDAR; LOTUS® NOTES®; MICROSOFT® EXCHANGE®; MICROSOFT® OUTLOOK®; and YAHOO!® CALENDAR.
